(19) United States
(12) Patent Application Publication
(10) Pub. No.: US 2012/0026303 A1
(43) Pub. Date: Feb. 2, 2012

(54) METHOD FOR FORMING AND OBSERVING STEREO IMAGES HAVING MAXIMUM SPATIAL RESOLUTION AND A DEVICE FOR CARRYING OUT SAID METHOD

(75) Inventor: Vasily Alexandrovich Ezhov, Moscow (RU)

(73) Assignee: STUNNY 3D, LLC

(21) Appl. No.: 13/141,628

(22) PCT Filed: Dec. 22, 2009
(86) PCT No.: PCT/IB09/07865

§ 371 Date: Oct. 18, 2011

(30) Foreign Application Priority Data
Dec. 25, 2008 (RU) 2008151367

(51) Int. Cl. H04N 13/04

(52) U.S. Cl. 348/54; 348/51; 348/E13.026; 348/E13.027

(57) ABSTRACT

The invention relates to stereoscopic displays and can be used for producing flat screen stereoscopic monitors and television sets with the option of observing a stereo image both with glasses and without glasses and with maximum spatial resolution equal to the full resolution of display matrices, and retaining the option of observing monoscopic images with full resolution. The required separation of two views of stereo image in a pair of observation windows (zones) is ensured with aid of virtually any type of display matrix, the transmission characteristic of which are linearized with aid of reciprocal or inverse functions which are deduced in accordance with a calibrating curve defining as the relation between two corresponding light intensity dependences in a pair of observation windows (zones) whereas changing the amplitude of calibrating signal.

The invention relates to the technology of forming and observing three-dimensional images, more precisely, to stereoscopic video technology, and can be used for creating stereoscopic and autostereoscopic (glasses-free) television sets and monitors on the basis of different optical structures with maximum spatial resolution at each view of the stereo image, equal to full spatial resolution of optical structures, including creation of flat autostereoscopic displays on liquid crystal (LC) matrices practically of any type with autocompensation of nonlinearity of transmission characteristics of matrices.

A method [1] is known for forming and observing stereo images with maximum spatial resolution with use of passive polarization stereo glasses, that includes the following: with aid of an optical source a light wave is generated; with aid of a real-amplitude first optical modulator, that is matrix-addressed in M rows and N columns, the optical intensity value is modulated in the mn^{th} element of the real-amplitude first optical modulator in accordance with the sum of the values of Bₘₙ^{L}, and Bₘₙ^{R}, of the brightness of the mn^{th} image elements of the left and right views, where m=1, 2, . . . , M, p=1, 2, . . . , N, and M·N is the total number of elements in the image of each of the views; with aid of a phase-polarization second optical modulator, that is matrix-addressed in M rows and N columns, in the mn^{th} element of the cross-section of luminous flux a polarization coding modulation is implemented in accordance with trigonometric functions of the type arctg, arcctg, arcsin, arccos from the algebraic relations between the values of B_{L}^{mn} and B_{R}^{mn}; with aid of the first and second optical polarization analyzers having complementary polarization characteristic a polarization decoding is implemented, forming the first and second luminous fluxes with intensity values of Jₘₙ^{L} and Jₘₙ^{R}, equal to the values of Bₘₙ^{L} and Bₘₙ^{R} of the brightness of the mn^{th} image elements respectively of the left and right views in the left W_{form}^{L} and right W_{form}^{R} formation windows, and the left and right views of the stereo image are observed in the left W_{V}^{L} and right W_{V}^{R} observation windows (windows of passive stereo glasses), which are optically connected, respectively, with the left W_{form}^{L} and right W_{form}^{R} formation windows.

The basic advantage of the known method [1] is the maximum information content of the stereo image, since the two image elements—the mn^{th} element of the left view image and the mn^{th} element of the right view image are simultaneously reproduced by any mn^{th} element of a matrix display (by mn^{th} elements of the first and second optical modulators). Actually, two images are simultaneously reproduced, each with M·N number of resolvable elements, on a display with M·N resolvable elements. That makes it possible to realize the stereo image with maximum spatial resolution, equal to full resolution of the matrix display screen.

A disadvantage of the known technical disclosure is the need for the observer to use special means of stereo image viewing—passive stereo glasses, which reduces the convenience (comfort) of viewing, especially with prolonged (multihour) observation.

A method [2] of autostereoscopic (glasses-free) forming and observation of stereo images with maximum spatial resolution is known, that includes the following: with aid of an optical source a light wave is formed; with aid of a real-amplitude first optical modulator, that is matrix-addressed in M rows and N columns, the optical intensity value is modulated in the mn^{th} element of the first optical modulator directly proportional to the sum of the values of B_{L}^{mn} and B_{R}^{mn} of the brightness of the mn^{th} image elements of the left and right views; with aid of a phase polarized second optical modulator, that is matrix-addressed in M rows and N columns, a polarization coding modulation is carried out in the mn^{th} element of the phase polarized second optical modulator in accordance with trigonometric functions of algebraic relations between the values of B_{L}^{mn} and Bₘₙ^{R}, creating complementary initial polarization states between adjacent 2i and (2i−1) columns of the phase polarized second optical modulator, where i=1, 2, . . . , N; with aid of an N-column addressed spatially-selective optical decoder a polarization decoding is carried out by shifting phase or changing polarization state of the light wave to the corresponding complementary values between its adjacent 2k and (2k−1) columns, where k=0, 1, 2, . . . , N, wherein N light beams are routed to the left formation zone Z_{form}^{L}, the first N/2 of which pass through the N/2 odd (2i−1) columns of the phase polarized second optical modulator and through N/2 even 2k columns of the spatially-selective polarization decoder, and the remaining N/2 light beams pass through the N/2 even 2i columns of the phase polarized second optical modulator and through N/2 odd (2k−1) columns of the spatially-selective polarization decoder, and N light beams are routed to the right formation zone Z_{form}^{R}, the first N/2 of which pass through the N/2 odd (2i−1) columns of the phase polarized second optical modulator and through the N/2 odd (2k−1) columns of the spatially-selective polarization decoder, and the remaining N/2 light beams pass through the N/2 even 2i columns of the phase polarized second optical modulator and through the N/2 even 2k columns of the spatially-selective polarization decoder, and the left and right views of the stereo image are observed, respectively, in the left Z_{V}^{L} and right Z_{V}^{R} observation windows, optically connected, respectively, with the left Z_{form}^{L} and right Z_{form}^{R} formation zones.

A device [2] is known for implementation of the known method of autostereoscopic forming and observing of stereo images with maximum spatial resolution, which contains an information signal source, optically connected with a source of luminous flux and electrically addressed optical module, which contains sequentially arranged on an optical axis an optical summation section, an optical encoding section and a spatially-selective optical decoding section, and also a first and second functional modules, which outputs are connected with control inputs of optical summation section and optical encoding section respectively, and inputs of first and second functional modules are connected with the corresponding outputs of the stereo video signal source, wherein an aperture of the mn^{th} element of the optical summation section optically connected with an aperture mn^{th} element of the optical encoding section, in the adjacent (2i−1) and 2i columns of the optical encoding section and in the adjacent (2k−1) and 2k columns of the spatially-selective optical decoder the initial optical states of the working medium are complementary between the adjacent columns, the axis of symmetry of the formation zone of one of the views is the common intersection line of N planes, of which the first N/2 planes pass through the axes of symmetry of the odd (2k−1) columns of the optical encoding section and through the axes of symmetry of the even 2i columns of the spatially-selective optical decoding section, and the remaining N/2 planes pass through the axes of symmetry of the even 2k columns of the optical encoding section and through the axes of symmetry of the odd (2i−1) columns of the spatially-selective optical decoding section, and the axis of symmetry of the formation zone of another views is the common intersection line of N planes, of which the first N/2 planes pass through the axes of symmetry of the even 2k columns of the optical encoding section and through the axes of symmetry of the even 2i columns of the spatially-selective optical decoding section, and the remaining N/2 planes pass through the axes of symmetry of the odd (2k−1) columns of the optical encoding section and through the axes of symmetry of the odd (2i−1) columns of the spatially-selective optical decoding section, where n, i, k=1, 2, . . . , N, m=1, 2, . . . , M.

The known method and device [2] ensure viewing of the stereo image without the help of stereo glasses with providing maximum full resolution M·N of the display for each of two simultaneously reproduced views.

However, the implementation of the known technical disclosures [1,2] is possible only in those cases when the analytical dependence of the light polarization state on the degree of electrically controlled optical anisotropy of the working medium is known, specifically, on the value of electrically controlled birefringence (ECB) in one case, or on the ability to rotate the polarization plane—the degree of electrically controlled optical activity (ECOA)—in another case, or with such a combination of ECB and ECOA effects, when it is possible separately to take into account and analytically to describe the action of each of these effects on the light polarization state. The first case occurs, for example, with the using, as a working medium, a phase-polarization optical modulator, having oriented layer of nematic LC with positive or negative dielectric anisotropy of Δ∈ with simple configuration of transparent electrodes applying control voltage to the boundaries of the LC layer, that leads to the existence of force lines of the control electric field only in a direction that is orthogonal to the boundary planes of the LC layer, and only to appearance of the ECB effect in the absence of twisting of LC molecules. In this case there is a possibility to determine analytically the dependence of light polarization state on the value of electrically controlled phase delay δ between ordinary and extraordinary rays in the LC layer. The second case takes place with the use of an LC twist structure based on 90°-twisting LC molecules with analogous simple configuration of electric field lines; then there is the possibility to determine analytically the polarization state of the output light caused by electrically variable value of the angle φ of rotation of the polarization plane in the LC layer.

However, difficulties in analytical calculations of the polarization encoding algorithm appear even for simple combinations of ECB and ECOA, since it is necessary to take into account the nature of the interaction of these effects among themselves, in particular, the noninvariance of the ECOA effect relative to the light polarization states, changing under the influence of the ECB effect. At the same time, the modern trend toward developing flat-screen display technology is in attainment of high resolution, contrast (dynamic range), speed and wide viewing angle displays due to using the advanced LC matrices (layers) with complicated initial and working orientation of LC molecules, with three-dimensional structure of electric field lines, which leads to extremely complex combinations of various electro-optical effects. For example, various types of ECOA effect (twisting of LC molecules in helical structures with a substantially different value of turning angle for separate molecules) are combined with various implementations of the ECB effect (additional reorientation of groups of LC molecules, as whole, to certain angles). Many varieties of similar LC structures have been developed, for which it is extremely difficult to calculate analytically the dependence of polarization state of output light from the applied control voltage, and therefore it is problematic analytically to calculate the polarization coding algorithm or to determine the transmission characteristic of the polarization optical encoder for implementation of known technical disclosures [1,2].

Another disadvantage of the prior art is the complexity of account of spurious nonlinearities of transmission characteristics of optical structures (reducing stereo image quality) in calculation of the polarization coding algorithm (transfer function of the phase-polarization optical modulator). Since such algorithm and transmitting function are fundamental functional nonlinearities, it is very difficult analytically to identify spurious nonlinearity on the background of such functional nonlinearity, and even more difficult to identify an assemblage of such spurious nonlinearities. This is especially problematic for case of LC structures, which are based on a combination of electro-optical effects, since one and the same nonlinearity can be interpreted differently for different electrooptic effects. In particular, a distortion of the uniformity of orientation of LC molecules due to “bulking” electric field force lines at the boundaries of the transparent electrodes can be treated as functional or, on the contrary, spurious nonlinearity, depending on which direction of electric field force lines is working for definite electrooptic effect. For example, in LC twist-structures in which the working direction is the direction of the electric field force lines between the electrodes on opposite boundaries of the LC layer (in the direction across the LC layer), the “buckling” of force lines, leading to the appearance of longitudinal (along the LC layer boundaries) components of force lines, is the spurious effect. However, for example, the formation of LC structures by the IPS method (in-plane switching), the working direction of the force lines is primarily a direction between adjacent electrodes on the same edge boundary of the LC layer (in a direction along the LC layer boundaries), and here the effect of “buckling” of the force lines on the edges of the electrodes is the major positive contribution to the mechanism of the electrooptic effect.

Therefore, the class of the actually utilized effects of optical modulation for polarization encoding in prior art is restricted, in fact, only by two electrooptic effects (ECOA and ECB) at their separate performance, when there is an opportunity to build mathematical models by solving the well-known equation of elliptical polarization of light in without taking into account the spurious nonlinearity in the transfer functions of structures.

Furthermore, polarization coding is a special case of optical encoding of general type, the latter in principle can be implemented on any optical effect, allowing one to create two complementary (supplementing each other or mutually opposite to each other) optical encoding states. However, analytical calculation in the general case of optical coding is problematic, since it is necessary to create a mathematical model of each particular effect of optical modulation or of combinations of such effects, taking into account the nonlinearities of characteristics, which requires a large amount of additional research.

Along with this, implementation of optical modulation for inputting the sum of the values of B_{L}^{mn} and B_{R}^{mn} only on base of absorption effect of the luminous flux by its real-amplitude modulation using LC layer, located between the polarizer and the analyzer, limits the modulation optical efficiency to a value less than 50%, since that is the maximum own optical efficiency of the linear polarizer with respect to non-polarized light of the optical source. But only a direct real-amplitude modulation of light wave due to direct absorption of its energy at the modulation point, yields a fairly simple calculation. In the prior art, the use of the indirect modulation of light wave (leading to desired variations of optical intensity after passage of a number of optical components) is problematic because of the complexity of analytical calculation of the combined action of optical components. Also it is problematic because of the appearance of concomitant (besides real-amplitude) modulation of the luminous flux at the refusal of using the output polarizer. It is very difficult to consider analytically effect of indirect modulation (for the purpose of its compensation) on the resulting variations in optical intensity in the observation windows. That does not allow using a number of optical structures with high optical efficiency in the prior art.

The task of the invention in a method and device is to improve the quality of stereo images by possibility to use various advanced optical structures regardless of their complexity.

The given task is solved by the first embodiment of the method, in which, with aid of an optical source a light wave is generated; with aid of a matrix-addressed first optical modulator a sum modulation of a light wave in the mn^{th} element of the first optical modulator is implemented in accordance with the sum of the values of Bₘₙ^{L} and Bₘₙ^{R} of the brightness of the mn^{th} image elements of the left and right views; with aid of a matrix-addressed second optical modulator a coding modulation of a light wave is implemented in accordance with nonlinear functions from the algebraic relations between the values of Bₘₙ^{L} and Bₘₙ^{R} of the brightness of the mn^{th} image elements of the left and right views; with aid of a first and second optical analyzers with complementary parameters of optical decoding of coding modulation, a first and second luminous fluxes are formed with intensity values of Jₘₙ^{L} and Jₘₙ^{R}, equal to the values of Bₘₙ^{L} and Bₘₙ^{R} of the brightness of the mn^{th} image elements of the left and right views in the left W_{form}^{L} and right W_{form}^{R} windows, that are optically connected with the left W_{V}^{L} and right W_{V}^{R} observation windows, in which the left and right views of the stereo image are observed; in accordance with the invention; with aid of a uniform-effect matrix-addressed optical modulator a direct sum modulation is implemented due to modulation of the optical intensity value or indirect sum modulation due to modulation of remaining physical characteristic of the light wave such as a direction of propagation or a value of convergence-divergence angle or a spectral characteristic or a polarization state or a phase value or due is implemented to modulation of a combination of the remaining light wave characteristics in the mn^{th} element of the uniform-effect optical modulator, applying to its control input a sum compensating signal sₘₙ^{Σ}^{_{—}}^{comp} which amplitude is directly proportional to the values of the linearization function of sum modulation Λ^{Σ}; with aid of a difference-effect matrix-addressed optical modulator a direct ratio modulation is implemented due to modulation of optical intensity or an indirect ratio modulation due to modulation of said remaining physical characteristics of a light wave in the mn^{th} element of the difference-effect optical modulator, applying to its control input a ratio compensating signal sₘₙ^{Ξ}^{_{—}}^{comp} which amplitude is directly proportional to the values of the linearization function of ratio modulation Λ^{Ξ}; and the intensity-modulated luminous fluxes in the left W_{form}^{L} and right W_{form}^{R} formation windows are formed with aid of a first and second optical converters respectively, which ones have complementary conversion parameters of ratio modulation, identical conversion parameters of indirect sum modulation and identical optical transmission parameters both for the direct ratio component and the direct sum component of luminous flux intensity, wherein the linearization function Λ^{Σ} of sum modulation and the linearization function Λ^{Ξ} of ratio modulation are determined by results of the corresponding calibration procedures with measuring of luminous flux intensity values in the W_{form}^{L}, W_{form}^{R} formation windows.

The given task is solved also by the second embodiment of the method, in which, with aid of an optical source a light wave is generated; with aid of a matrix-addressed first optical modulator a sum modulation of a light wave in the mn^{th} element of the first optical modulator is implemented in accordance with the sum of the values of Bₘₙ^{L}, and Bₘₙ^{R}; with aid of a matrix-addressed second optical modulator a coding modulation of a light wave is implemented in the mn^{th} element of the second optical modular in accordance with nonlinear functions from algebraic relations between the values of Bₘₙ^{L} and Bₘₙ^{R}, of the brightness of the mn^{th} image elements of the left and right views; assigning complementary initial optical modular parameters in the adjacent 2i and (2i−1) columns of the second optical modulator; assigning complementary optical analysis parameters for adjacent 2k and (2k−1) columns of an N-column addressed spatially-periodic optical analyzer, with aid of which forming the first and second groups of light beams with intensity values of Jₘₙ^{L} and Jₘₙ^{R}, equal to the values of Bₘₙ^{L} and Bₘₙ^{R} of the brightness of the mn^{th} image elements of the left and right views in the left Z_{form}^{L} and right Z_{form}^{L} formation zones respectively; wherein one group N of light beams is routed in one of the formation zones, the first N/2 of which pass through N/2 even 2i columns of the second optical modulator and through N/2 even 2k columns of the spatially-periodic optical analyzer, and the remaining N/2 planes pass through N/2 odd (2i−1) columns of the second optical modulator and through N/2 odd (2k−1) columns of the spatially-periodic optical analyzer; in another formation zone another group N of light beams is routed, the first N/2 of which pass through N/2 odd (2i−1) columns of the second optical modulator and through NI 2 even 2k columns of the spatially-periodic optical analyzer, and the remaining N/2 planes pass through N/2 even 2i columns of the second optical modulator and through N/2 odd (2k−1) columns of the spatially-periodic optical analyzer; and the left and right stereo image views are observed, respectively, in the left Z_{V}^{L} and right Z_{V}^{R} observation windows, which ones are optically connected, respectively, with the left Z_{form}^{L} and right Z_{form}^{R} formation zones; according to the invention, with aid of a matrix-addressed uniform-effect optical modulator a direct sum modulation is implemented due to modulation of the optical intensity value or an indirect sum modulation is implemented due to modulation of the remaining light wave physical characteristic, applying to its control input a sum compensating signal sₘₙ^{Σ}^{_{—}}^{comp} which amplitude is directly proportional to the values of the linearization function Λ^{Σ} of sum modulation; with aid of a difference-effect matrix-addressed optical modulator a direct ratio modulation is implemented due to modulation of optical intensity or an indirect ratio modulation is implemented due to modulation of the remaining light wave physical characteristics, assigning thereby complementary values of ratio modulation characteristic in the adjacent 2i and (2i−1) columns of the difference-effect optical modulator, whereas applying to its control input a ratio compensating signal sₘₙ^{Ξ}^{_{—}}^{comp}, which amplitude is directly proportional to the values of the linearization function Λ^{Ξ} of ratio modulation, the first and second groups of modulated intensity light beams are formed with aid of an N-column addressed spatially-periodic optical converter, that is characterized by complementary conversion parameters for ratio modulation for its adjacent 2k and (2k−1) columns, by identical conversion parameters for indirect sum modulation, by identical optical transmission parameters for both of direct ratio component and direct sum component of the luminous flux intensity in all N columns of the difference-effect optical modulator, wherein the linearization function Λ^{Σ} of sum modulation and the linearization function Λ^{Ξ} of ratio modulation are determined by the results of calibration procedures with measuring luminous flux intensity values in the W_{form}^{L}, W_{form}^{R} formation windows.

The given task is also solved due to the fact that in the device comprising a stereo video signal source, an optical source and an electrically controlled optical module, that is optically connected with the optical source and comprises sequentially arranged along an optical axis an optical summation section, that is addressed in M rows and N columns the, an optical encoding section, that is addressed in M rows and N columns, and a spatially-selective optical decoding section, that is addressed in N columns, and also a first and second functional modules, which outputs are connected with the control inputs of the optical summation section and optical encoding section respectively, whereas the inputs of the first and second functional modules are connected with the corresponding outputs of the stereo video signal source, wherein the aperture of the mn^{th} element of the optical summation section is optically connected with the aperture of the mn^{th} element of the optical encoding section, whereas the initial optical states of the working medium are complementary between the adjacent (2i−1) and 2i columns of the optical encoding section and between the adjacent (2k−1) and 2k columns of the spatially-selective optical decoder; the axis of symmetry of one of the formation zones Z_{form}^{L}, Z_{form}^{R} is the common intersection line of one group of N planes, of which the first N/2 planes pass through the axes of symmetry of the odd (2k−1) columns of the optical encoding section and through the axes of symmetry of the even 2i columns of the spatially-selective optical decoding section, and the remaining N/2 planes pass through the axes of symmetry of the even 2k columns of the optical encoding section and through the axes of symmetry of the odd (2i−1) columns of the spatially-selective optical decoding section; the axis of symmetry of another of formation zones Z_{form}^{L}, Z_{form}^{R} is the common intersection line of another group of N planes, of which the first N/2 planes pass through the axes of symmetry of the even 2k columns of the optical encoding section and through the axes of symmetry of the odd (2i−1) columns of the spatially-selective optical decoding section, and the remaining N/2 planes pass through the axes of symmetry of the odd (2k−1) columns of optical encoder and through the axes of symmetry of the even 2i columns of the spatially-selective optical decoder; according to the invention, the electrically controlled matrix-addressed optical module is implemented with possibility of mutual permutation of the optical summation, the optical encoder and the spatially-selective optical decoding sections or/and their components along the optical axis, which ones are implemented respectively in the form of a sum optical modulator, a ratio optical modulator and an optical selector, each of which contains at least one layer of working medium with two complementary arbitrary optical states and with unambiguous characteristic of transition between said states, the first functional module is implemented with transfer function T^{Σ}, that is the inverse of the transfer function Φ^{ch}^{_{—1}} of the first optoelectronic channel: T^{Σ}=F⁻¹{Φ^{ch}^{_{—}}¹}, the input of that is the control input of the sum optical modulator, and the optical output of the first optoelectronic channel is either of the formation zones Z_{form}^{L}, Z_{form}^{R}; the second electronic functional module is implemented with transfer function T^{Ξ}, that is the inverse of the transfer function Φ^{ch}^{_{—}}² of the second optoelectronic channel: T^{Ξ}=F⁻¹{Φ^{ch}^{_{—}}²}, the input of that is the control input of the ratio optical modulator, whereas the optical outputs of the second optoelectronic channel are the apertures of both formation zones Z_{form}^{L}, Z_{form}^{R}, and the values of the transfer functions of the first and second optoelectronic channels correspond to the optical intensity values.

In the method and device the sum and ratio modulation of the luminous flux are implemented with use of any modulation effect of luminous flux. The characteristics of the sum and ratio modulation are linearized according to the results of the calibration procedures. The calibration procedures are carried out by measuring the intensity of the light in the formation windows (zones) while applying the calibration signals to the control inputs of the sum and ratio optical modulators. As the result of the linearization, a linear reproduction of the sum of the values of B_{L}^{mn}+B_{R}^{mn} in both formation windows together with a linear reproduction of the ratio of values B_{L}^{mn}/B_{R}^{mn} between formation windows are provided.

The technical result of solving the task in the method and device is an improvement of the quality of stereo image due to possibility of using various advanced optical structures along with autocompensation of spurious nonlinear components of transmission characteristics of the optical structures regardless of their complexity.

A real-amplitude sum modulation is used in the first, second and fourth particular embodiments of the method and in the first particular embodiment of implementation of device. A ratio phase-polarization modulation, including its combination with real-amplitude modulation, is used in the second, fourth, fifth and sixth particular embodiments of the method. A spectral and diffraction (angular) ratio modulations are used respectively in the second and third particular embodiments of the method. A ratio bistable modulation is used in the fourth particular embodiment of the method.

In the fifth and sixth particular embodiments of implementation of the method and in the first particular embodiment of the device the additional technical result is the increase in optical efficiency of the optoelectronic channels of image formation.

The invention is explained by a description of the embodiments, illustrated in the following drawings.

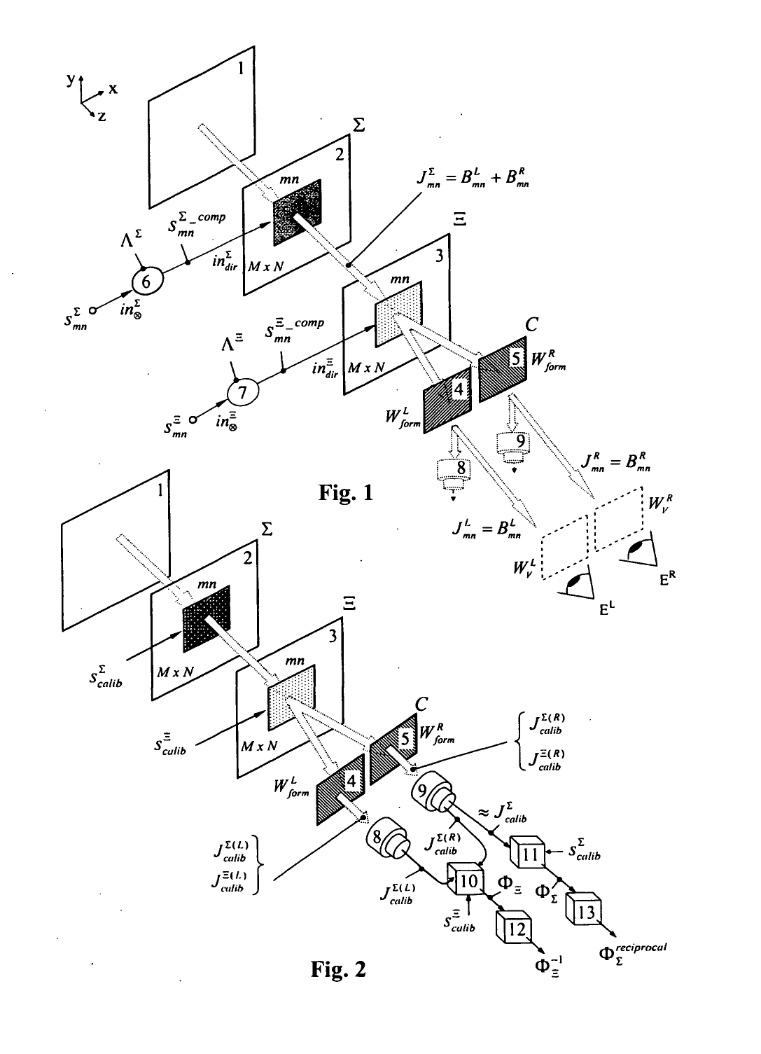

FIG. 1 is a schematic diagram of the first embodiment of the method.

FIG. 2 is a schematic diagram of calibration (measurement of nonlinearity function) and determination (calculation) of linearization function for the first embodiment of the method.

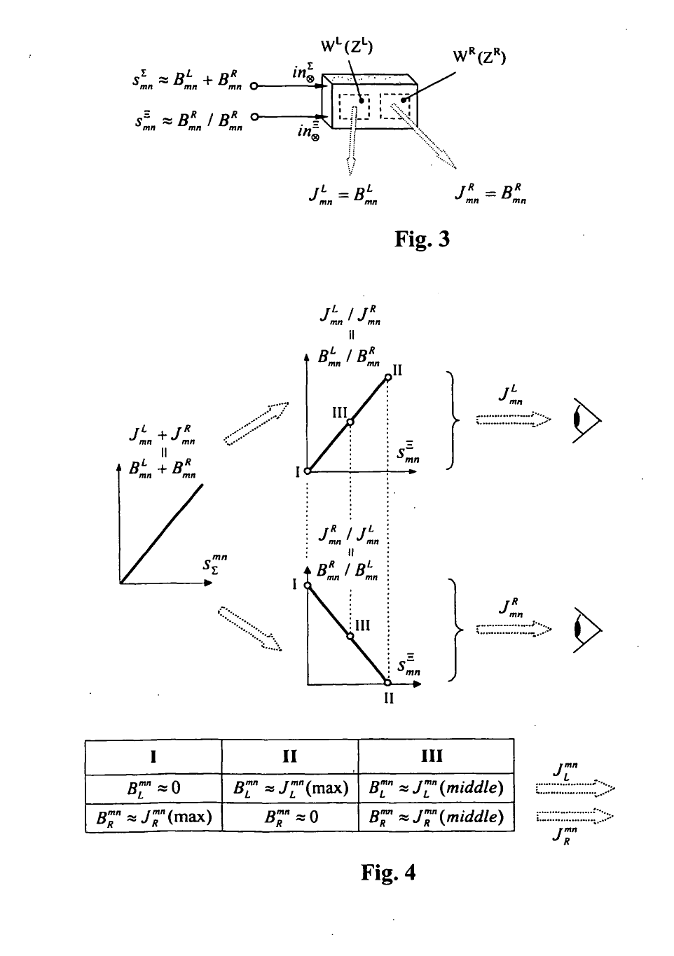

FIG. 3, 4 is an illustration of the method as a combined performance of two optoelectronic channels, linearized in relation to luminous flux intensity.

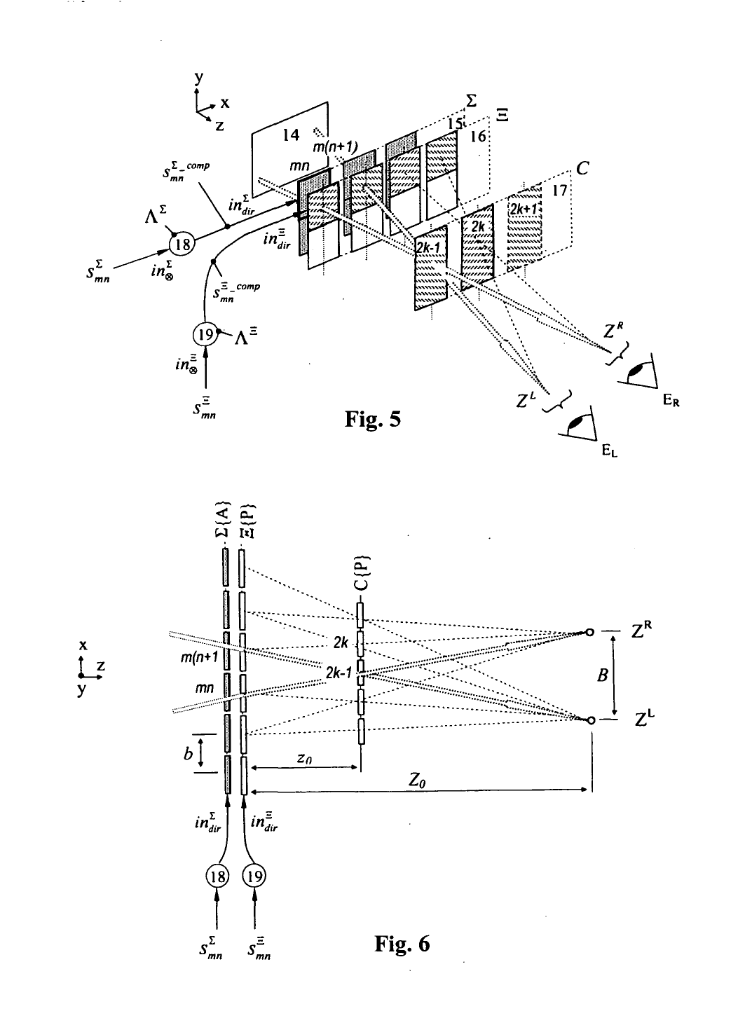

FIG. 5, 6 is a scheme of implementation of the first embodiment of method.

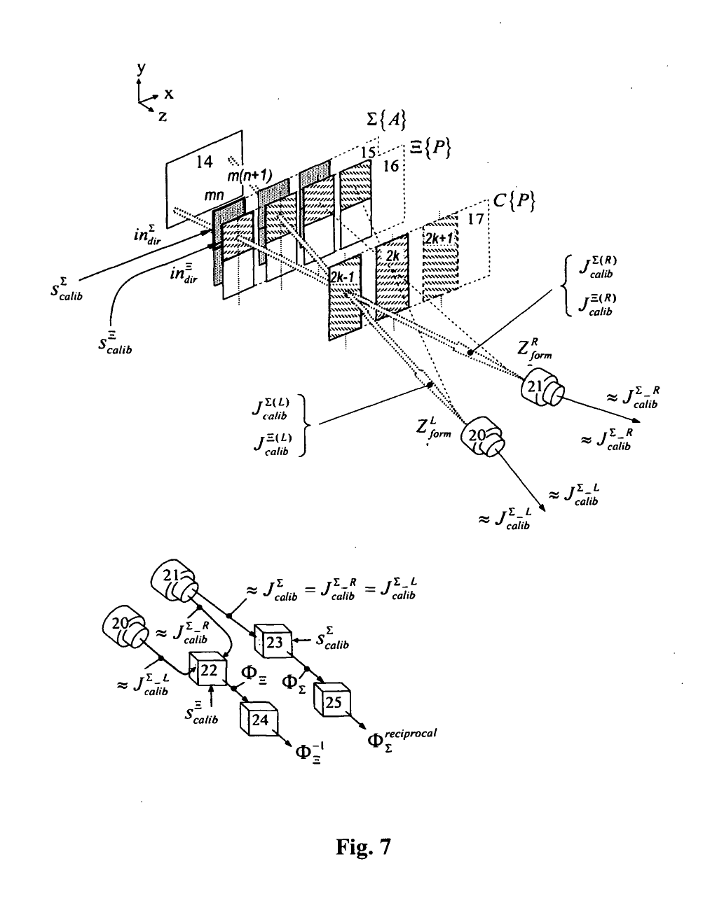

FIG. 7 is a schematic diagram of the second method embodiment.

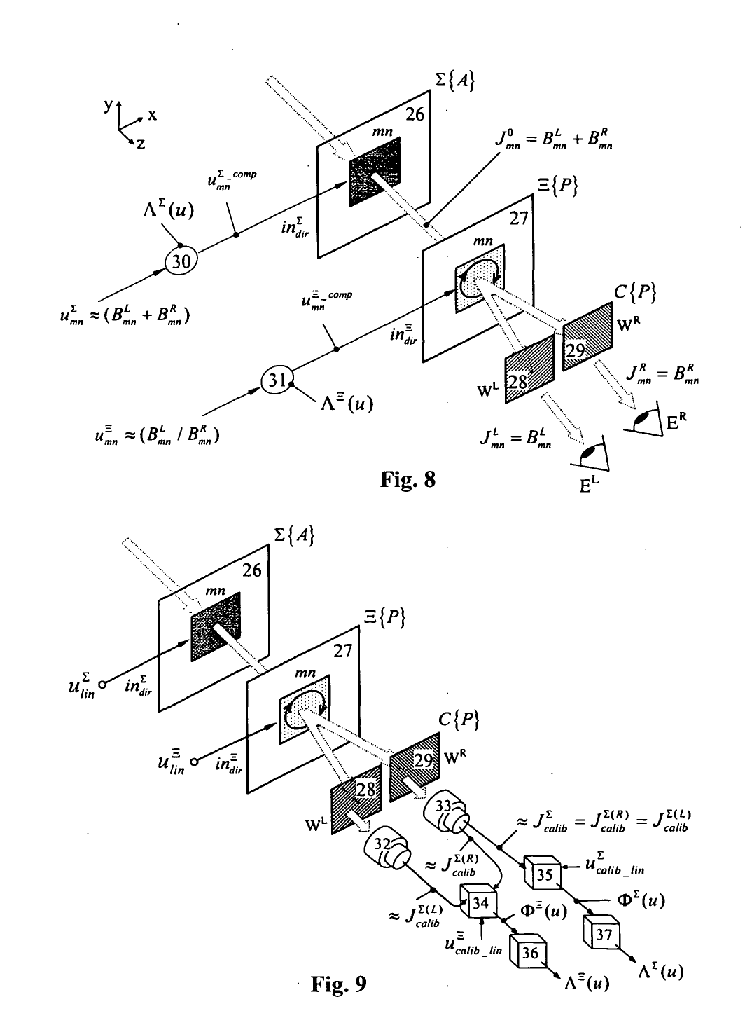

FIG. 8, 9 is a schematic diagram of first particular embodiment of the first embodiment of the method.

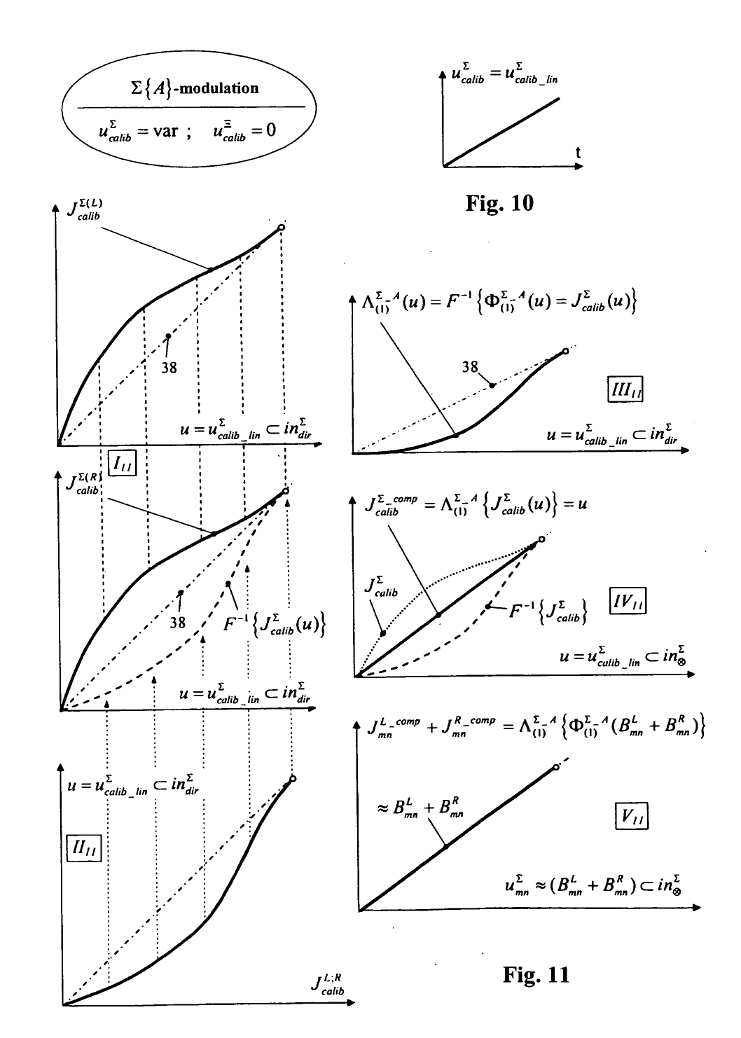

FIG. 10, 11 is an illustration of linearization procedure for sum modulation by a method of taking an inverse function.

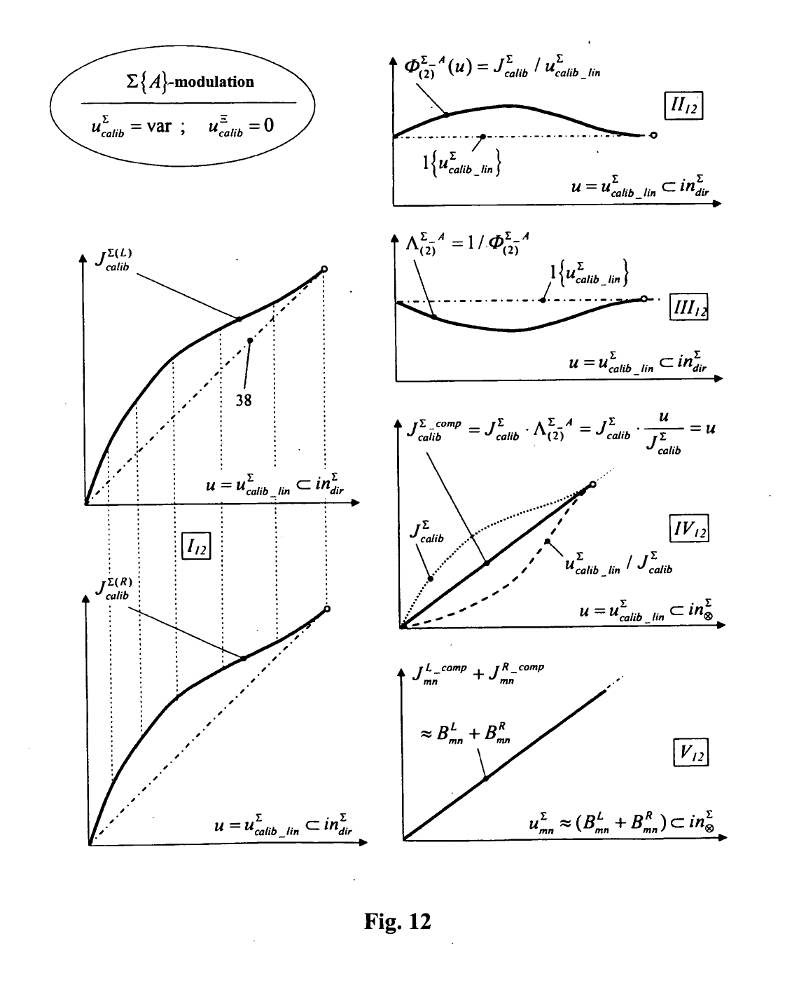

FIG. 12 is an illustration of linearization procedure for sum modulation by a method of reciprocal values.

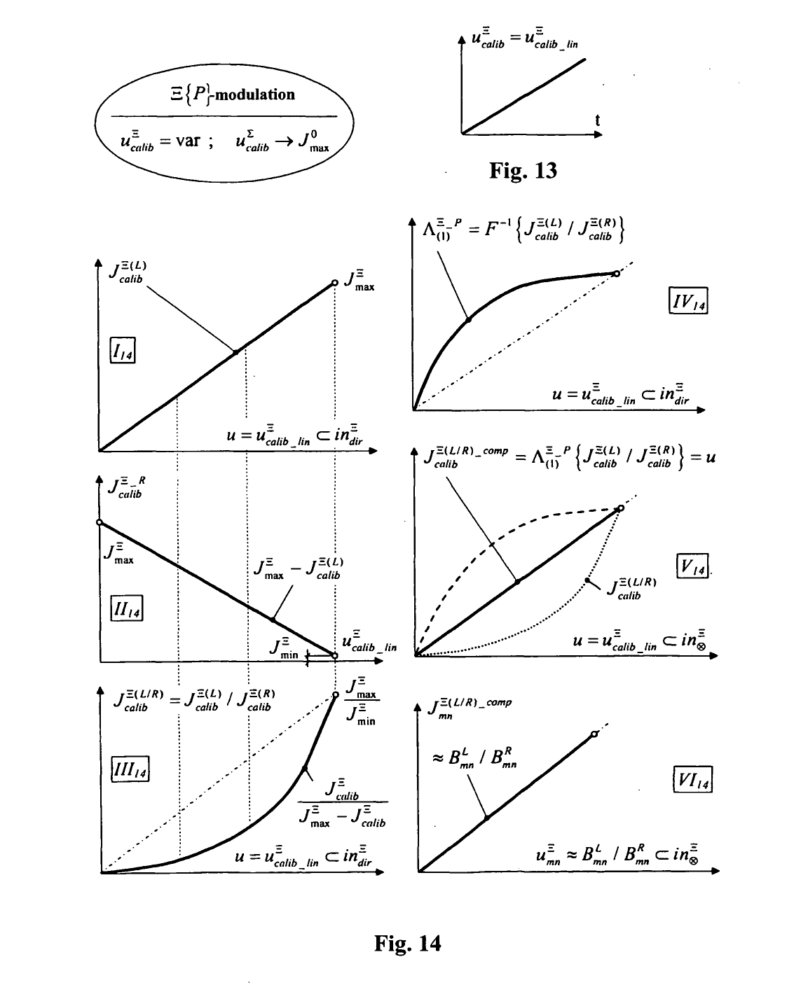

FIG. 13, 14 is an illustration of linearization procedure for ratio modulation by a method of taking an inverse function.

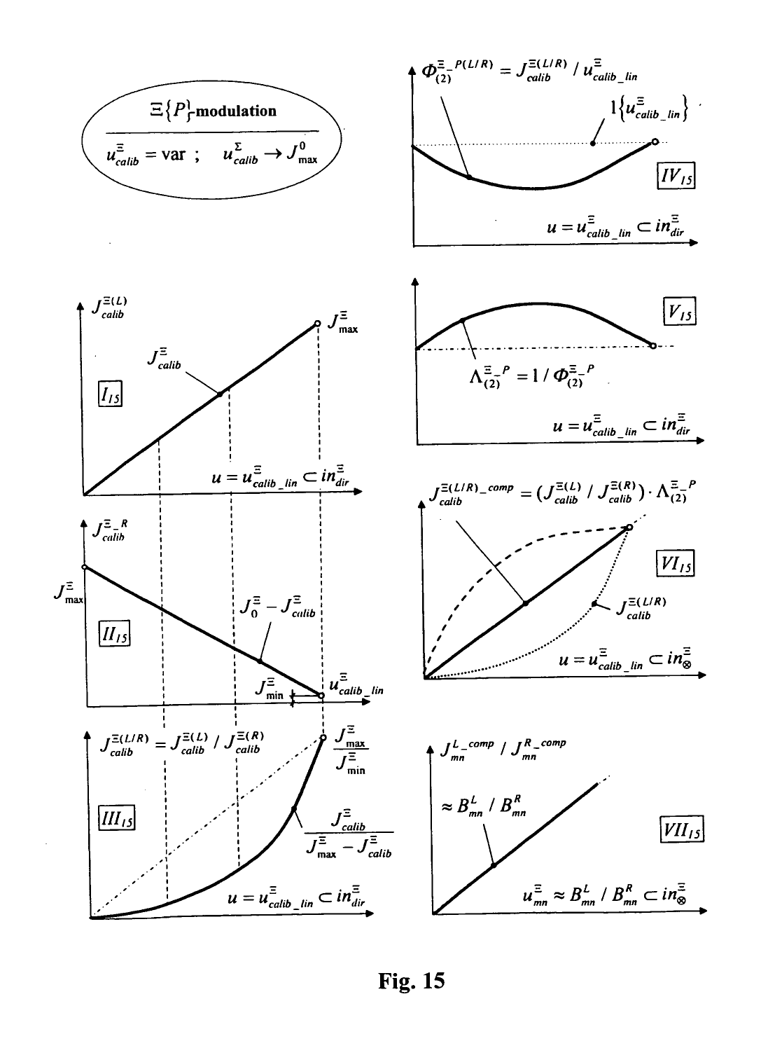

FIG. 15 is an illustration of a linearization procedure for ratio modulation by calculating inverse values.

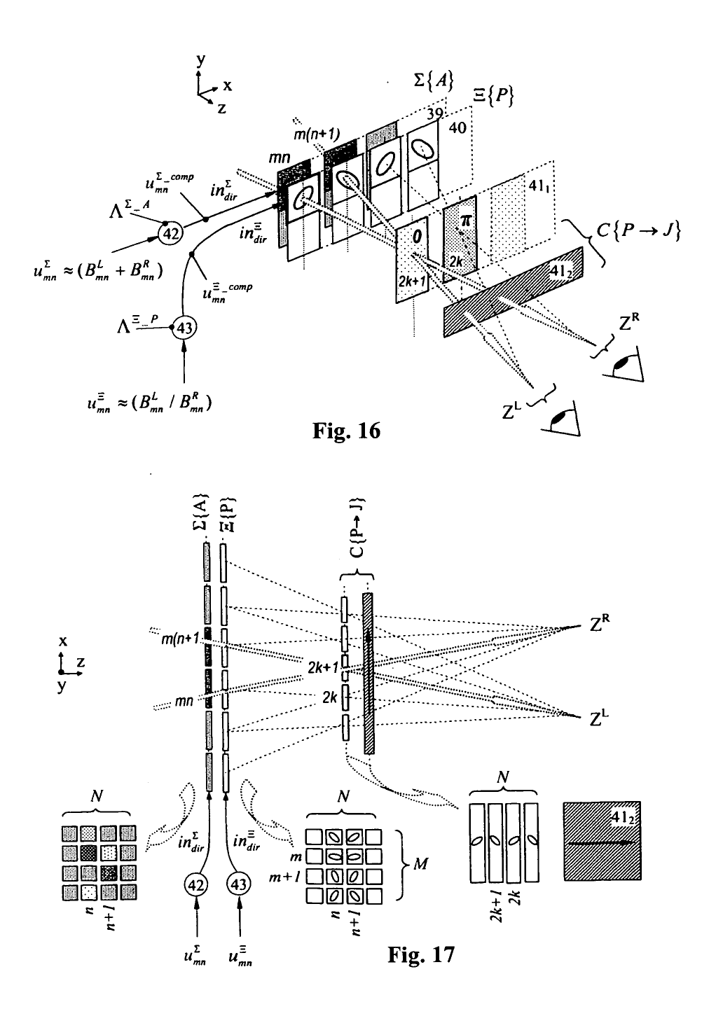

FIG. 16, 17 is an schematic diagram of first particular embodiment of the second embodiment of the method.

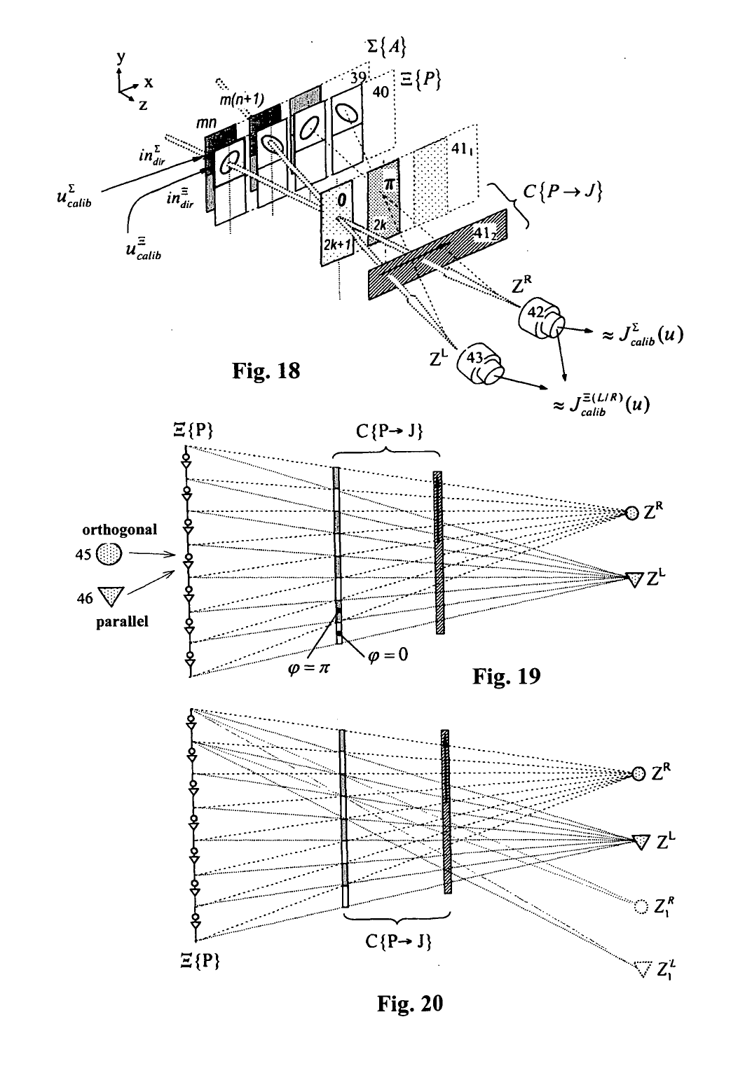

FIG. 18, 19 is an schematic diagram of implementation of calibration and illustration of selection of views for the first particular embodiment of the second embodiment of the method.

FIG. 20 is an illustration of appearance of secondary formation zones.

FIG. 21-23 is a schematic diagram of implementation, calibration and graphing of modulation linearization for the second particular embodiment of first embodiment of method.

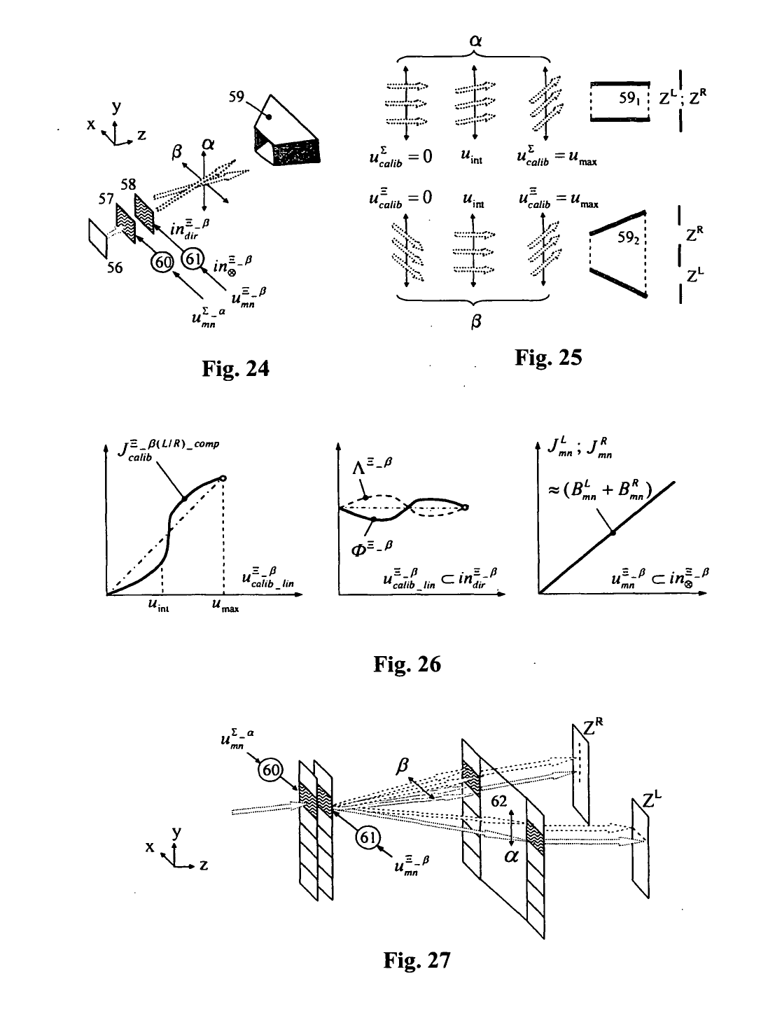

FIG. 24-27 is a schematic diagram of implementation, calibration and graphing of linearization for the third particular embodiment of the first embodiment.

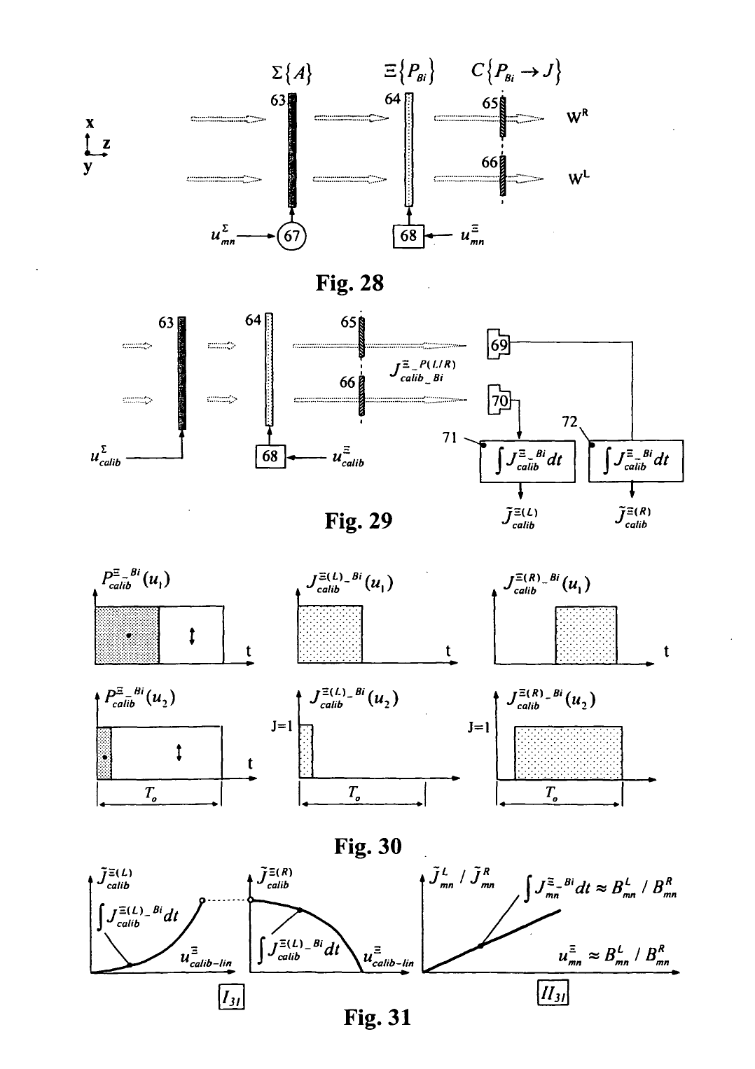

FIG. 28-31 is a schematic diagram of implementation, calibration and graphing of linearization for the fourth particular embodiment of the first embodiment of the method.

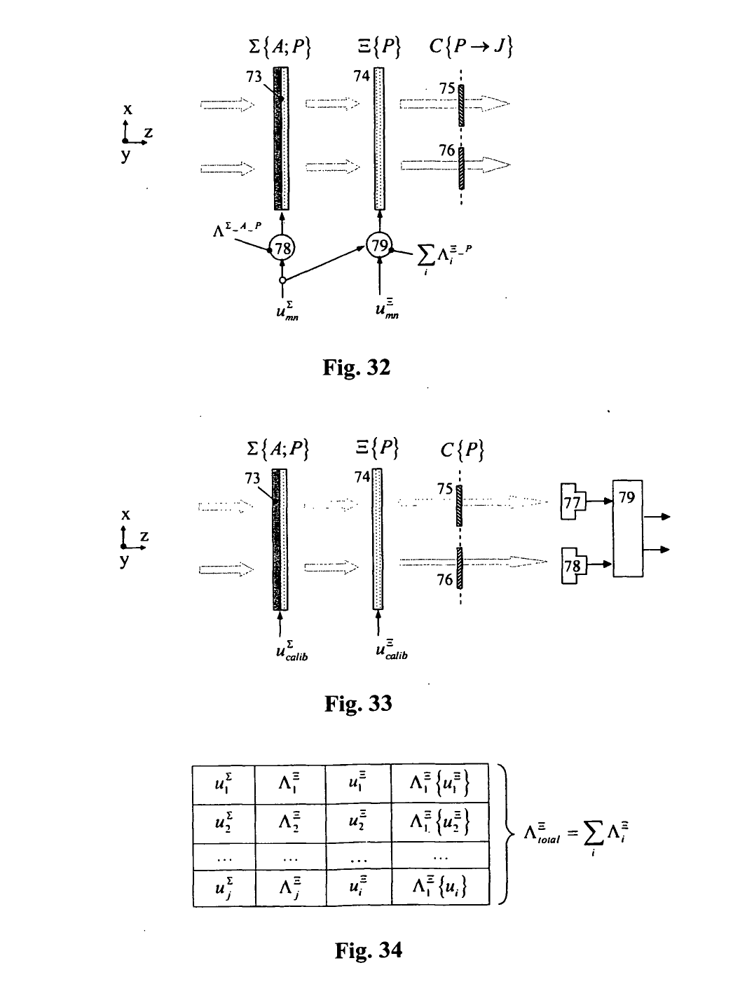

FIG. 32, 33 is a schematic diagram of implementation of the fifth particular embodiment of first embodiment of the method.

FIG. 34 is a matrix representation of a two-dimensional linearization function of ratio modulation in the fifth particular embodiment of the method.

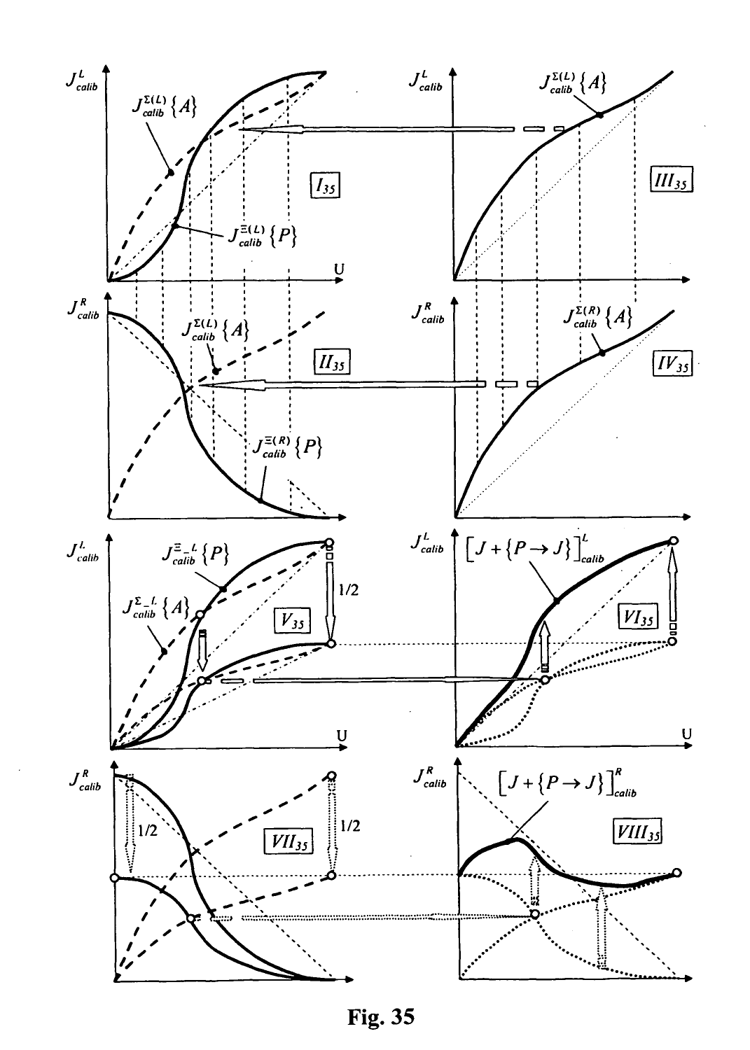

FIG. 35 is an illustration of appearance of asymmetry in sum modulation graphs in presence of nonlinear dependence between sum and ratio modulation.

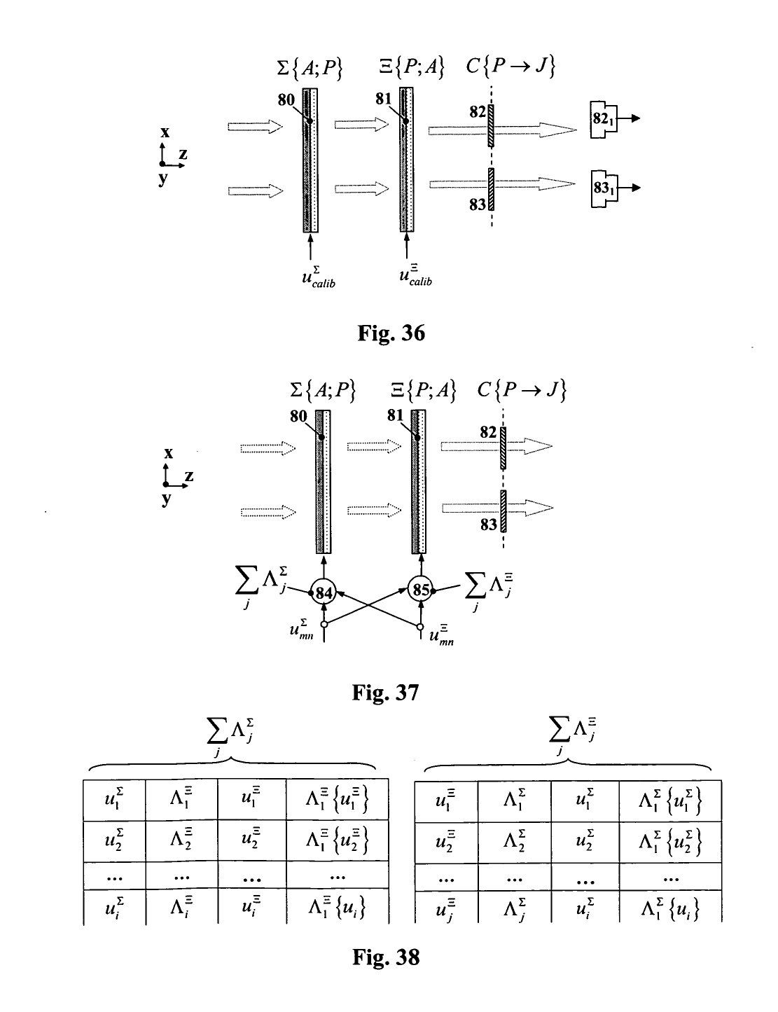

FIG. 36, 37 is a schematic diagram of implementation of the sixth particular embodiment of first embodiment of the method.

FIG. 38 is a matrix representation of two-dimensional linearization functions in the sixth particular embodiment of the first embodiment of the method.

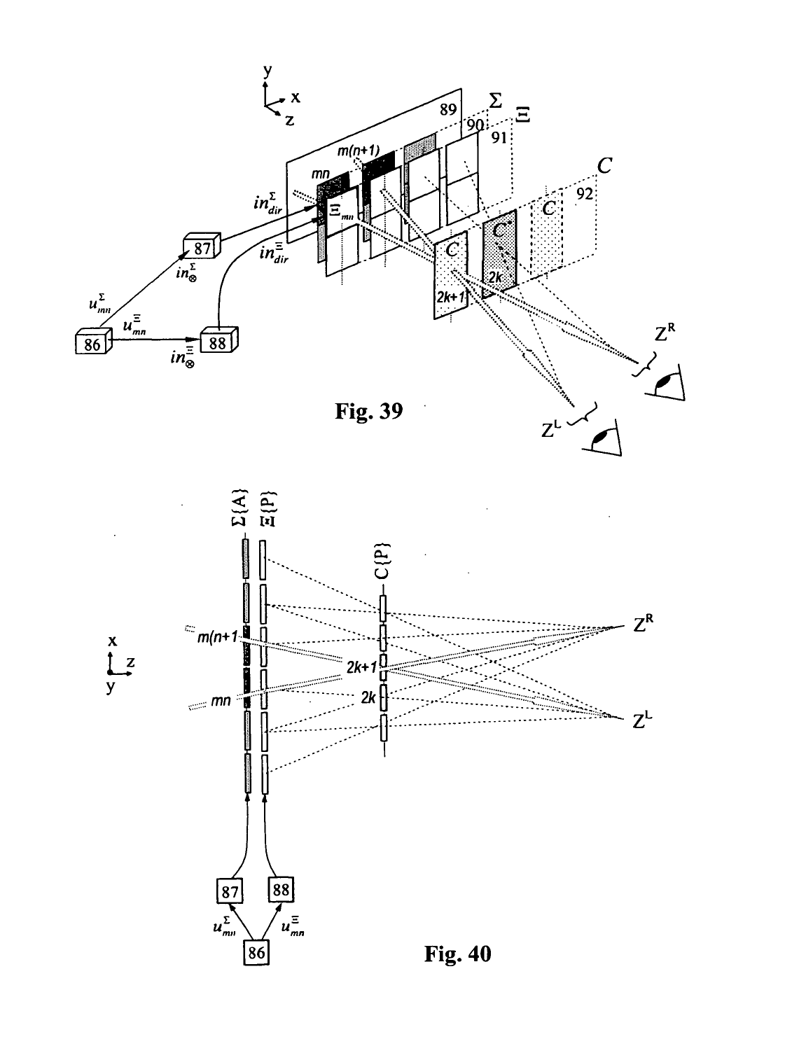

FIG. 39, 40 is a schematic diagram of a device for implementation of the method.

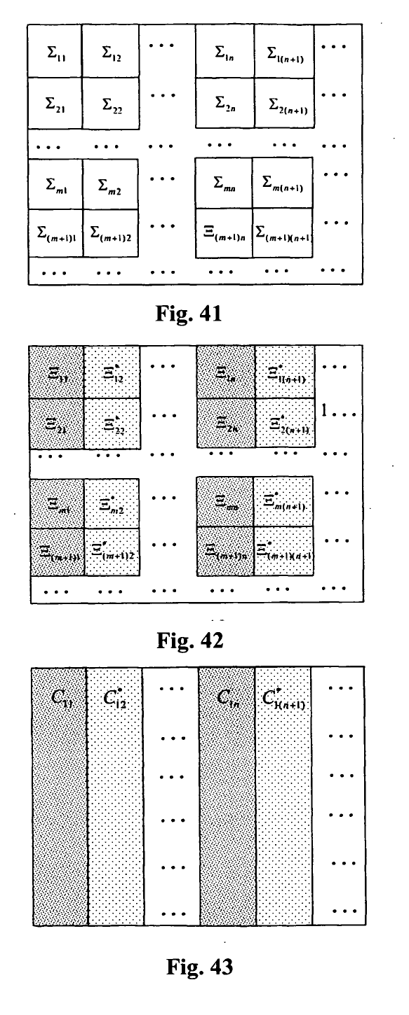

FIG. 41-43 shows optical states of sum and ratio optical modulators and of an optical selector in the device.

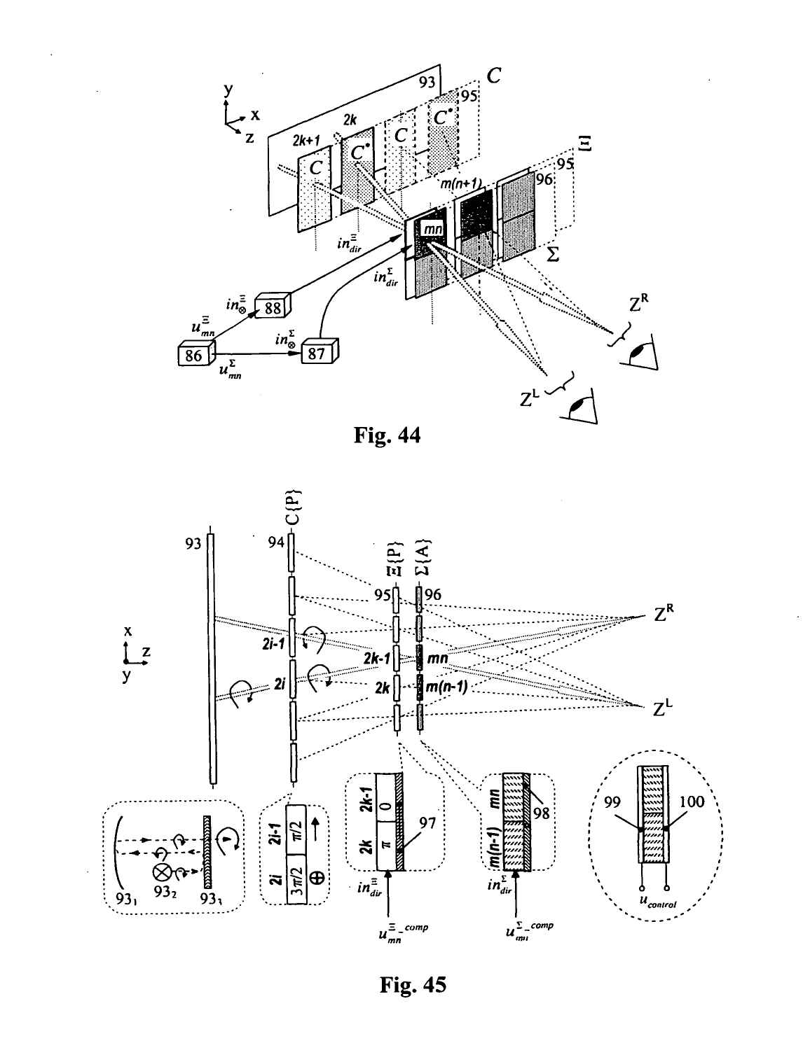

FIG. 44, 45 is a schematic diagram and explanation of work of the first particular embodiment of the device.

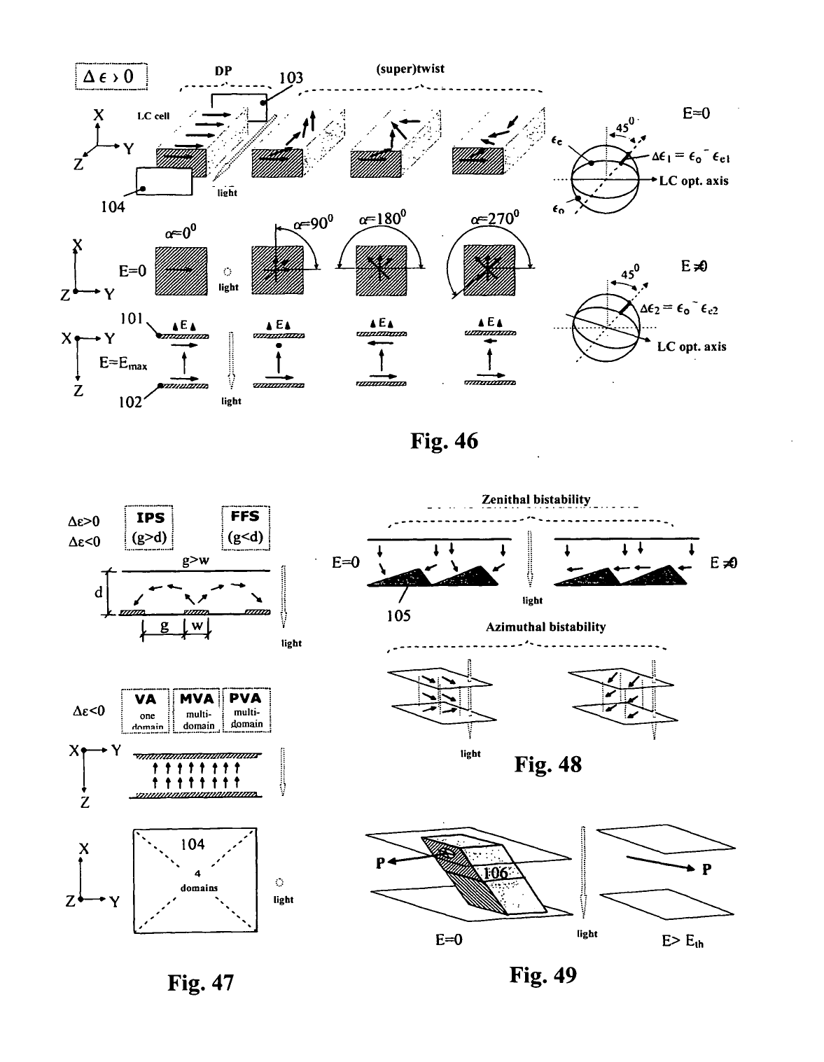

FIG. 46-49 is an illustration of principle of operation of phase-polarization LC cells, that is preferably used for implementation of ratio modulation.

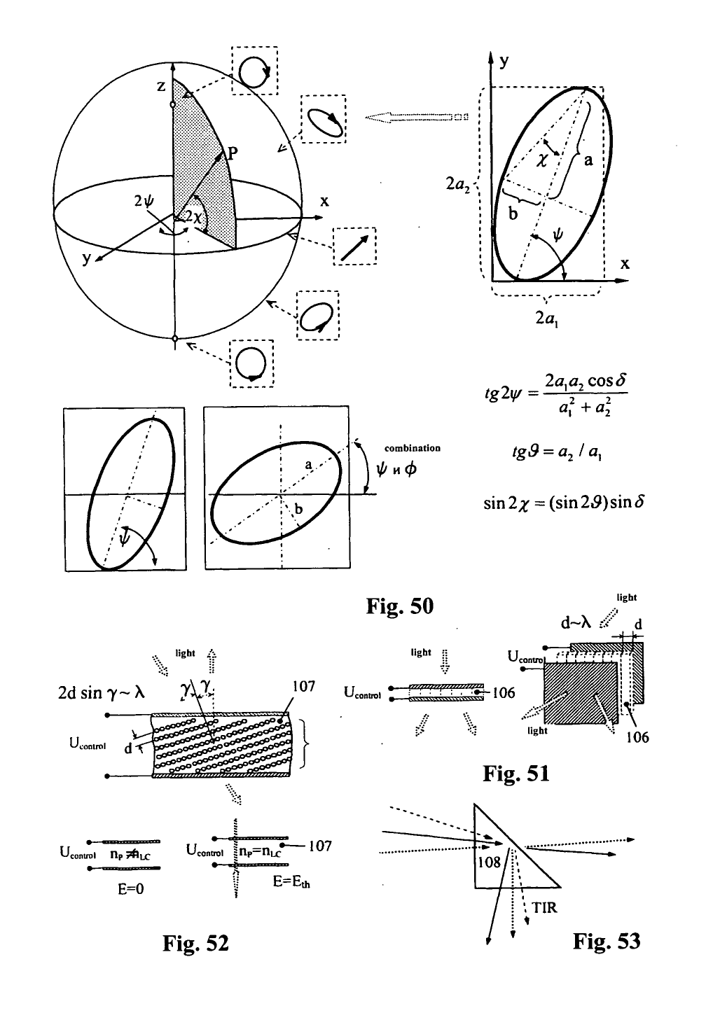

FIG. 50 is an illustration with help of Poincare's sphere of generality of description of properties of anisotropic optical elements.

FIG. 51, 52 is an illustration of principle of operation of polaroid-less LC cells, which it is possible to use for implementation of sum modulation.

The method (first embodiment) of forming and observing stereo images with maximum optical resolution comprises in that: with aid of an optical source 1 (FIG. 1), a light wave is generated; with aid of a uniform-effect optical modulator 2, that is matrix-addressed in M rows and N columns, the uniform optical modulation is carried out, causing the identical in a value and in a sign optical intensity changes in the left W_{form}^{L} and right W_{form}^{R} formation windows, wherein a direct sum modulation Σ is implemented due to modulation of the optical intensity or an indirect sum modulation Σ is implemented due to modulation of remaining light wave physical characteristics such as a direction of propagation or a value of convergence-divergence angle or a spectral characteristic or a polarization state or a phase value is implemented due to modulation of a combination of the remaining light wave characteristics in the mn^{th} element of uniform-effect optical modulator 2 (m=1, 2, . . . M; n=1, 2, . . . N), applying to its control input in_{dir}^{Σ} a sum compensating signal sₘₙ^{Σ}^{_{—}}^{comp}; with aid of difference-effect optical modulator 3, that is matrix-addressed in M rows and N columns, a difference-effect optical modulation is implemented, causing the identical in a value but different in a sign optical intensity changes in the left W_{form}^{L} and right W_{form}^{R} formation windows; whereas a direct ratio modulation Ξ is implemented due to modulation of optical intensity, either an indirect ratio modulation Ξ is implemented due to modulation of remaining physical characteristics of light wave such as the direction of propagation or the value of convergence-divergence angle or the spectral characteristic or the polarization state or the phase value or is implemented due to modulation of a combination of the remaining light wave characteristics in the mn^{th} element of ratio optical modulator 3, whereas applying to its control input in_{dir}^{Ξ} a ratio compensating signal sₘₙ^{Ξ}^{_{—}}^{comp}; the modulated by intensity luminous fluxes are formed in the left W_{form}^{L} and right W_{form}^{R} formation windows with aid, respectively, of the first 4 and the second 5 optical converters which ones have the complementary parameters of ratio modulation conversion, the identical conversion parameters of an indirect sum modulation, the identical parameters of the optical transmission of both direct ratio component and direct sum component of the luminous flux intensity; and the left and right views of the stereo image are observed, respectively, in the left W_{V}^{L} and right W_{V}^{R} observation windows, which are optically connected, respectively, with the left W_{form}^{L} and right W_{form}^{R} formation windows.

The sum compensating signal sₘₙ^{Σ}^{_{—}}^{comp} in its first particular embodiment s₍₁₎ₘₙ^{Σ}^{_{—}}^{comp} has an amplitude that is directly proportional to the value of the linearization function Λ^{Σ} of sum modulation in its first particular embodiment Λ₍₁₎^{Σ}, taken from the sum Bₘₙ^{L}+Bₘₙ^{R} of the values of the brightness of the mn^{th} image elements of the left and right views:

s₍₁₎ₘₙ^{Σ}^{_{—}}^{comp}≈Λ₍₁₎^{Σ}{Bₘₙ^{L}+Bₘₙ^{R}}, (1)

and in the second particular embodiment s₍₂₎ₘₙ^{Σ}^{_{—}}^{comp} the amplitude of the signal is directly proportional to the product of the sum Bₘₙ^{L}+Bₘₙ^{R} by the linearization function Λ^{Σ} of sum modulation in its second particular embodiment Λ₍₂₎^{Σ}:

s₍₂₎ₘₙ^{Σ}^{_{—}}^{comp}≈(Bₘₙ^{L}+Bₘₙ^{R})·Λ₍₂₎^{Σ}, (2)

The ratio compensating signal sₘₙ^{Ξ}^{_{—}}^{comp} in its first particular embodiment s₍₁₎ₘₙ^{Ξ}^{_{—}}^{comp} has an amplitude that is directly proportional to the values of the linearization function Λ^{Ξ} of ratio modulation in its first particular embodiment Λ₍₁₎^{Ξ}, taken from the ratio Bₘₙ^{L}/Bₘₙ^{R} of the values of the brightness in the mn^{th} image elements of the left and right views:

s₍₁₎ₘₙ^{Ξ}^{_{—}}^{comp}≈Λ₍₁₎^{Ξ}{Bₘₙ^{L}/Bₘₙ^{R}}, (3)

and in the second particular embodiment s₍₂₎ₘₙ^{Ξ(L/R)}^{_{—}}^{comp} the amplitude of the signal is directly proportional to the product of the ratio Bₘₙ^{L}/Bₘₙ^{R} by the linearization function Λ^{Ξ} of ratio modulation in its second particular embodiment Λ₍₂₎^{Ξ}:

s₍₂₎ₘₙ^{Ξ}^{_{—}}^{comp}≈(Bₘₙ^{L}/Bₘₙ^{R})·Λ₍₂₎^{Ξ}, (4)

The linearization function Λ^{Σ} of sum modulation in its first particular embodiment Λ₍₁₎^{Σ} is defined as the function F⁻¹{Φ₍₁₎^{Σ}}, that is the inverse function of the calibration function Φ^{Σ} of sum modulation nonlinearity in its first particular embodiment Φ₍₁₎^{Σ}:

Λ₍₁₎^{Σ}=F⁻{Φ₍₁₎^{Σ}}, (5)

the linearization function Λ^{Σ} of sum modulation in its second particular embodiment Λ₍₂₎^{Σ} is defined as the function F^{reciprocal}{(Φ₍₂₎^{Σ}}, that is the reciprocal function 1/Φ₍₂₎^{Σ} to the calibration function Φ^{Σ} of the sum modulation nonlinearity in its second particular embodiment Φ₍₁₎^{Σ}:

Λ₍₂₎^{Σ}=F^{reciprocal}{Φ₍₂₎^{Σ}}=1/Φ₍₂₎^{Σ}, (6)

the linearization function of ratio modulation Λ^{Ξ} its first particular embodiment Λ₍₁₎^{Ξ} is defined as the function F⁻¹{Φ₍₁₎^{Ξ}}, that is the inverse of the calibration function Φ^{Ξ} of ratio modulation nonlinearity in its first particular embodiment Φ₍₁₎^{Ξ}:

Λ₍₁₎^{Ξ}=F⁻¹{Φ₍₁₎^{Ξ}}, (7)

and the linearization function of ratio modulation Λ^{Ξ} in its second particular embodiment Λ₍₂₎^{Ξ} is defined as the function F^{reciprocal}{Φ₍₂₎^{Ξ}}, that is the reciprocal function 1/Φ₍₂₎^{Ξ} to the calibration function Φ^{Ξ} of the ratio modulation nonlinearity in its second particular embodiment Φ₍₂₎^{Ξ}:

Λ₍₂₎^{Ξ}=F^{reciprocal}{Φ₍₂₎^{Ξ}}=1/Φ₍₂₎^{Ξ}, (8)

where the calibration function Φ^{Ξ} of the assemblage modulation nonlinearity in its first particular embodiment Φ₍₁₎^{Σ} is equal to the assemblage of the calibration values of the uniformly modulated component J_{calib}^{Σ} of the luminous flux intensity in the output of either of the formation windows W_{form}^{L}, W_{form}^{R} (FIG. 2):

Φ₍₁₎^{Σ}=J_{calib}^{Σ}, (9)

whereas applying to the control input in_{dir}^{Σ} of the uniform-effect optical modulator 2 a linearly-varying calibration signal s_{calib}_{_{—}}ₗᵢₙ^{Σ} of sum modulation and the calibration function of sum modulation nonlinearity; the calibration function Φ^{Ξ} in its second particular embodiment Φ₍₂₎^{Σ} is equal to the ratio of the sequence of calibration values of uniformly modulated component J_{calib}^{Σ} of the luminous flux intensity in either of the formation windows W_{form}^{L}, W_{form}^{R} the sequence of the corresponding values of the amplitude of the monotonically-varying calibration signal s_{calib}^{Σ} of sum modulation:

Φ₍₂₎^{Σ}≈J_{calib}^{Σ}/s_{calib}^{Σ}, (10)

the calibration function of the ratio modulation nonlinearity in its first particular embodiment Φ₍₁₎^{Ξ(L/R)} is equal to the ratio of the assemblage of calibration values of the difference-modulated component J_{calib}^{Ξ(L)} of the luminous flux intensity in the left formation window W_{form}^{L} to the assemblage of the calibration values of the difference-modulated component J_{calib}^{Ξ(R)} of the luminous flux intensity in the right formation window W_{form}^{R}:

Φ₍₁₎^{Ξ(L/R)}≈J_{calib}^{Ξ(L)}/J_{calib}^{Ξ(R)}, (11)

whereas applying to the control input in_{dir}^{Ξ} of the difference-effect optical modulator 4 a linearly-varying calibration signal s_{calib}_{_{—}}ₗᵢₙ^{Ξ} of ratio modulation; and the calibration function of the ratio modulation nonlinearity in its second particular embodiment Φ₍₂₎^{Ξ(L/R)} is equal to the ratio of the assemblage of the calibration values of the difference-modulated component J_{calib}^{Ξ(L)} of the luminous flux intensity in the left formation window W_{form}^{L} to the assemblage of the calibration values of the difference-modulated component J_{calib}^{(R)} of the luminous flux intensity in the right formation window W_{form}^{R}, divided by the assemblage of the corresponding values of the amplitude of the monotonically-varying calibration signal s_{calib}^{Ξ} of ratio modulation:

$${Φ}_{( 2 )}^{Ξ ( L / R )} = \frac{{J}_{calib}^{Ξ ( L )} / {J}_{calib}^{Ξ ( R )}}{{s}_{calib}^{Ξ}} . \qquad ( 12 )$$

The locations of the left E^{L} and right E^{R} eyes of the observer during observation of stereo image correspond to the arrangement of the left W_{form}^{L} and right W_{form}^{R} observation windows, for example, to the left and right windows of passive stereo glasses wearing by the observer. The apertures of the left and right formation windows spatially coincides with the apertures, respectively, of the left W_{V}^{L} and right W_{V}^{R} observation windows, when each of two optical converters is the optical element of the corresponding window of the stereo glasses.

Symbols W^{L} and W^{R} (Z^{L} and Z^{R}) on the figures note the spatial coincidence of the left formation window W_{form}^{L} with the left observation window W_{V}^{L} (of the left formation zone Z_{form}^{L} with the left observation zone Z_{V}^{L}) and the right formation window W_{form}^{R} with the right observation window W_{V}^{R} (of the right formation zone Z_{form}^{R} with the right observation zone Z_{V}^{R}).

The sum compensating signal sₘₙ^{Σ}^{_{—}}^{comp} is received on the output of functional module 5 having the transfer function, equal to the linearization function Λ^{Σ} of sum modulation, whereas applying to the input of functional module 5 the initial sum signal Sₘₙ^{Σ}, which amplitude is directly proportional to the sum Bₘₙ^{L}+Bₘₙ^{R}:

sₘₙ^{Σ}≈Bₘₙ^{L}+Bₘₙ^{R}, (13)

The ratio compensating signal sₘₙ^{Ξ}^{_{—}}^{comp} is received on the output of functional module 7 having the transfer function, equal to the linearization function Λ^{Ξ} of ratio modulation, whereas applying to the input of functional module 7 the initial ratio modulation signal sₘₙ^{Ξ} which amplitude is directly proportional to the Bₘₙ^{L}/Bₘₙ^{R}:

sₘₙ^{Ξ}≈Bₘₙ^{L}/Bₘₙ^{R}. (14)

The intensity calibration values are measured with aid of photo detectors 8, 9, which output signals enter processing modules 10, 11, in which, in accordance with relations (7)-(10), the calibration functions Φ^{Σ} and Φ^{Ξ} of nonlinearity of sum modulation and ratio modulation are calculated, and according to which, the linearization function Λ^{Σ} of sum modulation and the linearization function Λ^{Ξ} of ratio modulation are calculated in processing modules 12, 13 in accordance with relations (5)-(8), according to which the transfer functions of functional modules 6, 7 are set during observation of the formed stereo image.

With spatial invariant (identical for all M·N image elements of each of the views) calibration function Φ^{Σ} of sum modulation nonlinearity and the calibration function Φ^{Ξ} of ratio modulation nonlinearity, each of the calibration values of uniformly modulated component J_{calib}^{Σ} and difference-modulated component J_{calib}^{Ξ(L)} of luminous flux intensity is measured with the spatial sum (integration) of the luminous flux intensity (by a photo receiver's aperture or by a lens to the photo receiver's aperture) throughout the entire area of each of the formation windows. With spatially not invariant calibration function Φ^{Σ} of sum modulation nonlinearity and the ratio modulation nonlinearity function Φ^{Ξ}, a separate calibration function of nonlinearity is determined for each partial area of spatial invariance.

It is preferable to use the photo detectors 8, 9 with the transmission characteristics close to the corresponding characteristics of perceiving image luminous flux by the human vision.

Upon superposition at the time of the stereo image observing process with the calibration process (with the process of measuring intensity calibration values, by calculation of the corresponding nonlinearity functions and setting or assigning the corresponding transfer linearization functions), the luminous fluxes from the left W_{form}^{L} and right W_{form}^{R} formation windows simultaneously enter both the left W_{V}^{L} and right W_{V}^{R} observation windows and the apertures of photo detectors 8, 9.

The values of the brightness of the mn^{th} image elements of the left Bₘₙ^{L} and right Bₘₙ^{R} views correspond to the values of the brightness of the corresponding three-dimensional scene (the stereo image of that is formed and observed in accordance with the method), integrated according to the aperture angle of the lenses of the left and right photographing video cameras, i.e., Bₘₙ^{L} and Bₘₙ^{R} are numerically equal to the luminous flux intensity values which enter the aperture of the lenses of the left and right video cameras from the mn^{th} element of the three-dimensional scene being imaged.

In the method it is equivalent to consider the ratio compensating signal sₘₙ^{Ξ(R/L)}^{_{—}}^{comp} for the ratio Bₘₙ^{R}/Bₘₙ^{L} of the brightness of the right and left views:

sₘₙ^{Ξ(L/R)}^{_{—}}^{comp}≈(Bₘₙ^{R}/Bₘₙ^{L})·Λ_{Ξ}, (15)

in which, for forming of each (for example, the left) view in the corresponding (left W_{form}^{L}) formation window, the optical conversion of the difference modulation is implemented in the opposite polarity in comparison with consideration of the signal in the form sₘₙ^{Ξ(L/R)}^{_{—}}^{comp}=sₘₙ^{Ξ}^{_{—}}^{comp} of form (3), (4) by means, for example, of mutual permutation of optical converters 4 and 5, and the calibration functions are determined in accordance with the relations:

$$\begin{matrix}{Φ}_{( 1 )}^{Ξ ( R / L )} \approx \frac{{J}_{calib}^{Ξ ( R )} / {J}_{calib}^{Ξ ( L )}}{{s}_{calib}^{Ξ}} , & ( 16 ) \\ {Φ}_{( 2 )}^{Ξ ( R / L )} = \frac{{F}^{- 1} \{ {J}_{calib}^{Ξ ( R )} / {J}_{calib}^{Ξ ( L )} \}}{{s}_{calib}^{Ξ}} . & ( 17 )\end{matrix}$$

The attainment of separation of the views of the formed stereo image in the method is illustrated by examination of the joint operation of two linearized optoelectronic channels (FIG. 3), the outputs of which are two formation windows W_{form}^{L}, W_{form}^{R} (or two observation windows W_{V}^{L}, W_{V}^{R}), where the input of one of the optoelectronic channels, intended for the transmission of sum modulation, corresponds to the input in [symbol] (FIG. 1) of functional module 6, and the input of the second optoelectronic channel, intended for the transmission of ratio modulation, corresponds to the input [symbol] of functional module 7, and the outputs of the optoelectronic channels are the formation windows W_{form}^{L}, W_{form}^{R}. In the optoelectronic channel of sum modulation (linearized by luminous flux intensity due to compensation of the initial nonlinearity of transmission of the sum B_{L}^{mn}+B_{R}^{mn} by the effect of the linearization function of sum modulation Λ^{Ξ}), the sum of the luminous flux intensities Jₘₙ^{L}+Jₘₙ^{R} in both formation windows W_{form}^{L}, W_{form}^{R} is equal to the sum of the brightness of the elementary images of the left and right views:

J_{L}^{mn}+Jᵣ^{mn}=B_{L}^{mn}+B_{R}^{mn} (18)

In the optoelectronic channel of ratio modulation (linearized by luminous flux intensity due to compensation of the initial nonlinearity of transmission of the ratio B_{L}^{mn}/Bᵣ^{mn} by performance of the linearization function of ratio modulation), the ratio of the luminous flux intensities in the left and right formation windows W_{form}^{L}, W_{form}^{R} is:

Jₘₙ^{L}/Jₘₙ^{R}≈Bₘₙ^{L}/Bₘₙ^{R} (19)

Joint solving the system of equations (18) and (19) leads to the relation (20):

Jₘₙ^{L}≈Bₘₙ^{L}; Jₘₙ^{R}≈Bₘₙ^{R}, (20)

from which the attainment of the desired separation of the views of the stereo image between the left W_{form}^{L} and right W_{form}^{R} formation windows is followed (forming of stereo image with the possibility of its observation), since the intensity of the nm^{th} element of the cross section of luminous flux in the left W_{form}^{L} and right W_{form}^{R} observation windows correspond to the values of the brightness Bₘₙ^{L}, Bₘₙ^{R} of the nm^{th} image elements of the left and right views of the stereo image.

From the physical point of view the role of linearized by intensity optoelectronic channel of sum modulation is in realization of identical resulting changes of luminous flux intensity in both formation windows W_{form}^{L}, W_{form}^{R}, that are directly proportional to changes in the total quantity Bₘₙ^{L}+Bₘₙ^{R}; the role of linearized by intensity optoelectronic transmission channel of ratio modulation to distribute the luminous flux (according to intensity value) directly proportional to the ratio (Bₘₙ^{L}/Bₘₙ^{R}) in the left formation window W_{form}^{L} and directly proportional to the ratio (Bₘₙ^{R}/Bₘₙ^{L}) in the right formation window W_{form}^{R}, without introducing any changes in the total value of the luminous flux in both formation windows W_{form}^{L}, W_{form}^{R}. At choice the form of sum signal sₘₙ^{Σ} in accordance with relation (1), any positive increment in the amplitude of sₘₙ^{Σ} on the control input of the linearized optoelectronic channel of sum modulation causes corresponding positive increase in the intensity value in both formation windows W_{form}^{L}, W_{form}^{R} (FIG. 4), i.e. it calls for an intensity value increment in each window, directly proportional to the value of the increment in the sum of the brightness of both views Bₘₙ^{L}+Bₘₙ^{R}. At choice the form of the ratio signal sₘₙ^{Ξ} in accordance with expressions (3), (4) any positive increment in the amplitude of the sₘₙ^{Ξ} on the control input of the linearized optoelectronic channel of ratio modulation causes a positive increase in the luminous flux intensity value in one of the formation windows, for example, in the left formation window W_{form}^{L}, that is directly proportional with the indicated increment in the amplitude sₘₙ^{Ξ}, and causes a corresponding negative increment (decrease) in the luminous flux intensity value in the other, right formation window W_{form}^{R}. For example, with brightness Bₘₙ^{R} close to zero, the light intensity on the output of the optoelectronic channel of sum modulation corresponds only to the brightness Bₘₙ^{L}, and thus the whole luminous flux is routed to the left formation window W_{form}^{L} according with applying to the control input of the optoelectronic channel of ratio modulation the signal (which amplitude is directly proportional to (Bₘₙ^{L}/Bₘₙ^{R}) with maximum amplitude leading to maximum (within the limits of dynamic range of both optoelectronic channels) increment in the light intensity in the left formation window W_{form}^{L} and to extinguishing the luminous flux in the right formation window W_{form}^{R}. On the contrary, with Bₘₙ^{L} close to zero and at maximum Bₘₙ^{R} the whole luminous flux is be routed analogously to the right formation window W_{form}^{R}. Finally, any relation between the values Bₘₙ^{L} and Bₘₙ^{R} leads to redistribution of the same luminous flux energy between the left W_{form}^{L} and the right W_{form}^{R} formation windows. Thus from a physical point of view it is indicated the achievement of the desired separation of the views (formation of stereo image) in implementation of the method.

The maximum separation of the stereo image views (a stereo image with maximum values of contrast and dynamic range) is achieved if the extreme points of dynamic range of sum modulation changes are chosen as minimum and maximum values of its parameter, and if the extreme points of the dynamic range of ratio modulation changes are chosen as two complementary values of its parameter. Then the optical converters 4, 5 both tuned to realization of the identical luminous flux intensity values in both formation windows W_{form}^{L}, W_{form}^{R} for any value of sum modulation parameter, will form at one of the extreme values of the sum modulation parameter a minimum luminous flux intensity value in both formation windows W_{form}^{L}, W_{form}^{R} and a maximum value of intensity at another extreme value of the sum modulation parameter. So at the first of the complementary ratio modulation values, one of the optical converters, for example, optical converter 4 (that is tuned to form the maximum luminous flux intensity value at the first of the complementary values of the ratio modulation parameter) forms the maximum luminous flux intensity value in the left formation window W_{form}^{L}, and another optical converter 5 (tuned to form the minimum luminous flux intensity value with the first of the complementary values of the ratio modulation parameter) forms the minimum (in the limit, close to zero) luminous flux intensity value in the right observation window W_{form}^{R}. The minimum and maximum intensity values of the luminous flux crossly change places in the left W_{form}^{L} and right W_{form}^{R} observation window in the case of using the second complementary value of the ratio modulation parameter.

The method (second embodiment) of forming and observing stereo images with maximum spatial resolution includes the following: with aid of the optical source 14 (FIG. 5, 6), a light wave is generated; with aid of a uniform-effect optical modulator 15, that is matrix-addressed in M rows and N columns, and that implements uniform optical modulation, causing the identical in a value and in a sign optical intensity changes in the left Z_{form}^{L} and right Z_{form}^{R} formation zones, a direct sum modulation is implemented due to direct modulation of the optical intensity value or an indirect sum modulation is implemented due to modulation of remaining light wave physical characteristics such as a direction of propagation or a value of convergence-divergence angle or a spectral characteristic or a polarization state or a phase value or is implemented due to modulation of a combination of the remaining light wave characteristics in the mn^{th} element of uniform-effect optical modulator 15 (m=1, 2, . . . M; n=1, 2, . . . N), whereas applying to its control input in_{dir}^{Σ} a sum compensating signal sₘₙ^{Σ}^{_{—}}^{comp} in its first particular embodiment s₍₁₎ₘₙ^{Σ}^{_{—}}^{comp} (1) which amplitude is directly proportional to the value of the linearization function Λ^{Σ} of sum modulation in its first particular embodiment Λ₍₁₎^{Σ}, that is obtained from the multiplying sum Bₘₙ^{L}+Bₘₙ^{R} of the values of the brightness of the mn^{th} image elements of the left and right views, or a sum compensating signal is applied in its second particular embodiment s₍₂₎ₘₙ^{Σ}^{_{—}}^{comp} (2) which amplitude is directly proportional to the product of the sum Bₘₙ^{L}+Bₘₙ^{R} by the linearization function Λ^{Σ} of sum modulation in its second particular embodiment Λ₍₂₎^{Σ} (6); with aid of difference-effect optical modulator 16, that is matrix addressed in M rows and N columns, and which implements difference optical modulation, causing the identical in a value but different in sign optical intensity changes in the left Z_{form}^{L} and right Z_{form}^{R} formation zones, a direct ratio modulation is implemented due to modulation of optical intensity or an indirect ratio modulation is implemented due to modulation of remaining light wave physical characteristics—a direction of propagation or a value of convergence-divergence angle or a spectral characteristic or a polarization state or a phase value or is implemented due to modulation of a combination of the remaining light wave characteristics in the mn^{th} element of ratio difference-effect optical modulator 16, whereas the complementary values of ratio modulation characteristic in the adjacent 2i and (2i−1) columns of the difference-effect optical modulator 16 are assigned, wherein i=1, 2, . . . , N, whereas to its control input in_{dir}^{Ξ} a ratio compensating signal sₘₙ^{Ξ}^{_{—}}^{comp} is applied in its first particular embodiment s₍₁₎ₘₙ^{Ξ}^{_{—}}^{comp} (3) which amplitude is directly proportional to the values of the linearization function Λ^{Ξ} of ratio modulation in its first particular embodiment Λ₍₁₎^{Σ} (5), taken from the ratio of the values Bₘₙ^{L}/Bₘₙ^{R}, or applying a ratio compensating signal in its second particular embodiment s₍₂₎ₘₙ^{Ξ}^{_{—}}^{comp(L/R)} (4) which amplitude is directly proportional to the product of the ratio Bₘₙ^{L}/Bₘₙ^{R} by the linearization function of ratio modulation Λ^{Ξ} in its second particular embodiment Λ₍₂₎^{Ξ} (8); the first and second groups of modulated intensity light beams are formed in the left Z_{form}^{L} and right Z_{form}^{R} formation zones, respectively; with aid of an N-column addressed spatially-periodic optical converter 17 with complementary conversion parameters of ratio modulation for its adjacent 2k and (2k−1) columns, where k=1, 2, . . . , N, with identical parameters of indirect sum modulation conversion, with identical optical transmission parameters for both of direct ratio component and direct sum component of the luminous flux intensity for all its N columns, wherein one group N of light beams is routed in the Z_{form}^{L} formation zone, the first N/2 of which pass through N/2 even 2i columns of difference-effect optical modulator 16 and through N/2 even 2k columns of the spatially-periodic optical converter 17, and the remaining N/2 light beams pass through N/2 odd (2i−1) columns of the difference-effect optical modulator 16 and through N/2 odd (2k−1) columns of the spatially-periodic optical converter 17, and another group N of light beams is routed in the right formation zone Z_{form}^{R}, the first N/2 of which pass through N/2 odd (2i−1) columns of difference-effect optical modulator 16 and through N/2 even 2k columns of spatially-periodic optical converter 17, and the remaining N/2 light beams pass through N/2 even 2i columns of difference-effect optical modulator 16 and through N/2 odd (2k−1) columns of spatially-periodic optical converter 17, and the left and right views of the stereo image are observed, respectively, in the left Z_{V}^{L} and right Z_{V}^{R} observation zones, which ones are optically connected, respectively, with the left Z_{form}^{L} and right Z_{form}^{R} formation zones, wherein the linearization function of sum modulation Λ^{Σ} in its first embodiment Λ₍₁₎^{Σ} is defined as the function F⁻¹{Φ₍₁₎^{Σ}} (5), that is the inverse of the calibration function I of sum modulation nonlinearity in its first particular embodiment Φ₍₁₎^{Σ} (9), the linearization function of sum modulation in its second particular embodiment Λ₍₂₎^{Σ} is defined as the function F^{reciprocal}{Φ₍₂₎^{Σ} (}6), which values are the reciprocal 1/Φ₍₂₎^{Σ} to the values of the function Φ^{Σ} of sum modulation nonlinearity in the second particular embodiment Φ₍₁₎^{Σ} (9), the linearization function Λ^{Ξ} of ratio modulation in its first particular embodiment Λ₍₁₎^{Ξ} is defined as the function F⁻¹{Φ₍₁₎^{Ξ}} (7), that is the inverse of the calibration function Φ^{Ξ} of ratio modulation nonlinearity in its first particular embodiment Φ₍₁₎^{Ξ} (11), and the linearization function Λ^{Ξ} of ratio modulation in its second particular embodiment Λ₍₂₎^{Ξ} is defined as the function F^{reciprocal}{Φ₍₂₎^{Ξ}} (8), that has the reciprocal values 1/Φ₍₂₎^{Ξ} to the calibration function Φ^{Ξ} of ratio modulation nonlinearity in its second particular embodiment Φ₍₂₎^{Ξ} (12), where the calibration function of sum modulation nonlinearity Φ^{Ξ} in its first particular embodiment Φ₍₁₎^{Σ} is equal to the assemblage (9) of the calibration values of the uniformly modulated component J_{calib}^{Σ} of the luminous flux intensity on the output of either of the formation windows W_{form}^{L}, W_{form}^{R} whereas to the control input in_{dir}^{Σ} of the uniform-effect optical modulator 16 the linearly-varying calibration signal s_{calib}_{_{—}}ₗᵢₙ of sum modulation is applied, and the calibration function Φ^{Σ} of sum modulation nonlinearity in its second particular embodiment Φ₍₂₎^{Σ} is equal to the ratio (10) of the sequence of calibration values of the uniformly modulated component J_{calib}^{Σ} of the luminous flux intensity on the output of either of the formation windows W_{form}^{L}, W_{form}^{R} to the sequence of corresponding amplitude values of the monotonically-varying calibration signal s_{calib}^{Σ}; the calibration function Φ^{Σ} of ratio modulation nonlinearity in its first particular embodiment Φ₍₁₎^{Ξ(L/R)} is equal to a ratio (11) of the assemblage of the calibration values of the difference-modulated component J_{calib}^{Ξ(L)} of the luminous flux intensity in the left formation window W_{form}^{L} to the assemblage of the calibration values of the difference-modulated component J_{calib}^{Ξ(R)} of the luminous flux intensity in the right formation window W_{form}^{R}, whereas to the control input in_{dir}^{Ξ} of the difference-effect optical modulator 4 the linearly-varying calibration signal s_{calib}^{Ξ} of ratio modulation is applied; and the calibration function Φ^{Ξ} of ratio modulation nonlinearity in its second particular embodiment Φ₍₂₎^{Ξ(L/R)} is equal to the ratio (12) of the assemblage of the calibration values of the difference-modulated component J_{calib}^{Ξ(L)} of the luminous flux intensity in the left formation window W_{form}^{L} to the assemblage of the calibration values of the difference-modulated component J_{calib}^{Ξ(R)} of the luminous flux intensity in the right formation window W_{form}^{R}, divided by the assemblage of corresponding values of the amplitude of the monotonically-varying calibration signal s_{calib}^{Ξ} of ratio modulation.

The ratio compensating signal sₘₙ^{Ξ}^{_{—}}^{comp} (1) is obtained on the output of functional module 18 which transfer function is equal to the linearization function Λ_{Σ} of sum modulation whereas to its input [symbol] the initial sum signal Sₘₙ^{Σ} is applied, which amplitude is directly proportional to the sum Bₘₙ^{L}+Bₘₙ^{R} of the values of the brightness of the mn^{th} image elements of the left and right views.

The ratio compensating signal sₘₙ^{Ξ}^{_{—}}^{comp} (2) is obtained on the output of functional module 19 which transfer function is equal to the linearization function Λ^{Ξ} of ratio modulation whereas to its input [symbol] the initial ratio signal Sₘₙ^{Ξ} is applied, which amplitude is directly proportional to the ratio Bₘₙ^{L}Bₘₙ^{R}.

The calibration values of the luminous flux intensity are measured by photo detectors 20, 21 (FIG. 7), disposed in the formation zones Z_{form}^{L}, Z_{form}^{R}, whereas the calibration signal s_{calib}^{Σ} of sum modulation and the calibration signal s_{calib}^{Ξ} of ratio modulation are supplied respectively to the control input in_{dir}^{Σ} of the uniform-effect optical modulator 15 and to the control input in_{dir}^{Ξ} of the difference-effect optical modulator 17.

The output signals of photo detectors 20, 21 enter the processing modules 22, 23, in which, in accordance with relations (9)-(12), the calibration function Φ_{Ξ} of ratio modulation nonlinearity and the calibration function Φ_{Σ} of sum modulation nonlinearity are calculated, on the basis of which the inverse function Φ_{Ξ}⁻¹ of ratio modulation nonlinearity and the reciprocal function Φ_{Σ}^{reciprocal} to the function Φ_{calib}^{Σ} are calculated in processing modules 24, 25 in accordance with relations (5)-(8), thus the linearization functions Λ^{Σ} and Λ^{Ξ} of sum and ratio modulation are determined, according to which the corresponding transfer functions are assigned to functional modules 18 and 19 in the process of observing the stereo image.

The left E^{L} and right E^{L} eyes of the observer are arranged, respectively, in the left Z_{V}¹ and right Z_{V}^{R} observation zones, which are formed in space by mutual intersection of the optical beams which are separated with aid of spatially-periodic optical converter 17, which makes it possible to observe the stereo image without utilization of special means (stereo glasses). There is a continuum of positions of such two-dimensional observation zones Z_{V}^{L}, Z_{V}^{R} corresponding to the different positions of the observer's eyes along the axis Z (within the limits of the depth of the space, defined by the extent of the three-dimensional formation zones Z_{form}^{L}, Z_{form}^{R}). The average distance Z₀ from the observer's eyes E^{L}, E^{L} (from the observation zones Z_{V}^{L}, Z_{V}^{R}) to optical conversion plane C is determined by the relation (FIG. 6):

Z₀/B=z₀/b, (21)

where B is the distance between the centers of the observer's eyes (between the centers of the observation zones), z₀ is the distance between the plane Ξ of the difference-effect optical modulator 17 position to plane C of spatially-periodic optical converter 19 position, b is the period of the position of mn^{th} image elements (FIG. 6).

The particular embodiments of the method, corresponding to different particular embodiments for the uniform-effect optical modulators 2, 15, the difference-effect optical modulators 3, 16 and the optical converters 4, 5, 17, have corresponding different particular embodiments of the nonlinearity functions Φ^{Σ}, Φ^{Ξ} of sum modulation and ratio modulation, the form and dimensionality (number of variables or arguments, on which the nonlinearity function Φ depends) of which are determined by the physical interactions mechanism of sum modulation and ratio modulation components. In accordance with the invention, the knowledge of the indicated physical mechanisms/the analytical expressions (which associate changes in the sum modulation and ratio modulation optical parameters with the value the control signal amplitude) is not required, and the knowledge of the analytical expressions between the indicated optical parameters is not required too. The results of measuring intensity values dependencies in the formation windows W_{form}^{L}, W_{form}^{R} (formation zones Z_{form}^{L}, Z_{form}^{R}) of amplitudes of sum and ratio calibration signals s_{calib}^{Σ}, s_{calib}^{Ξ} are necessary and sufficient information for the subsequent linearization of transfer functions of optoelectronic channels.

The direct sum or direct ratio optical modulation corresponds to a direct change in the optical intensity with aid of the uniform-effect optical modulators 2, 15 or with aid of the difference-effect optical modulators 3, 16 in the corresponding planes Σ and Ξ of their position (for example, due to a change of the real-amplitude absorption coefficient in the working medium of the mn^{th} element of each of them). This corresponds to a direct (without conversion effect by the optical converters 4, 5, 17) realization of the corresponding intensity variations in both formation windows W_{form}^{L}, W_{form}^{R} (both formation zones Z_{form}^{L}, Z_{form}^{R}). The role of optical converters 4, 5, 17 in this case is in the transmission without change of the direct-modulated sum and ratio components of the luminous flux intensity. The real amplitude A of a light wave is described by the real-amplitude factor in the record Aexp(−iθ) of the complex amplitude of the light wave, where θ is the phase of the light wave. Upon modulation of the value of the real-amplitude A of a light wave, the corresponding modulation of its intensity J is equal to |A|².

The indirect sum or ratio modulation of light wave corresponds to modulation of the remaining (i.e., with the exception of variations of the direct real-amplitude) light wave physical characteristics, and the role of the optical converters 4, 5, 17 in this case is in conversion of the light wave physical characteristics in the corresponding luminous flux intensity variations in the formation windows W_{form}^{L}, W_{form}^{R} (zones Z_{form}^{L}, Z_{form}^{R}), wherein the conversion parameters are identical (uniform) for sum modulation in both formation windows W_{form}^{L}, W_{form}^{R} (zones Z_{form}^{L}, Z_{form}^{R}), and the conversion parameters for ratio modulation are complementary (mutually supplementary or opposite) between the two formation windows W_{form}^{L}, W_{form}^{R} (zones Z_{form}^{L}, Z_{form}^{R}).

The first (preferred) particular embodiment of the first embodiment of the method (FIG. 8) includes the following: with aid of the real-amplitude optical modulator 26, that is matrix-addressed in M rows and N columns, a direct sum modulation Σ{A} is implemented due to real modulation of amplitude A (direct modulation of intensity J) of the light wave in the mn^{th} element of the real-amplitude optical modulator 26; with aid of phase-polarization optical modulator 27, that is matrix-addressed in M rows and N columns, an indirect ratio modulation C{P} is implemented due to modulation of the polarization state P of the light wave in the mn^{th} element of the phase-polarization optical modulator 27; with aid of first and second polarization converters 28, 29 with complementary polarization parameters, an indirect conversion (polarization) of ratio modulation C{P} is implemented in the ratio component of the luminous flux intensity, forming the luminous fluxes of mn^{th} image elements of the left Bₘₙ^{L} and right Bₘₙ^{R} views in the left W_{form}^{L} and right W_{form}^{R} formation windows, respectively, wherein the control input of the real-amplitude optical modulator 26 is applied by the sum compensating electronic signal uₘₙ^{c}^{_{—}}^{Σ} in its first particular embodiment u₍₁₎ₘₙ^{Σ}^{_{—}}^{comp} which amplitude is directly proportional to the linearization function Λ^{Σ} of sum modulation in its first particular embodiment Λ₍₁₎^{Ξ}, that is taken from the sum Bₘₙ^{L}+Bₘₙ^{R}:

u₍₁₎ₘₙ^{Σ}^{_{—}}^{comp}≈Λ₍₁₎^{Σ}{Bₘₙ^{L}+Bₘₙ^{R}}, (22)

or the sum compensating electronic signal in its second particular embodiment u₍₂₎ₘₙ^{Σ}^{_{—}}^{comp} which amplitude is directly proportional to the product of the sum Bₘₙ^{L}+Bₘₙ^{R} by the linearization function of sum modulation Λ^{Σ} in its second particular embodiment Λ₍₂₎^{Σ}:

u₍₂₎ₘₙ^{Σ}^{_{—}}^{comp}≈(Bₘₙ^{L}+Bₘₙ^{R})·Λ₍₂₎^{Σ}, (23)

the control input of phase-polarization optical modulator 27 is applied with the ratio compensating electronic signal u_{mn(L/R)}^{Ξ}^{_{—}}^{comp} in its first particular embodiment s_{(1)mn(L/R)}^{Ξ}^{_{—}}^{comp} which amplitude is directly proportional to the values of the linearization function of ratio modulation Λ^{Ξ} in its first particular embodiment Λ₍₁₎^{Ξ}, taken from the ratio Bₘₙ^{L}/Bₘₙ^{R}:

u₍₁₎ₘₙ^{Ξ}^{_{—}}^{comp}≈Λ₍₁₎^{Ξ}{Bₘₙ^{L}/Bₘₙ^{R}}, (24)

and the amplitude of the ratio compensated electronic signal in its second particular embodiment u₍₂₎ₘₙ^{Σ}^{_{—}}^{comp} is proportional to the product of the ratio Bₘₙ^{L}/Bₘₙ^{R} by the linearization function of ratio modulation Λ^{Ξ} in its second particular embodiment Λ₍₂₎^{Ξ}:

u₍₂₎ₘₙ^{Ξ}^{_{—}}^{comp}≈(Bₘₙ^{L}/Bₘₙ^{R})·Λ₍₂₎^{Ξ}, (25)

wherein the linearization function Λ^{Σ} of sum modulation in its first particular embodiment Λ₍₁₎^{Σ} is defined as the function F⁻¹{Φ₍₁₎^{Σ}(u)}, that is the inverse function of the calibration function Φ^{Σ} of sum modulation nonlinearity in its first particular embodiment Φ₍₁₎^{Σ}:

Λ₍₁₎^{Σ}(u)=F⁻¹{Φ₍₁₎^{Σ}(u)}, (26)

the linearization function Λ^{Σ} of sum modulation in its second particular embodiment Λ₍₂₎^{Σ} is defined as the function F^{reciprocal}{Φ₍₂₎^{Σ}(u)}, which is the reciprocal function 1/Φ₍₂₎^{Σ}(u) to values of the calibration function Φ^{Σ} of sum modulation nonlinearity in its second particular embodiment Φ₍₁₎^{Σ}:

Λ₍₂₎^{Σ(}u)=F^{reciprocal}{Φ₍₂₎^{Σ}(u)}=1/Φ₍₂₎^{Σ}(u), (27)

the linearization function of ratio modulation Λ^{Ξ} in its first particular embodiment Λ₍₁₎^{Ξ} is defined as the function F⁻¹{Φ₍₁₎^{Ξ}(u)}, that is the inverse of the calibration function Φ^{Ξ} of ratio modulation nonlinearity in its first particular embodiment Φ₍₁₎^{Ξ}:

Λ₍₁₎^{Ξ}(u)=F⁻¹{Φ₍₁₎^{Ξ}(u)}, (28)

and the linearization function of ratio modulation Λ^{Ξ} in its second particular embodiment Λ₍₁₎^{Ξ} is defined as the function F^{reciprocal}{Φ₍₂₎^{Ξ}(u)}, which is the reciprocal function 1/Φ₍₂₎^{Ξ} to the calibration function of ratio modulation nonlinearity in the second particular embodiment Φ₍₂₎^{Ξ}:

Λ₍₂₎^{Ξ}(u)=F^{reciprocal}{Φ₍₂₎^{Ξ}(u)}, (29)

where the calibration function of sum modulation nonlinearity in its first particular embodiment Φ₍₁₎^{Σ} is equal to the assemblage of the calibration values of the uniformly modulated component J_{calib}^{Σ}(u) of the luminous flux intensity in the output of either of the formation windows W_{form}^{L}, W_{form}^{R} (FIG. 2):

Φ₍₁₎^{Σ}(u)=J_{calib}^{Σ}(u), (30)

whereas to the control input of in_{dir}^{Σ} of the uniform-effect optical modulator 26 the linearly-varying electronic calibration signal u_{calib}_{_{—}}ₗᵢₙ^{Σ} of sum modulation is applied, and the calibration function Φ^{Σ} of sum modulation nonlinearity in its second particular embodiment Φ₍₂₎^{Σ} is equal to the ratio of the sequence of calibration values of the uniform modulated component J_{calib}^{Σ} of the luminous flux intensity in the output of either of the formation windows W_{form}^{L}, W_{form}^{R} to the sequence of the corresponding amplitude values of the linearly-varying electronic calibration signal u_{calib}_{_{—}}ₗᵢₙ of sum modulation:

Φ₍₂₎^{Σ}(u)≈J_{calib}^{Σ}(u)/U_{calib}_{_{—}}ₗᵢₙ^{Σ}, (31)

the calibration function of ratio modulation nonlinearity Φ^{Ξ} in its first particular embodiment Φ₍₁₎^{Ξ(L/R)}(u) is equal to the ratio of the assemblage of the calibration values of the difference-modulated component J_{calib}^{Ξ(L)}(u) of the luminous flux intensity in the left formation window W_{form}^{L} to the assemblage of the calibration values of the difference-modulated component J_{calib}^{Ξ(R)}(u) of the luminous flux intensity in the right formation window W_{form}^{R}:

Φ₍₁₎^{Ξ(L/R)}≈J_{calib}^{Ξ(L)}/J_{calib}^{Ξ(R)}, (32)

whereas to the control input in_{dir}^{Ξ} of the difference-effect optical modulator 27 the linearly-varying ratio modulation electronic calibration signal u_{calib}_{_{—}}ₗᵢₙ is applied, and the calibration function of ratio modulation nonlinearity Φ^{Ξ} in its second particular embodiment Φ₍₂₎^{Ξ(L/R)}(u) is equal to the ratio of the assemblage of the calibration values of difference modulated component J_{calib}^{Ξ(L)}(u) of the luminous flux intensity in the left formation window W_{form}^{L} to the assemblage of the calibration values of the difference-modulated component J_{calib}^{Ξ(R)}(u) of the luminous flux intensity in the right formation window W_{form}^{R}, divided by the assemblage of the corresponding values of the amplitude of the linearly-varying electronic calibration signal u_{calib}_{_{—}}ₗᵢₙ of ratio modulation:

$${Φ}_{( 2 )}^{Ξ ( L / R )} ( u ) = \frac{{F}^{- 1} \{ {J}_{calib}^{Ξ ( L )} ( u ) / {J}_{calib}^{Ξ ( R )} ( u ) \}}{{u}_{calib\_li n}^{Ξ}} . \qquad ( 33 )$$

wherein the limits of amplitude change in the sum modulation electronic calibration signal u_{calib}_{_{—}}ₗᵢₙ^{Σ} correspond to change in luminous flux intensity J_{calib}^{Σ}(u) from minimum to maximum calibration values, and the limits of amplitude change in the ratio modulation electronic calibration signal u_{calib}_{_{—}}ₗᵢₙ^{Ξ} correspond to change in the calibration values of the ratio component J_{calib}^{Ξ}(u) of the luminous flux intensity from minimum to maximum values at constant (preferably, maximum) luminous flux intensity value in the input of phase-polarization optical modulator 27.

The sum compensating signal sₘₙ^{Σ}^{_{—}}^{comp} is received on the output of functional module 30 with transfer function in the form of the linearization function Λ^{Σ}(u) of sum modulation, whereas the initial sum signal uₘₙ^{Σ} is applied to the input of functional module 30 with amplitude that is directly proportional to the sum Bₘₙ^{L}+Bₘₙ^{R} of the values of the brightness of the mn^{th} image elements of the left and right views: uₘₙ^{Σ}≈Bₘₙ^{L}+Bₘₙ^{R}.

The ratio compensating signal s_{mn(L/R)}^{Ξ}^{_{—}}^{comp} is received on the output of functional module 31 with transfer function in the form of the linearization function Λ^{Ξ}(u) of ratio modulation, whereas the initial ratio modulation signal uₘₙ^{Ξ} is applied to the input of functional module 31 with amplitude that is directly proportional to ratio Bₘₙ^{L}/Bₘₙ^{R} of brightness of the mn^{th} image element of the left view to the value of the brightness of the mn^{th} image element of the right view: uₘₙ^{Ξ}≈Bₘₙ^{L}/Bₘₙ^{R}.

The output signals of photo detectors 32, 33 enter the processing modules 34, 34, in which, in accordance with relations (30-33), the calibration function Φ_{Ξ}(u) of ratio modulation nonlinearity and the calibration function Φ_{Σ}(u) of sum modulation nonlinearity are calculated, according to which the inverse function Φ_{Ξ}⁻¹ of ratio modulation nonlinearity and the reciprocal function Φ_{Σ}^{reciprocal} of the function Φ_{calib}^{Σ} are calculated in processing modules 36, 37 in accordance with relations (26)-(29), thus the linearization functions Λ^{Ξ}, Λ^{Σ} of ratio and sum modulation are determined, according to which the corresponding transfer functions of the functional modules 31 and 30 are assigned in the process of observing the stereo image.

The procedure of linearization of real-amplitude sum modulation (Σ{A}-modulation) and the procedure of linearization of polarization ratio modulation (Ξ{P}-modulation) for the first particular embodiment of the first embodiment of the method are implemented separately.

For linearization of Σ{A}-modulation, there is applied to the control input in_{dir}^{Σ} of the real-amplitude optical modulator 26 (hereafter, Σ{A}-modulator) a calibration electronic signal u_{calib}_{_{—}}ₗᵢₙ^{Σ} of Σ{A}-modulation with amplitude that is linearly increasing in time t (FIG. 10), wherein the amplitude of the electronic calibration signal u_{calib}_{_{—}}ₗᵢₙ is equal to 0 (corresponds to absence of Ξ{P}-modulation) on the control input 14 of the phase-polarization modulator 27 (hereafter, Ξ{P}-modulator). The first and second particular embodiments of the linearization procedure of Σ{A}-modulation correspond to the first and second particular embodiments Λ₍₁₎^{Σ} and Λ₍₂₎^{Σ} of linearization function Λ^{Σ} of the Σ{A}-modulation.

When using the linearization function Λ^{Σ} of Σ{A}-modulation in its first particular embodiment Λ₍₁₎^{Σ}, the luminous flux intensity values J_{calib}^{Σ(L)} and J_{calib}^{Σ(L)}, respectively, in the left W_{form}^{L} and right W_{form}^{R} formation windows are represented by the calibration values of the uniform-modulated component (Σ{A}-component) of the luminous flux intensity J_{calib}^{Σ} (FIG. 11), which, in general case, represents the nonlinear function of voltage values of the linearly-varying amplitude calibration signal u_{calib}_{_{—}}ₗᵢₙ^{Σ} of Σ{A}-modulation, applied to the control input in_{dir}^{Σ} of the Σ{A}-modulator (marked out on the drawing as the signal argument u=u_{calib}_{_{—}}ₗᵢₙ^{Σ}, belonging to the input in_{dir}^{Σ}, i.e., u=u_{calib}_{_{—}}ₗᵢₙ^{Σ⊂in}_{dir}^{Σ}), and therefore is illustrated by a curve with deviations from sloped straight line 38 (being a graph of a direct proportional dependence); moreover, the form of the curved function J_{calib}^{Σ} is the same for both formation windows W_{form}^{L}, W_{form}^{R} (graph I₁₁). The linearization of Σ{A}-modulation with help of the first particular embodiment Λ₍₁₎^{Σ} of the linearization function is implemented through calculating (taking) the inverse function of the nonlinearity function Φ₍₁₎^{Σ}(u) of Σ{A}-modulation, that is equal in accordance with relations (30, 28) to the sum of the values of the Σ{A}-modulated component of luminous flux intensity J_{calib}^{Σ}. The graphic way of obtaining an inverse function is in obtaining the inverse function graph by mutual permutation of the argument and initial values of the function (relative to which the inverse function is taken), i.e., the values of the argument u_{calib}_{_{—}}ₗᵢₙ^{Σ} are plotted along the y-axis, and the values of J_{calib}^{Σ} along the x-axis to obtain the graph of the inverse function (graph II₁₁), which in this form is transferred to the initial coordinates (graph III₁₁) to obtain the resulting graph of the inverse function Λ_{(1)P}^{Σ}=F⁻¹{Φ_{(1)P}^{Σ}(u)=J_{calib}^{Σ}(u)}. To obtain the compensated (with corrected nonlinearity) Σ{A}-component J_{calib}^{Σ}^{_{—}}^{comp} (u) of the luminous flux intensity (graph IV₁₁), it is applied to the control input in_{dir}^{Σ} of the electronic module of the Σ{A}-modulator the compensating electronic signal u_{calib}_{_{—}}ₗᵢₙ^{Σ}^{_{—}}^{comp} of the form:

u_{calib}_{_{—}}ₗᵢₙ^{Σ}^{_{—}}^{comp}=Λ₍₁₎^{Σ}{u_{calib}_{_{—}}ₗᵢₙ^{Σ}^{_{—}}^{comp}} (34)

as a result of taking the inverse function of the initial calibration signal u_{calib}_{_{—}}ₗᵢₙ^{Σ}^{_{—}}^{comp}. As a result, the compensating electronic signal (26) obtains nonlinear properties, inverse with respect to the nonlinear properties of Σ{A}-modulation. The result of the performance of the Σ{A}-modulator under control of compensating signal (26) is the forming the compensated Σ{A}-component J_{calib}^{Σ}^{_{—}}^{comp} (u) of the luminous flux intensity without nonlinearity of Σ{A}-modulation that is presented in the initial Σ{A}-component J_{calib}^{Σ} of the luminous flux intensity, i.e., graph IV₁₁ illustrates a direct proportional dependence of the Σ{A}-component J_{calib}^{Σ}^{_{—}}^{comp} (u) of the intensity on the amplitude of the initial signal u_{calib}_{_{—}}ₗᵢₙ^{Σ}, being applied to the input [symbol] of the electronic module with the transfer function Λ₍₁₎^{Σ} (and marked out on the drawing as the signal argument u_{calib}_{_{—}}ₗᵢₙ^{Σ}, belonging to the input [symbol] ,i.e., u=u_{calib}_{_{—}}ₗᵢₙ^{Σ⊂in} [symbol] ^{), Analytically the directly proportional dependence is described as:}

J_{calib}^{Σ}^{_{—}}^{comp}=Λ₍₁₎^{Σ}{J_{calib}^{Σ}(u)}=J_{calib}^{-1(Σ)}{J_{calib}^{Σ(}u)}=u (35)

where J_{calib}^{-1(Σ)} is the inverse function of the function J_{calib}^{Σ}, and taking the inverse function of the original function corresponds to receiving the argument of the original function, i.e., the variable itself, which describes the signal voltage change producing changes J_{calib}^{Σ}, (changes in the signal u_{calib}_{_{—}}ₗᵢₙ^{Σ} with the linearly-varying amplitude), i.e., along the y-axis (vertical) axis of graph IV₁₁ the u values are actually plotted. At the same time, u is the argument of the signal u_{calib}_{_{—}}ₗᵢₙ^{Σ}, and so is plotted along the axis of the arguments (horizontal) of graph IV₁₁, and, since the dependence of u on u is linear, from here it is followed the linearity of the graphic dependence described in (27).

Whereas the information signal uₘₙ^{Σ}≈Bₘₙ^{L}+Bₘₙ^{R} is applied to the input in [symbol] of the electronic module (corresponding designation uₘₙ^{Σ}≈Bₘₙ^{L}+Bₘₙ^{R}⊂in [symbol] on the drawing, graph V₁₁), that has the transfer function Λ₍₁₎^{Σ}, the resulting total intensity Jₘₙ^{L}^{_{—}}^{comp}+Jₘₙ^{R}^{_{—}}^{comp} of the luminous flux in the two formation windows:

$$\begin{matrix}{J}_{mn}^{L\_comp} + {J}_{mn}^{R\_comp} = {Λ}_{( 1 )}^{Σ} \{ {Φ}_{( 1 )}^{Σ} ( {B}_{mn}^{L} + {B}_{mn}^{R} ) \} = \\ = {Φ}_{( 1 )}^{- 1 ( Σ )} \{ {Φ}_{( 1 )}^{Σ} ( {B}_{mn}^{L} + {B}_{mn}^{R} ) \} \\ = {B}_{mn}^{L} + {B}_{mn}^{R}\end{matrix} \qquad ( 36 )$$

is directly proportional to Bₘₙ^{L}+Bₘₙ^{R} (it corresponds to graph V₁₁ in the form of a straight line) in accordance with the same linearization algorithm examined in the example of the signal u_{calib}_{_{—}}ₗᵢₙ^{Σ} with linearly-varying amplitude (graph IV₁₁), which means implementation of the desired linearization of Σ{A}-modulation in relation to the signal having arbitrary form of the sum of the values Bₘₙ^{L}+Bₘₙ^{R}, since the value of Bₘₙ^{L}+Bₘₙ^{R} is actually plotted along the axis of the arguments and along the y-axis of graph V₁₁ as a result of compensation of the nonlinearity of Σ{A}-modulation with passage of the signal of arbitrary form through the electronic module with the transfer function Λ₍₁₎^{Σ}. And the influence of the linearization function Λ₍₁₎^{Σ} on the nonlinearity of Σ{A}-modulation is invariant relative to the form of the supplied signal: all deviations of the latter (i.e., deviations of the amplitude of Bₘₙ^{L}+Bₘₙ^{R}) from linear dependence in the case of the signal u_{calib}_{_{—}}ₗᵢₙ^{Σ} are identical both for the y-axis and x-axis, from which the described linearity (36) of graphic dependence of the form:

J_{calib}^{Σ}^{_{—comp}}=Λ₍₁₎^{Σ}{J_{calib}^{Σ}(u)}=J_{calib}^{-1(Σ)}{J_{calib}^{Σ}(u)}=u. (37)

is followed. When using the linearization function in its second particular embodiment Λ₍₂₎^{Σ}, the luminous flux intensity values J_{calib}^{Σ(L)} and J_{calib}^{Σ(R)} respectively in the left W_{form}^{L} and right W_{form}^{R} formation windows are represented as before by the curve J_{calib}^{Σ} (FIG. 12) with essential deviations from inclined straight line 38, that is a graph of direct proportional dependence (graph I₁₂), whereas the linearly-varying calibration signal of u_{calib}_{_{—}}ₗᵢₙ^{Σ} of Σ{A}-modulation is applied to the control input in_{dir}^{Σ} of Σ{A}-modulator. The nonlinearity function of Σ{A}-modulation in its second particular embodiment Φ₍₂₎^{Σ}(u) is equal to the ratio of J_{calib}^{Σ}(u) to the value of its argument, and this function (graph II₁₂) is characterized by deviations from a straight line 1{u_{calib}^{Σ}}, that is the graphic presentation of the unit coefficient of linear transmission of values of the calibration signal u_{calib}^{Σ} of Σ{A}-modulation. The linearization function Λ₍₂₎^{Σ}^{_{—}}^{A}(u) is represented by the curve (graph III₁₂), that is mirror symmetrical to the curve of the function Λ₍₂₎^{Σ}(u) in relation to the curve 1{u_{calib}^{Σ}} as a result of determining the values of the function Λ₍₂₎^{Σ}^{_{—}}^{A}(u)) as the inverse of the values of the function Λ₍₂₎^{Σ}(u).

To obtain the compensated (with corrected nonlinearity) Σ{A}-component J_{calib}^{Σ}^{_{—}}^{comp} (u) of the luminous flux intensity (graph IV₁₂), it is applied to the control input in_{dir}^{Σ} of the electronic module of the Σ{A}-modulator the compensating electronic signal u_{calib}_{_{—}}ₗᵢₙ^{Σ}^{_{—}}^{comp} of the form:

u_{calib}_{_{—}}ₗᵢₙ^{Σ}^{_{—}}^{comp}=Λ₍₂₎^{Σ}{u_{calib}_{_{—}}ₗᵢₙ^{Σ}^{_{—}}^{comp}} (38)

as a result of multiplication of the functions, one of which describes the calibration values J_{calib}^{Σ} of the luminous flux intensity in either of the formation windows, and another function is the linearization function in its second embodiment Λ₍₂₎^{Σ}, that is equal to the values of the nonlinearity function of Σ{A}-modulation, which, in turn, in accordance with the general formula (6) is equal to the inverse function of the intensity J_{calib}^{Σ}, multiplied by voltage values of the calibration signal u_{calib}_{_{—}}ₗᵢₙ^{Σ}:

$$\begin{matrix}{J}_{calib}^{Σ \_comp} = {J}_{calib}^{Σ} \cdot {Λ}_{( 2 )}^{Σ \_A} \\ = {J}_{calib}^{Σ} \cdot ( 1 / {Φ}_{( 2 )}^{Σ \_A} ) \\ = {J}_{calib}^{Σ} \cdot \frac{u}{{J}_{calib}^{Σ}} = u\end{matrix} \qquad ( 39 )$$

From here it is followed the direct proportional dependence of the intensity values J_{calib}^{Σ}^{_{—}}^{comp} (u), since simultaneously it is the argument of the signal u_{calib}_{_{—}}ₗᵢₙ^{Σ} and is plotted along the axis of arguments (horizontal) of graph IV₁₂ (the form of that is analogous to the form of graph IV₁₁).

Whereas the information signal uₘₙ^{Σ}≈Bₘₙ^{L}+Bₘₙ^{R} is applied to the input [symbol] of the electronic module, having transfer function Λ₍₂₎^{Σ}, the resulting total intensity Jₘₙ^{L}^{_{—}}^{comp}+Jₘₙ^{R}^{_{—}}^{comp} of the luminous flux in the two formation windows W_{form}^{L}, W_{form}^{R}:

$$\begin{matrix}{J}_{mn}^{L\_comp} + {J}_{mn}^{R\_comp} = {Λ}_{( 2 )}^{Σ - a} \cdot {Φ}_{( 1 )}^{Σ \_A} \{ ( {B}_{mn}^{L} + {B}_{mn}^{R} ) \} = \\ = \frac{u}{{J}_{calib}^{Σ}} \cdot {J}_{mn}^{Σ} \{ {B}_{mn}^{L} + {B}_{mn}^{R} \} \\ = {B}_{mn}^{L} + {B}_{mn}^{R}\end{matrix} \qquad ( 40 )$$

is directly proportional to Bₘₙ^{L}+Bₘₙ^{R} (it corresponds to graph V₁₂ in the form of a straight line), since, upon dividing the function by the nonlinearity function, it is compensated, and the result of the ratio is a correction factor to the voltage value, which corresponds to changes in the value of Bₘₙ^{L}+Bₘₙ^{R}.

For linearization of Ξ{P}-modulation, the ratio calibration electronic signal uₗᵢₙ^{Ξ} with linearly increasing amplitude (FIG. 13) is applied to the control input in_{dir}^{Ξ} of the Ξ{P}-modulator, wherein the voltage value to the control input in_{dir}^{Σ} of the Σ{P}-modulator is a constant, which preferably corresponds to the maximum constant luminous flux intensity value on the input of the Ξ{A}-modulator (for obtaining maximum dynamic range and precision for calibration intensity values). The first and second particular embodiments of the linearization procedure for Ξ{P}-modulation corresponds to the first Λ₍₁₎^{Ξ}^{_{—}}^{P} and second Λ₍₂₎^{Ξ}^{_{—}}^{P} particular embodiments of the linearization function Λ^{Ξ} of Ξ{P}-modulation.

When using linearization function Λ^{Ξ} in its first Λ₍₁₎^{Ξ}^{_{—}}^{P} particular embodiment, the intensity values J_{calib}^{Ξ(L)} and J^{R} of the luminous flux respectively in the left W_{form}^{L} and right W_{form}^{R} formation windows are represented by the calibration values of the Ξ{P}-component J_{calib}^{Ξ} of the luminous flux (FIG. 14), which for clarity of illustration of the subsequent realization of the linearization algorithm of the ratio of intensities J_{calib}^{Ξ(L/R)}=J_{calib}^{Ξ(L)}/J_{calib}^{Ξ(R)} is represented by a linear function of the voltage values of calibration signal u_{calib}^{Ξ} of Ξ{P}-modulation, applied to the control input in_{dir}^{Ξ} of the Ξ{P}-modulator (marked out on the drawing as signal argument u_{calib}_{_{—}}ₗᵢₙ^{Ξ}, belonging to the input in_{dir}^{Ξ}, i.e., u=u_{calib}_{_{—}}ₗᵢₙ^{Ξ}⊂in_{dir}^{Ξ}), and graphically represented by the straight line J_{calib}^{Ξ(L)}{u_{calib}_{_{—lin}}^{Ξ}} for the left formation window (graph I₁₄) with positive derivative and straight line J₀^{Ξ}−J_{calib}^{Ξ(L)}{u_{calib}_{_{—}}ₗᵢₙ^{Ξ} for the right formation window (graph II}₁₄) with negative derivative.

The graphic dependence of the relation J_{calib}^{Ξ(L/R)} (graph III₁₄) is nonlinear even with the linear graphic dependences for J_{calib}^{Ξ(L)} and J_{calib}^{Ξ(R)}, since J_{calib}^{Ξ(L/R)} of the form:

J_{calib}^{Ξ(L/R)}(u)=J_{calib}^{Ξ(L)}(u)/J_{calib}^{Ξ(R)}(u)=J_{calib}^{Ξ(L)}(u)/Jₘₐₓ^{Ξ}−J_{calib}^{Ξ}(u) (41)

is a hyperbolic dependence of the value and voltage with the maximum value Jₘₐₓ^{Ξ}/Jₘᵢₙ^{Ξ}, where Jₘₐₓ and Jₘᵢₙ are constant values, equal to the maximum and minimum values accordingly of the light intensity calibration values. The linearization of Ξ{P}-modulation due to use of the first particular embodiment Λ₍₁₎^{Ξ}^{_{—}}^{P} of the linearization function is implemented through taking of the inverse function of the nonlinearity function Φ₍₁₎^{Ξ}^{_{—}}^{P}(u) of the Ξ{P}-modulator. The function Φ₍₁₎^{Ξ}^{_{—}}^{P}(u) in accordance with relation (32) for the case of the ratio of intensities between the left W_{form}^{L} and right W_{form}^{R} formation windows is equal to Φ₍₁₎^{Ξ(L/R)}(u)≈J_{calib}^{Ξ(L)}(u)/J_{calib}^{Ξ(R)}(u), i.e., its graph is actually graph III₁₄. The graph IV₁₄ of the function, inverse of the function Λ₍₁₎^{Ξ}^{_{—}}^{P} (u), is the linearization function in its first particular embodiment Λ₍₁₎^{Ξ}.

To obtain the compensated (with corrected nonlinearity) Ξ{P}-component J_{calib}^{Ξ}^{_{—}}^{comp} (u) of the luminous flux intensity (graph V₁₁), it is applied to the control input in_{dir}^{Σ} of the electronic module of the Ξ{P}-modulator the compensating electronic signal u_{calib}_{_{—}}ₗᵢₙ^{Ξ}^{_{—}}^{comp} of the form:

u_{calib}_{_{—}}ₗᵢₙ^{Ξ}^{_{—}}^{comp}=Λ₍₁₎^{Ξ}^{_{—}}^{P}{u_{calib}_{_{—lin}}^{Ξ}^{_{—}}^{comp}} (42)

as a result of taking (calculating) the inverse function of the initial calibration signal u_{calib}_{_{—}}ₗᵢₙ^{Ξ}^{_{—}}^{comp}, so the compensating electronic signal (41) receives nonlinear properties, inverse with respect to the nonlinear properties of Ξ{P}-modulation. The result of the performance of the Ξ{P}-modulator under the control of the compensating signal (33) is formation of a compensated Ξ{P}-component of J_{calib}^{Ξ}^{_{—}}^{comp} (u) of the luminous flux intensity, in which it is already absent the {ΞP}-modulation nonlinearity that is present in the initial Ξ{P}-component of J_{calib}^{Σ(L)}(u)/J_{calib}^{Σ(R)}(u) of the luminous flux intensity, i.e., it is valid the graph VI₁₄ of the direct proportional dependence of the Ξ{P}-component of J_{calib}^{Σ(L)}(u)/J_{calib}^{Σ(R)}(u) of the intensity on the amplitude of the initial signal of u_{calib}_{_{—}}ₗᵢₙ^{Ξ}, that is applied to the input [symbol] of the electronic module with the transfer function Λ₍₁₎^{Ξ}. Analytically obtaining the directly proportional dependence described as:

$$\begin{matrix}{J}_{calib}^{Ξ \_comp} = {Λ}_{( 1 )}^{Ξ \_P} \{ {J}_{calib}^{Ξ ( L )} ( u ) / {J}_{calib}^{Ξ ( R )} ( u ) \} \\ = {Λ}_{( 1 )}^{Ξ \_P} \{ {J}_{calib}^{Ξ ( L / R )} ( u ) \} = \\ = {J}_{calib}^{- 1 \_Ξ ( L / R )} \{ {J}_{calib}^{Ξ ( L / R )} ( u ) \} = u\end{matrix} \qquad ( 43 )$$

where J_{calib}⁻^{_{—}}^{Ξ(L/R)} is the inverse function of the function J_{calib}^{Ξ(L/R)}, and taking the inverse function of the original function corresponds to the argument u of the original function, i.e., the values of u are actually plotted along the y-axis (vertical) of the graph V₁₄. At the same time, u is the argument of the signal u_{calib}_{_{—}}ₗᵢₙ^{Ξ} and is plotted along the axis of the arguments (horizontal) of graph V₁₄. The dependence of u on u is linear, from here it is followed the linearity of the graphic dependence described in (42).

Whereas the signal uₘₙ^{Ξ}≈Bₘₙ^{L}+Bₘₙ^{R} is applied to the input [symbol] of the electronic module with the transfer function Λ₍₁₎^{Ξ}^{_{—}}^{P}, the resulting compensated ratio of the intensities Jₘₙ^{Ξ(L/R)}^{_{—}}^{comp} between the two formation windows W_{form}^{L}, W_{form}^{R}:

$$\begin{matrix}{J}_{mn}^{Ξ ( L / R ) \_comp} = {Λ}_{( 1 )}^{Ξ\_ P} \{ {Φ}_{( 1 )}^{Ξ\_ P} ( {B}_{mn}^{L} / {B}_{mn}^{R} ) \} \\ = {J}_{calib}^{- 1 \_Ξ ( L / R )} \{ {J}_{mn}^{Ξ ( L / R )} ( {B}_{mn}^{L} / {B}_{mn}^{R} ) \} = \\ = {J}_{calib}^{- 1 \_Ξ ( L / R )} \{ {B}_{mn}^{L} / {B}_{mn}^{R} \cdot {J}_{calib}^{Ξ ( L / R )} ( u ) \} \\ = {B}_{mn}^{L} / {B}_{mn}^{R} \cdot {J}_{calib}^{- 1 \_Ξ ( L / R )} \{ {J}_{calib}^{Ξ ( L / R )} ( u ) \} = \\ = {B}_{mn}^{L} ( u ) / {B}_{mn}^{R} ( u )\end{matrix} \qquad ( 44 )$$

is directly proportional to B_{L}^{mn}/B_{R}^{mn}, which corresponds to graph VI₁₄ in the form of a straight line, which indicates realization of the desired linearization of Ξ{P}-modulation in relation to the arbitrary ratio of the values Bₘₙ^{L}/Bₘₙ^{R}.

When using the linearization function its second particular embodiment Λ₍₂₎^{Ξ}^{_{—}}^{P} Λ, the luminous flux intensity values J_{calib}^{Σ(L)} and J_{calib}^{Σ(R)} respectively in the left W_{form}^{L} and right W_{form}^{R} formation windows (FIG. 15) are represented as before (even in case of linear graphic dependences for J_{calib}^{Σ(L)} and J_{calib}^{Σ(R)} of graph I₁₅ and II₁₅) by the nonlinear graphic dependence of the relation J_{calib}^{Ξ(L/R)} (graph III₁₅) when the linearly-varying calibration signal u_{calib}_{_{—}}ₗᵢₙ^{Ξ} is applied to the control input in_{dir}^{Ξ} of the Ξ{P}-modulator.

The nonlinearity function Ξ{P}-modulation in its second particular embodiment Φ₍₂₎^{Ξ}^{_{—}}^{P}(u) is equal to the result of dividing J_{calib}^{Ξ(L/R)}(u) in its argument u (graph IV₁₅) and is characterized by deviations from the straight line 1{u_{calib}^{Ξ}}, that is the graphic presentation of the unit coefficient of linear transmission the values of the calibration signal u_{calib}^{Ξ} of Ξ{P}-modulation. The linearization function Λ₍₂₎^{Ξ}^{_{—}}^{P}(u) is represented by the curve (graph V₁₅), that is mirror symmetrical to the curve function Φ₍₂₎^{Ξ}^{_{—}}^{P} (u) relative to straight line 1{u_{calib}^{Ξ}} as a result of defining the values of the function Λ₍₂₎^{Ξ}^{_{—}}^{P} (u) as the inverse function of the function Λ₍₂₎^{Ξ}^{_{—}}^{P} (u).

To obtain the compensated Ξ{P}-component of J_{calib}^{Ξ}^{_{—}}^{comp} (u) of the luminous flux intensity (graph VI₁₅), it is applied to the control input of in_{dir}^{Σ} of the electronic module of the Ξ{P}-modulator a compensating electronic signal u_{calib}_{_{—}}ₗᵢₙ^{Ξ}^{_{—}}^{comp} of the form:

u_{calib}_{_{—}}ₗᵢₙ^{Σ}^{_{—}}^{comp}=Λ₍₂₎^{Ξ}^{_{—}}^{P}{u_{calib}_{_{—}}ₗᵢₙ^{Ξ}^{_{—}}^{comp}} (45)

as a result of multiplication of the functions, one of which describes the calibration values of the relation J_{calib}^{Ξ(L/R)}=J_{calib}^{Ξ(L)}/J_{calib}^{Ξ(R)} of the luminous flux intensities between the two formation windows W_{form}^{L}, W_{form}^{R}, and the other function is the linearization function in its second embodiment Λ₍₂₎^{Ξ}^{_{—}}^{P}, that is equal to the values of the nonlinearity function of Ξ{P}-modulation, which, in turn, is equal to relation (8) of the intensity value, divided by voltages values u of the calibration signal u_{calib}_{_{—}}ₗᵢₙ:

$$\begin{matrix}{J}_{calib}^{Ξ ( L / R ) \_ comp} = {J}_{calib}^{Ξ ( L / R )} \cdot {Λ}_{( 2 )}^{Ξ} \\ = {J}_{calib}^{Ξ ( L / R )} \cdot ( 1 / {Φ}_{( 2 )}^{Σ} ) \\ = {J}_{calib}^{Ξ ( L / R )} \cdot \frac{u}{{J}_{calib}^{Ξ ( L / R )}} = u\end{matrix} \qquad ( 46 )$$

From here it is followed the direct proportional dependence of the intensity values Jₘₙ^{Ξ(L/R)}^{_{—}}^{comp} (u), since u is simultaneously the argument of the u_{calib}_{_{—}}ₗᵢₙ^{Σ} and is and is plotted along the axis of the arguments (horizontal) of graph VI₁₅. Whereas the information signal uₘₙ^{Ξ}≈Bₘₙ^{L}+Bₘₙ^{R} is applied to the input [symbol] of the electronic module with the transfer function Λ₍₂₎^{Ξ}, the resulting ratio of intensities Jₘₙ^{Ξ(L/R)} of the luminous flux in the two formation windows W_{form}^{L}, W_{form}^{R}:

$$\begin{matrix}\frac{{J}_{mn}^{Ξ ( L ) \_ comp}}{{J}_{mn}^{Ξ ( R ) \_ comp}} = {J}_{mn}^{Ξ ( L / R ) \_ comp} \\ = {Λ}_{( 2 )}^{Ξ} \cdot {Φ}_{( 2 )}^{Ξ} \{ ( {B}_{mn}^{L} / {B}_{mn}^{R} ) \} = \\ = \frac{u}{{J}_{calib}^{Ξ ( L / R )}} \cdot {J}_{mn}^{Ξ ( L / R )} \{ {B}_{mn}^{L} / {B}_{mn}^{R} \} \\ = {B}_{mn}^{L} / {B}_{mn}^{R}\end{matrix} \qquad ( 47 )$$

is directly proportional to Bₘₙ^{L}/Bₘₙ^{R} (it corresponds to graph VII₁₅ in the form of a straight line), since division of function Jₘₙ^{Ξ(L/R)} into the function J_{calib}^{Ξ(L/R)}, the nonlinearity is compensated, and the resulting ratio is a correction factor to the voltage value, which corresponds to changes of Bₘₙ^{L}/Bₘₙ^{R}.

The first (preferred) particular embodiment of the second embodiment of the method (FIG. 16, 17) comprises the following: in the mn^{th} element of the cross section of luminous flux, with aid of real-amplitude optical modulator 39, that is matrix-addressed in M rows and N columns, a direct sum modulation Σ{A} is implemented due to modulation of the real amplitude A of the light wave in the mn^{th} element of real-amplitude optical modulator 39; with aid of phase-polarization optical modulator 40, that is matrix addressed in M rows and N columns, an indirect ratio modulation C{P} is implemented due to modulation of the polarization state P of the light wave in the mn^{th} element of phase-polarization optical modulator 40; the intensity modulated luminous fluxes are formed in the left Z_{form}^{L} and right Z_{form}^{R} formation zones, whereas assigning the orthogonal values of characteristic of polarization ratio modulation in the adjacent 2i and (2i−1) columns of phase-polarization optical modulator 40, the first and second groups of modulated intensity light beams are formed with aid of spatially-periodic phase-polarization converter 41, that comprises a static phase-polarization transparency 41₁ with electrical addressing by N columns and with mutually orthogonal parameters of polarization state analysis for its adjacent 2k and (2k−1) columns, wherein i, k=1, 2, . . . . , N, and a linear polarizer 41, and that converts a ratio C{P} polarization modulation in corresponding variations of the ratio component of the luminous flux intensity; and forming a first and second groups of N modulated by intensity light beams, wherein one group N of light beams is routed in one of the formation zones, the first N/2 of which pass through N/2 even 2i columns of phase-polarization optical modulator 40 and through N/2 even 2k columns of static phase-polarization transparency 41₁, and the remaining N/2 light beams pass through N/2 odd (2i−1) columns of phase-polarization optical modulator 40 and through N/2 odd (2k−1) columns of static phase-polarization transparency 41₁, and another group N of light beams is routed in the other formation zone, the first N/2 of which pass through N/2 odd (2i−1) columns of phase-polarization optical modulator 40 and through N/2 even 2k columns of static phase-polarization transparency 41₁, and the remaining N/2 light beams pass through N/2 even 2i columns of phase-polarization optical modulator 40 and through N/2 odd (2k−1) columns of static phase-polarization transparency 41₁, wherein to the control input of real-amplitude optical modulator 39 it supplied by the sum compensating signal sₘₙ^{Σ}^{_{—}}^{comp} in its first particular embodiment u₍₁₎ₘₙ^{Σ}^{_{—}}^{comp} which amplitude is directly proportional to the value of the linearization function of sum modulation in its first particular embodiment Λ₍₁₎^{Σ}^{_{—}}^{A}, taken from the product of the sum Bₘₙ^{L}+Bₘₙ^{R} (22), or by the sum compensating electronic signal in its second particular embodiment u₍₂₎ₘₙ^{Σ}^{_{—}}^{comp} which amplitude is directly proportional to the product of the sum Bₘₙ^{L}+Bₘₙ^{R} by the sum modulation linearization function in its second particular embodiment Λ₍₂₎^{Σ}^{_{—}}^{A} (23), it is applied to the control input of phase polarized optical modulator 40 a ratio compensating electronic signal uₘₙ^{Ξ}^{_{—comp}} in its first particular embodiment u₍₁₎ₘₙ^{Ξ}^{_{—}}^{comp}, which amplitude is directly proportional to the values of the linearization function Λ^{Ξ}^{_{—}}^{P} of ratio modulation in its first particular embodiment, taken from the ratio of the values (24), and the amplitude of the ratio compensating electronic signal in its second particular embodiment u₍₂₎ₘₙ^{Ξ}^{_{—}}^{comp} is directly proportional to the product of the ratio Bₘₙ^{L}/Bₘₙ^{R} by the linearization function of ratio modulation Λ^{Ξ}^{_{—}}^{P} in its second particular embodiment Λ₍₂₎^{Σ}^{_{—P}} (25), wherein the linearization function of sum modulation in its first particular embodiment Λ₍₁₎^{Σ}^{_{—}}^{P} is defined as the function F⁻¹{Φ₍₁₎^{Σ}^{_{—}}^{P}(u)}, that is the inverse of calibration function of sum modulation nonlinearity ΦΞ^{_{—}}^{P} in the first particular embodiment Φ₍₁₎^{Ξ}^{_{—P}} (26), the linearization function of sum modulation in its second particular embodiment Λ₍₂₎^{Σ}^{_{—A}}(u) is defined as the function F^{reciprocal}{Φ₍₂₎^{Σ}^{_{—}}^{A}(u)}, which values are the reciprocal values 1/Φ₍₂₎^{Σ}^{_{—}}^{A}(u) of the calibration function Φ^{Σ}^{_{—}}^{A}; the linearization function of ratio modulation in its first particular embodiment Λ₍₁₎^{Ξ}^{_{—}}^{P} (u) is defined as the function F⁻¹{Φ₍₁₎^{Ξ}^{_{—}}^{P}(u)}, that is the inverse of the calibration function Φ^{Ξ}^{_{—}}^{P} of ratio modulation nonlinearity in its first particular embodiment Φ₍₁₎^{Ξ}^{_{—}}^{P}(u) (28), and the linearization function of ratio modulation its second particular embodiment Φ₍₂₎^{Ξ}^{_{—}}^{P}(u) is defined as the function F^{reciprocal}{Φ₍₂₎^{Ξ}(u)}, which values are the reciprocal values 1/Φ₍₂₎^{Ξ}^{_{—}}^{P}(u) to the calibration function of sum modulation nonlinearity in its second particular embodiment Φ₍₂₎^{Ξ}^{_{—}}^{P}(u) (29), wherein the calibration function of modulation nonlinearity in its first particular embodiment Φ₍₁₎^{Σ}^{_{—}}^{P}(u) is equal to the assemblage of the calibration values of the uniform modulated component J_{calib}^{Σ}(u) of the luminous flux intensity on the output of either of the formation windows W_{form}^{L}, W_{form}^{R} (30) whereas it is applied to the control input in_{dir}^{Σ} of real-amplitude optical modulator 39 the linearly-varying sum modulation electronic calibration signal u_{calib}_{_{—}}ₗᵢₙ^{Σ}; and the calibration function of sum modulation nonlinearity its second particular embodiment Φ₍₂₎^{Σ}^{_{—}}^{A}(u) is equal to the ratio of the sequence of calibration values of the uniformly modulated component J_{calib}^{Σ} of the luminous flux intensity on the output of any of the formation zones Z_{form}^{L}, Z_{form}^{R} to the sequence of the corresponding values of the amplitude of the linearly-varying sum modulation electronic calibration signal u_{calib}_{_{—}}ₗᵢₙ^{Σ} (31); the calibration function of ratio modulation nonlinearity in its first particular embodiment Φ₍₁₎^{Ξ}^{_{—}}^{P(L/R)}(u) for the case of the ratio of intensities between the left Z_{form}^{L} and right Z_{form}^{R} formation zones is equal to the ratio of the assemblage of calibration values of the difference-modulated component J_{calib}^{Ξ(L)} (u) of the luminous flux intensity in the left formation zone Z_{form}^{L} to the assemblage of the calibration values of the difference-modulated component J_{form}^{Ξ(R)} (u) of the luminous flux intensity in the right formation zone Z_{form}^{R} (32) whereas it is applied to the control input in_{dir}^{Ξ} of phase-polarization modulator 40 the linearly-varying ratio modulation electronic calibration signal u_{calib}_{_{—}}ₗᵢₙ^{Ξ}; and the calibration function of ratio modulation nonlinearity its second particular embodiment Φ₍₂₎^{Ξ}^{_{—}}^{P(L/R)}(u) is equal to the ratio of the assemblage of the calibration values of difference modulated component J_{calib}^{Ξ(L)}(u) of the luminous flux intensity in the left formation zone Z_{form}^{L} to the assemblage of the calibration values of the difference-modulated component J_{calib}^{Ξ(R)}(u) of the luminous flux intensity in the right formation zone Z_{form}^{L} divided by the assemblage of the corresponding amplitude values of the linearly-varying electronic calibration signal u_{calib}_{_{—}}ₗᵢₙ^{Ξ}(u) of ratio modulation (33), wherein the limits of the amplitude change of the electronic calibration signal u_{calib}_{_{—}}ₗᵢₙ^{Σ}(u) of sum modulation correspond to a change in the calibration values of sum component J_{calib}^{Σ}(u) of luminous flux intensity from minimum to maximum calibration values, and the limits of amplitude change in the electronic calibration signal u_{calib}_{_{—}}ₗᵢₙ^{Ξ} of ratio modulation correspond to a change in the calibration values of the ratio component J_{calib}^{Ξ}(u) of the luminous flux intensity from minimum to maximum values with constant (preferably, maximum) luminous flux intensity value in the input of phase-polarization optical modulator 40.

The sum compensating signal sₘₙ^{Σ}^{_{—}}^{comp} is received on the output of functional module 42 which transfer function is linearization function Λ^{Σ}^{_{—}}^{A}(u) of sum modulation, whereas the initial sum signal uₘₙ^{Σ} is applied to the input of functional module 42 with amplitude that is directly proportional to the sum uₘₙ^{Σ}≈Bₘₙ^{L}+Bₘₙ^{R} of the values of the brightness of the mn^{th} image elements of the left and right views.

The ratio compensating signal sₘₙ^{Ξ}^{_{—}}^{comp} is received on the output of functional module 43 which transfer function is the linearization function Λ^{Ξ}^{_{—}}^{P} (u) of ratio modulation, whereas the initial signal uₘₙ^{Ξ} is applied to the input of functional module 43 with amplitude that is directly proportional to the ratio uₗᵢₙ^{Ξ}≈Bₘₙ^{L}/Bₘₙ^{R}.

The calibration and linearization procedures (FIG. 18) for the first particular embodiment of the second embodiment of method are analogous to the corresponding procedures for the first particular embodiment of the first embodiment of method, illustrated in FIG. 10-15 and corresponding to relations (34)-(47). The photo detectors 42, 43, which apertures are arranged respectively in the left Z_{form}^{L} and right Z_{form}^{R} formation zones, are used for measuring the intensity calibration values.

Separation of the image elements of the left and right images is implemented by teamwork of polarization analyzer 41₂ with phase-polarization transparency 41₁ (FIG. 19). resulting in grouping the elements 44 and 45 in different formation zones. The elements 44 and 45 are formally marked out by circular element 45 and triangular element 46, that designate, respectively, the orthogonal component and the parallel component of general polarization in plane C{P} relatively to the polarization axis of polarization analyzer 41₂. To disclose the technical essence of the method, it is sufficient to examine only the central pair of formation zones Z_{form}^{L}, Z_{form}^{R}; however, simultaneously the peripheral pairs of the formation zones (FIG. 20) are also formed, separation in which (for example, in the peripheral pair of the first order Z₁^{L}, Z₁^{R}) is implemented analogously to the central pair of formation zones Z_{form}^{L}, Z_{form}^{R}, that is the pair of the zero order formation zones.

In the second particular embodiment of the first embodiment of the method, with aid of optical generator 47 (FIG. 21) a luminous flux with the first spectrum R₁, G₁, B₁ is formed a; with aid of real-amplitude optical modulator 48 a sum modulation Σ{A} is implemented due to modulation of the real amplitude A of the luminous flux; with aid of optical frequency modulator 49 an indirect ratio modulation (Ξ{k}-modulation) is implemented in the form of the controlled change of the wavelength λ with transition from the first spectrum R₁, G₁, B₁ to the second spectrum R₂, G₂, B₂ whereas the voltage is changed at its control input from the first (minimum) to the second (maximum) value; with aid of first and second optical frequency analyzers 50, 51 a conversion C{λ→J) of the indirect ratio modulation into the ratio component of the luminous flux intensity is implemented due to comb frequency filtration, forming the luminous fluxes of the mn^{th} image elements of the left Bₘₙ^{L} and right Bₘₙ^{R} views in the left W_{form}^{L} and right W_{form}^{R} formation windows, wherein spectral characteristic R^{L}, G^{L}, B^{L} and R^{R}, G^{R}, B^{R} of the first and second optical frequency analyzers 50, 51 respectively correspond to the first R₁, G₁, B₁ and second spectrum R₂, G₂, B₂, wherein a sum compensating signal sₘₙ^{Σ}^{_{—}}^{comp} is applied to the control input of real-amplitude optical modulator 48, and a ratio compensating signal sₘₙ^{Ξ(L/R)}^{_{—}}^{comp} is applied to the control input of optical frequency modulator 49.

The sum compensating signal sₘₙ^{Σ}^{_{—}}^{A}^{_{—}}^{comp} of form (1), (2) is received on the output of functional module 52 with the transfer function, equal to the linearization function Λ^{Σ}^{_{—}}^{A} of Σ{A}-modulation, which fulfills to relations (5), (6) whereas the initial sum signal sₘₙ^{Σ} (13) is applied to the input of functional module 52.

The ratio compensating signal sₘₙ^{Ξ}^{_{—}}^{λ}^{_{—}}^{comp} is received on the output of functional module 53 with a transfer function, equal to the linearization function Λ^{Ξ}^{_{—}}^{λ} of Ξ{X}-modulation, which fulfills to relations (7), (8) whereas the initial ratio signal Sₘₙ^{Ξ} (14) is applied to the input of functional module 53.

Spectrum R₁, G₁, B₁ of the luminous flux, which passed through optical frequency modulator 49 in the absence of voltage on its control input (u=0), corresponds to the spectral characteristic R^{L}, G^{L}, B^{L} of first optical frequency analyzer 51. At maximum value of control voltage (u=uₘₐₓ) on the control input of optical frequency modulator 49, the transited luminous flux characterized by the spectrum R₂, G₂, B₂, corresponding to the spectral characteristic R^{R}, G^{R}, B^{R} of the second optical frequency analyzer 50. At intermediate value of the control voltage (u=uᵢₙₜ), the transited luminous flux has spectrum R₁, G₁, B₁.

Consequently, at u=0, the luminous flux has the maximum intensity on the output of first optical frequency analyzer 51 and the minimum intensity on the output of second optical frequency analyzer 51, and conversely at u=uₘₐₓ; thereby the optical characteristics of the converters of the Ξ{X}-modulation into a corresponding component of luminous flux intensity are complementary.

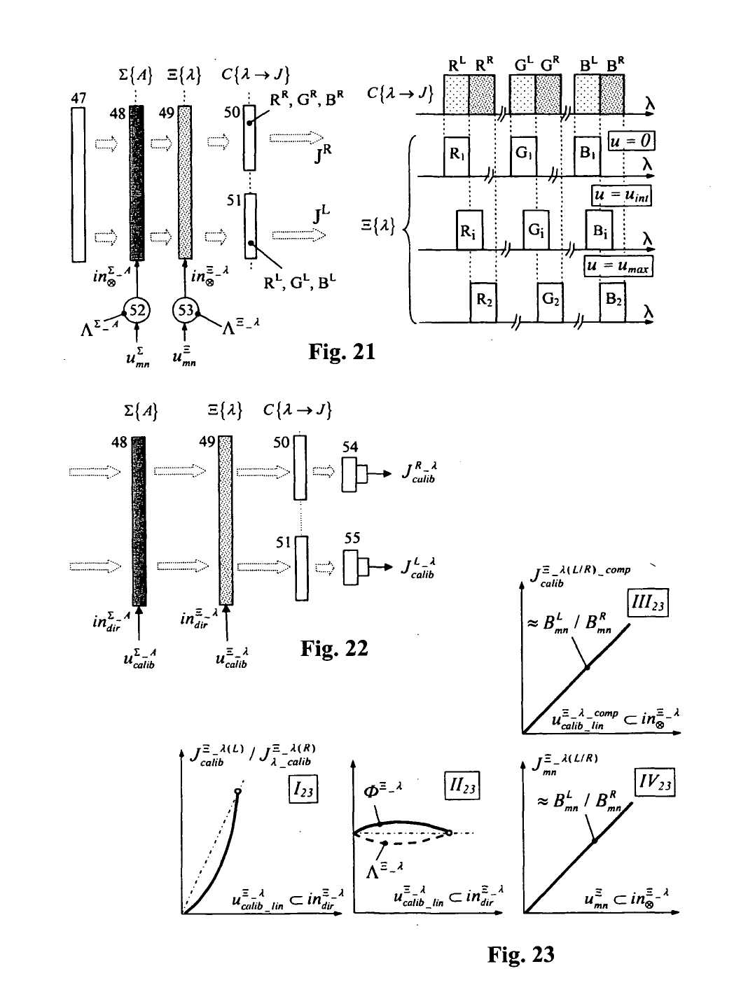

The photo detectors 54, 55 (FIG. 22) measure the calibration intensity values. The calibration procedures for determining the linearization function Λ^{Σ}^{_{—}}^{A} of sum real-amplitude modulation and the linearization function Λ^{Ξ}^{_{—}}^{A} of ratio spectral modulation is analogous to the calibration procedures, which are illustrated in FIG. 10-15 and correspond to relations (34)-(47). For example, the ratio of the luminous flux intensities J_{calib}^{Ξ}^{_{—}}^{λ(L)}/J_{calib}^{Ξ}^{_{—}}^{λ(R)}=J_{calib}^{Ξ}^{_{—}}^{λ(L/R)} in the left and right formation windows takes the form of graph I₂₃ (FIG. 23) whereas 49 the calibration signal with linearly-varying amplitude u_{calib}_{_{—}}ₗᵢₙ^{Ξ}^{_{—λ}}⊂in_{dir}^{Ξ}^{_{—}}^{λ} is applied to the control input in_{dir}^{Ξ} of the optical frequency analyzer. The linearization function Λ^{Ξ}^{_{—}}^{λ} of ratio spectral modulation is received, for example, due to the calculating the inverse values (8) of the ratio modulation spectral nonlinearity function Φ^{Σ}^{_{—}}^{λ} (graph II₂₃). When a compensating calibration signal u_{calib}_{_{—}}ₗᵢₙ^{Ξ}^{_{—}}^{λ}^{_{—}}^{comp}⊂in [symbol] ^{_{—}}^{λ} is applied to the control input of electronic module 53, a linear dependence of compensated ratio of intensities J_{calib}^{Ξ}^{_{—}}^{λ(L/R)}^{_{—}}^{comp} is present in the left and right formation windows (graph III₂₃). When the compensating information signal uₘₙ^{Ξ}⊂in [symbol] ^{_{—}}^{λ} has the form (4), a linear dependence of compensated intensity value Jₘₙ^{Ξ}^{_{—}}^{λ(L/R)} of ratio spectral modulation (graph IV₂₃) is present. Thus, separation of the stereo image views is realized in accordance with (18)-(20).

In the third particular embodiment of the second embodiment of the method, with aid of optical source 56 (FIG. 24) a collimated (parallel) luminous flux is formed; with aid of a sum diffraction optical modulator (hereafter, Σ{A}-modulator) 57 a sum diffraction modulation Σ{A} is implemented due to a change in the deflection angle α of the luminous flux in a first transverse direction (along the coordinate y); with aid of a ratio diffraction optical modulator (hereafter, Ξ{β}-modulator) 58 a ratio diffraction modulation Ξ{β} is implemented due to a change in the deflection angle β of the luminous flux in a second transverse direction (along the x coordinate); with aid a louver optical element 59, that is asymmetric in two mutually orthogonal transverse directions, in the first transverse direction a separation of the luminous flux component J^{Σ} is implemented, that corresponds to sum diffraction modulation Σ{A} in both formation windows; in a second transverse direction a separation of the luminous flux component is implemented that corresponds to ratio diffraction modulation Ξ{β}, wherein a sum compensating electronic signal uₘₙ^{Σ}^{_{—}}^{α}^{_{—}}^{comp} and a ratio compensating electronic signal uₘₙ^{Ξ}^{_{—}}^{β}^{_{—}}^{comp} are supplied respectively to the control inputs of Σ{A}-modulator 57 and Ξ{β}-modulator 58.

The sum compensating signal uₘₙ^{Σ}^{_{—}}^{α}^{_{—}}^{comp} of forms (1), (2) is received on the output of functional module 60 with the transfer function, that is equal to the linearization function Λ^{Σ}^{_{—}}^{α} of Σ{A}-modulation, which fulfills to relations (5), (6) whereas an initial sum signal sₘₙ^{Σ} with amplitude of form (13) is applied to the input of functional module 60. A ratio compensating signal sₘₙ^{Ξ}^{_{—}}^{β}^{_{—}}^{comp} is received on the output of functional module 61, having transfer function, equal to the linearization function Λ^{Ξ}^{_{—}}^{β} of Ξ{β}-modulation, which fulfills to relations (7), (8) whereas an initial ratio signal sₘₙ^{Ξ} with amplitude of form (14) is applied to the input of functional module 61.

A change in the deflection angle α of luminous flux (FIG. 25), caused by amplitude change of the sum compensating electronic signal uₘₙ^{Σ}^{_{—}}^{α}^{_{—}}^{comp}, leads to a change in overlapping factor of the luminous flux relatively vertical (along coordinate y) section 59₁ of asymmetric louver element 59, wherein the overlapping factor is identical for both formation zones Z_{form}^{L}, Z_{form}^{R}. With a change in the amplitude of the ratio compensating electronic signal sₘₙ^{Ξ}^{_{—}}^{β}^{_{—}}^{comp}, a change in the luminous flux deflection angle β leads to a different (mutually opposite) overlapping factor of the luminous flux for the left Z_{form}^{L} and right Z_{form}^{R} formation zones, since, for example, upon increasing the angle β on some angle increment, the transmission coefficient of horizontal section 59 of asymmetric louver element 59 for one of the formation zones is increased, whereas at the same angle increment the transmission coefficient for another formation zone is decreased.

The calibration procedures for obtaining the linearization function Λ^{Σ}^{_{—}}^{α} of Σ{A}-modulation and the linearization function Λ^{Ξ}^{_{—}}^{β} of Ξ{β}-modulation are analogous to the corresponding procedures for another particular embodiments of the first or second embodiments of the method, illustrated in FIG. 10-15 and described by relations (34)-(47). For example, after obtaining the calibration values of the intensities ratio J_{calib}^{Ξ}^{_{—}}^{β(L/R)}^{_{—}}^{comp} in the left and right formation zones (FIG. 26), the linearization function Λ^{Ξ}^{_{—}}^{β} of Ξ{β}-modulation is determined by calculating the inverse values of the corresponding values of the nonlinearity function Φ^{Ξ}^{_{—}}^{β}, which leads to the linearization of the Ξ{β}-component of the information variations of the luminous flux intensity Jₘₙ^{Ξ}^{_{—}}^{β(L/R)} depending on the amplitude of the ratio compensating electronic information signal uₘₙ^{Ξ}^{_{—}}^{β}.

For parallel forming of all M·N elements of the stereo image, a matrix 62 of asymmetric louver elements 59 (FIG. 27) is used, that is implemented, for example, by nano-technological means or by a holographic method.

In the fourth particular embodiment of the first embodiment of the method, with aid of analog real-amplitude optical modulator 63 (FIG. 28), a sum modulation Σ{A} is implemented due to analog modulation of real-amplitude A of the luminous flux; with aid of bistable polarization modulator 64 a bistable polarization ratio modulation Ξ{P_{Bi}} (hereafter, Ξ{P_{Bi}}-modulation) is implemented due to pulse-width modulation (PWM) between two mutually orthogonal polarization states; with aid of a first 65 and second 66 polarization converters with complementary polarization states, a ratio modulation analog polarization conversion C{P_{Bi}→J} into bistable variations of the ratio component of luminous flux intensity is implemented, wherein the analog linearization function Λ_{analog}^{Σ}^{_{—}}^{A} of sum modulation is determined in accordance with relations (26), (27); and the linearization function Λ_{Bi}^{Σ}^{_{—}}^{P} of Ξ{P_{Bi}}-modulation in the first embodiment Λ_{(1)Bi}^{Ξ}^{_{—}}^{P} is the inverse to the function Φ_{Bi}^{Ξ}^{_{—}}^{P} of Ξ{P_{Bi}}-modulation nonlinearity in the first embodiment Φ_{(1)Bi}^{Ξ}^{_{—}}^{P}:

Λ_{(1)Bi}^{Ξ}^{_{—}}^{P}(u)≈F⁻¹{Φ_{(1)Bi}^{Ξ}^{_{—}}^{P}(u)}, (48)

where Φ_{(1)Bi}^{Ξ}^{_{—}}^{P} is defined as the ratio \tilde{J}_{calib}_{_{—}}_{Bi}^{Ξ}^{_{—}}^{P(L/R)}(u) of the time-averaged calibration values \tilde{J}_{calib}_{_{—}}_{Bi}^{Ξ}^{_{—}}^{P(L)}(u) of the Ξ{P_{Bi}}-component of the luminous flux intensity in the left formation window to the time-averaged calibration values \tilde{J}_{calib}_{_{—}}_{Bi}^{Ξ}^{_{—}}^{P(R)}(u) of the Ξ{P_{Bi}}-component of the luminous flux intensity in the right formation window:

$$\begin{matrix}{Φ}_{Bi}^{Ξ\_ P} ( u ) \approx {\tilde{J}}_{calib\_Bi}^{Ξ\_ P ( L )} ( u ) / {\tilde{J}}_{calib\_B i}^{Ξ\_ P ( R )} ( u ) = {\tilde{J}}_{calib\_B i}^{Ξ\_ P ( L / R )} ( u ) , \\ wherein & ( 49 ) \\ \begin{matrix}{\tilde{J}}_{calib\_B i}^{Ξ\_ P ( L )} ( u ) = {\int }_{t}^{ } {J}_{calib\_B i}^{Ξ\_ P ( L )} d t , {\tilde{J}}_{calib\_Bi}^{Ξ\_ P ( R )} ( u ) \\ = {\int }_{t}^{ } {J}_{calib\_B i}^{Ξ\_ P ( R )} d t\end{matrix} \\ {\tilde{J}}_{calib\_B i}^{Ξ\_ P ( L / R )} ( u ) = {\int }_{t}^{ } {J}_{calib\_Bi}^{Ξ\_ P ( L )} d t / {\int }_{t}^{ } {J}_{calib\_Bi}^{Ξ\_ P ( L )} d t , & ( 50 )\end{matrix}$$

whereas the calibration pulse-width signal u_{calib}_{_{—}}ₗᵢₙ_{_{—}}_{Bi}^{Ξ}^{_{—}}^{comp} with linearly-varying pulse width is applied to the control input of bistable polarization modulator 64; and the linearization function of {P_{Bi}}-modulation in its second embodiment Λ_{(2)Bi}^{Ξ}^{_{—}}^{P} is defined as the assemblage of the values each of that is the reciprocal value of the corresponding value of the nonlinearity function in its second embodiment ΦΛ_{(2)Bi}^{Ξ}^{_{—}}^{P}:

Λ_{(2)Bi}^{Ξ}^{_{—}}^{P}(u)≈1/Φ_{(2)Bi}^{Ξ}^{_{—}}^{P}(u), (51)

where the nonlinearity function in its second embodiment Φ_{(2)Bi}^{Ξ}^{_{—}}^{P} is equal to:

$$\begin{matrix}{Φ}_{( 2 ) Bi}^{Ξ\_ P} \approx \frac{{\tilde{J}}_{calib\_B i}^{Ξ\_ P ( L )} ( u ) / {\tilde{J}}_{calib\_B i}^{Ξ\_ P ( R )} ( u )}{{\tilde{u}}_{calib\_lin \_Bi}^{Ξ\_ P}} = \frac{{\tilde{J}}_{calib\_B i}^{Ξ\_ P ( L / R )} ( u )}{{\tilde{u}}_{calib\_lin \_Bi}^{Ξ\_ P}} \\ wherein \text{:} & ( 52 ) \\ {\tilde{u}}_{calib\_lin}^{Ξ\_ P} = {\int }_{0}^{T} {u}_{calib\_lin \_Bi}^{Ξ\_ P} d t . & ( 53 )\end{matrix}$$

The sum compensating signal uₘₙ^{Σ}^{_{—}}^{A}^{_{—}}^{comp} of forms (1), (2) is received on the output of electronic module 67 with the transfer function corresponding to analog linearization function Λ_{analog}^{Σ}^{_{—}}^{A} of sum modulation, which fulfills to relations (5), (6) whereas to the input of functional module 67 an initial sum signal with amplitude of form (13).

The ratio bistable compensating signal sₘₙ_{_{—}}_{Bi}^{Ξ}^{_{—}}^{P}^{_{—}}^{comp} is received on the output of PWM-transformer 68 with the transfer function, corresponding to the bistable linearization function Λ_{Bi}^{Σ}^{_{—}}^{P} of ratio modulation, which fulfills to relations (40), (44) whereas an initial ratio signal sₘₙ^{Ξ} with amplitude of form (14) is applied to the input of the PWM-transformer 68.

With aid of PWM-transformer the value of the analog calibration electronic signal u_{calib}_{_{—}}ₗᵢₙ^{Ξ} with linearly-varying amplitude is converted into variable-duration pulses with constant amplitude, sufficient for driving the bistable polarization modulator 64.

A special feature of the procedure for obtaining the values of the modulation function of bistable ratio polarization with pulse-width modulation of luminous flux intensity (FIG. 29) includes measuring the intensity of calibration optical pulses in the two formation windows W_{form}^{L}, W_{form}^{R} with aid of high speed photo detectors 69, 70 which outputs are connected with the inputs of time integrators 71, 72, whereas to the control input of the bistable optical modulator 64 a calibration electronic signal is applied u_{calib}_{_{—}}ₗᵢₙ^{Ξ}^{_{—}}^{Bi} in the form of a sequence of electric pulses with linearly-varying (linearly increasing) width produced by PWM-transformer 68. The time response of bistable optical modulator 64 includes the alternate realization of two mutually orthogonal polarization states, one of which corresponds to the zero logical level of the amplitude of the control electric pulses, and another one corresponds to the module logical level of amplitude. For example, with the first value u₁ of the analog calibration signal applied to the input of PWM-transformer 68, the latter produces an electric pulse with a small width T₁, which leads to the momentary realization of the vertical (relative to the plane of the drawing in FIG. 30) polarization state of bistable optical modulator 64, and, respectively, to the short-term (with time T₁) appearance of a light pulse in the left formation window and to the appearance a light pulse with complementary duration of T−T₁ in the right formation window, as a result of the performance of polarization converters 65, 66 with mutually orthogonal polarization characteristics. In the next cycle with the second value u₂ of the analog calibration signal u_{calib}_{_{—}}ₗᵢₙ^{Ξ} (where u₂>u₁) PWM transformer 68 produces an electric pulse with a greater width T₂, which leads to the appearance in the left formation window a light pulse of greater (with time 72) duration, and in the right observation window—a pulse of reduced duration T−T₂. After measurement of intensity of the optical pulses by photo detectors 69, 70 the corresponding electronic signals enter the inputs of time integrators 71, 72, characterized by constant time T of integration, which corresponds to the pulse repetition period in the calibration electronic signal u_{calib}_{_{—}}ₗᵢₙ. The electronic signals on the outputs of time integrators 71, 72 are analog signals, which envelopes correspond to time-averaged calibration values of ratio components J_{calib}^{Ξ(L)} and =

\tilde{J}_{calib}^{Ξ(R)} (FIG. 31) of the luminous flux intensity respectively in the left and right formation windows (graphs I₃₁). Integration in time of the calibration intensity values makes it possible to ensure linearization when using analog transfer functions, analog nonlinearity functions and analog linearization functions for bistable ratio polarization modulation, which are calculated with aid of analog or digital functional modules analogously to the other particular embodiments of the method in accordance with expressions (49), (50), (52).

When viewing the stereo image during the operation of bistable polarization modulator 64, the light pulses (which change in width is linearly related with a change in the ratio Bₘₙ^{L}/Bₘₙ^{R}) come to the formation windows W_{form}^{L}, W_{form}^{R} (to the observer's eyes located in observation windows W_{V}^{L}, W_{V}^{R}). The human vision is characterized by short-term optical memory, which ensures temporary integration of arriving light pulses, i.e., making it possible to perceive light pulses of constant level with variable duration as uninterrupted luminous flux with intensity proportional to the duration of the optical pulse of constant intensity level if the frequency of arrival of optical pulses to each eye of the observer is higher than a critical value (if frequency of arrival is not below 50-60 hertz, based on what the frame rate of television systems was selected), then luminous energy is distributed between the two formation windows W_{form}^{L}, W_{form}^{R} due to the bistable PWM, wherein a light pulse of duration Tₘₙ, directly proportional to the ratio B_{L}^{mn}B_{R}^{mn} is sent to the first of the formation windows, at the same time a light pulse with duration of T−Tₘₙ is sent to the second formation window. As a result of the integrating property of the person's vision, at linear increase of the duration of the optical pulse in the left observation window, the left eye perceives the equivalent linear increase of the luminous flux intensity, proportional to an increase in the ratio B_{L}^{mn}/B_{R}^{mn}. In the right observation window the right eye perceives a decrease of the time-averaged luminous flux intensity (in accordance with the ratio B_{L}^{mn}/B_{R}^{mn}). The perceived by the left (or right) eye time-averaged luminous flux intensity values arel graphically correspond to straight lines which ordinates are numerically equal to integrals by duration T (FIG. 31, graph II₃₁). This means that relation (19) is fulfilled for the considered luminous flux intensities. Simultaneously with aid of analog real-amplitude optical modulator 63 a sum modulation of the luminous flux component proportional to the sum Bₘₙ^{L}+Bₘₙ^{R} is implemented (after preliminary calibration with sum modulation linearization in accordance with relations (7)-(10)). Then relation (18) for luminous flux intensities in the observation windows is also fulfilled. That leads to fulfilling relation (20), i.e., to the desired separation of the views (forming) of the stereo image.

When calculating nonlinearity functions, known characteristic of nonlinear perception by human vision of changes in brightness (intensity) of luminous fluxes entering into the eyes should be taken into account.

The first, second, third and fourth particular embodiments of the second method embodiment are implemented analogously to the corresponding particular embodiments of the first embodiment of the method, the special feature only includes the fact that measuring of intensity calibration values is implemented in the formation zones Z_{form}^{L}, Z_{form}^{R} (instead of the formation windows W_{form}^{L}, W_{form}^{R}).

In the first, second, third and fourth particular embodiments of the method a nonlinear interaction between the physical parameters of Σ-modulation and Ξ-modulation is absent, which makes it possible to conduct for them separate (mutually independent) calibration procedures, which leads to obtaining, respectively, a one-dimensional linearization function of Σ-modulation and a one-dimensional linearization function of Ξ-modulation, which arguments are the values only of their own calibration signals—of the signal (Σ-modulation assignment) and the signal (Ξ-modulation assignment).

The absence of nonlinear interaction in the first, second and fourth particular embodiments of the method takes place with differing parameters of Σ-modulation and Ξ-modulation (real-amplitude modulation for Σ-modulation and polarization or spectral modulation of Ξ-modulation), which do not interact nonlinearly as a result of using different physical characteristic of the luminous flux (light wave). The absence of nonlinear interaction in the third particular embodiment of the method takes place with similar parameters (diffraction modulation) of Σ-modulation and Ξ-modulation, but acting mutually independently as a result of using two mutually orthogonal directions in space. In the general case, nonlinear interaction of Σ-modulation and Ξ-modulation is absent if they are realized with aid of corresponding (differing between themselves) degrees of freedom of the mathematical space of the modulation parameters.

On the contrary, using the same degree of freedom of the space of the modulation parameters for realization both Σ-modulation and Ξ-modulation leads to the appearance of their nonlinear interaction. The nature and physical implementation of the interaction is determined by the selection of the concrete form of sum (uniform-effect) optical modulator and/or ratio (difference-effect) optical modulator.

In the fifth particular embodiment of the first embodiment of the method, with aid of amplitude polarization optical modulator 73 (FIG. 32) a sum modulation Σ{A;P} is implemented due to modulation of real amplitude A (as main sum modulation) of the luminous flux in combination with modulation of the its polarization state P (as concomitant sum modulation); with aid of polarization modulator 74, ratio polarization modulation Ξ{P} of luminous flux is implemented due to modulation of the its polarization state P (as main ratio modulation); with aid of polarization converters 75, 76 with complementary polarization characteristic, ratio polarization modulation conversion C{P→J) is implemented in the corresponding variations of the ratio component of the flux luminous intensity and concomitant sum polarization modulation in the corresponding variations of the total component of the flux luminous intensity.

The special feature of the fifth particular embodiment of the method is the presence of two (main A and concomitant P) physical parameters of Σ-modulation, where the concomitant Σ-modulation parameter (polarization state of the luminous flux) is similar to the main Ξ-modulation parameter. The main Σ-modulation (or Ξ-modulation) parameter is that one of its parameters that is purposefully used for carrying out the operation of summing the brightness of the left and right views, and its use is sufficient for calculating the sum (or the ratio) of the values of the brightness of the left and right views. The form of the information signal sₘₙ^{Σ} (sₘₙ^{Ξ}), applied to the control input of the Σ-modulator (Ξ-modulator) is calculated to achieve the required characteristics of the main Σ-modulation (or Ξ-modulation) parameter. The concomitant Σ-modulation (or Ξ-modulation) parameter is that physical parameter of the luminous flux (light wave), which presence is not necessary for calculating the sum of the values (or the ratio of values) of the brightness of the left and right views, but its occurrence is caused by particular features of concrete implementation of the Σ-modulator (Ξ-modulator).

The presence of concomitant polarization modulation in the Σ-modulation in the fifth particular embodiment of the first embodiment of the method leads to the appearance of asymmetry in the graphs of the calibration intensity values of the sum component of the luminous flux intensity between the two formation windows W_{form}^{L}, W_{form}^{R} (FIG. 35) in case of carrying out a separate calibration procedure for Σ-modulation That is the principle difference from the results of carrying out the calibration procedure in the absence of the concomitant Σ-modulation parameters, where the corresponding graphic dependences are symmetrical. To illustrate the asymmetry origin in graphs I₃₅ and II₃₅ (corresponding to intensities values in the left W_{form}^{L} and right W_{form}^{R} formation windows), the superimposed graphic dependences for the calibration values of Σ-modulation components are shown in the case of separate main modulation in the form only of real-amplitude modulation of the luminous flux (separately represented on graphs III₃₅ and IV₃₅ for the left and right formation windows), and in the case of separate concomitant polarization modulation. On graph pairs V₃₅, VI₃₅ and VII₃₅, VIII₃₅ (corresponding to the left W_{form}^{L} and right W_{form}^{R} formation windows) graphic construction of the result of the combined effect of main and concomitant Σ-modulation is presented, from which the apparent asymmetry between the graphic dependences in case of carrying out an independent calibration procedure for Σ-modulation is obvious.

Since the concomitant Σ-modulation parameter serves also as main parameter for Ξ-modulation, to restore the symmetry of the graphs for Σ-modulation, the joint calibration procedure for Σ-modulation and Ξ-modulation is carried out After this a Σ-modulation symmetry is ensured due to mutual compensation for the Σ-modulation and Ξ-modulation polarization parameters. The received assemblage of the compensating values of the Ξ-modulation polarization parameter is the assemblage of the starting points of the Ξ-modulation information component, different for the different values of the control signal amplitude. The joint calibration procedure leads to the two-dimensional function describing the calibration intensity values J_{calib}^{Ξ(Σ)}(u_{calib;}^{Ξ}u_{calib}^{Σ}) of Ξ-modulation nonlinearity, which has become a function of two variable, namely, of its own ratio calibration signal u_{calib}^{Σ} and of crossed sum calibration signal u_{calib}^{Ξ}. In the process of joint calibration (with aid of measuring luminous flux intensities by photo detectors 77, 78 (FIG. 33), the values of the signal u_{calib}^{Ξ}, are determined ensuring the indicated compensation for each resolvable value of the amplitude of the signal u_{calib}^{Σ}. In the functional module 79 the identical values of the intensities in the left W_{form}^{L} and right W_{form}^{R} formation windows, providing indicated compensation, are compared, whereas corresponding values of calibration signals (applied to the control inputs of real-amplitude modulator 73 and polarization modulator 74) are stored. Then the separate calibration procedure for Ξ-modulation is implemented with using the stored (in the memory of functional module 76) values of the calibration signal of Ξ-modulation as the initial values for calibration of Ξ-modulation only. After both calibration procedures are carried out, two sets of calibration values are stored in the memory of functional module 79, one of which (relating to Σ-modulation) is one-dimensional—J_{calib}^{Σ}^{_{—}}^{A}(u_{calib}^{Σ}) and is used for calculating the one-dimensional nonlinearity function and the one-dimensional linearization function of Σ-modulation in accordance with relations (26), (27). Another set of calibration values J_{calib}^{Ξ(Σ)}(u_{calib;}^{Ξ}u_{calib}^{Σ}) is two-dimensional (represented, for example, by selection of data from the table in FIG. 34), and is used for calculating the two-dimensional nonlinearity function and the linearization function of Ξ-modulation. The obtained linearization functions are data for the assigned transfer functions of electronic modules 78 and 79, the latter of which has two inputs, one for inputting its own Ξ-modulation information signal, the other for inputting the cross Ξ-modulation information signal.

The sixth particular embodiment of the first embodiment of the method is characterized by the use of an amplitude polarization modulator 80 (FIG. 36) for implementation of main real-amplitude modulation and concomitant polarization modulation as components of Σ{A, P}-modulation, and also an amplitude polarization modulator 81 for implementation of main polarization modulation and concomitant real-amplitude modulation as components Ξ{P, A}-modulation, both of which—Σ{A, P}-modulation and Ξ{P, A)-modulation—are converted with aid of polarization converters 82, 83 into corresponding variations of intensity in the left and right formation windows. whereas to the control inputs of amplitude polarization modulator 80 and amplitude polarization modulator 81 the corresponding calibration signals. The photo detectors 82₁ and 83₁ measure the optical intensities.

Joint calibration procedures are carried out for obtaining the two-dimensional function of Σ-modulation nonlinearity and two-dimensional function of Ξ-modulation nonlinearity, based on which the Σ-modulation and Ξ-modulation two-dimensional linearization functions are calculated, which are the transfer functions of electronic modules 84, 85 (FIG. 37, 38), each of which has two inputs.

In the general case, Σ-modulation and/or Ξ-modulation are characterized by the sum of parameters, from which some parameters relate to the main parameters, while the remaining ones relate to the concomitant parameters. To account for the interaction of the corresponding Σ-modulation and/or Ξ-modulation parameters, joint calibration procedures are used for all pairs of interacting parameters, as a result they receive multidimensional nonlinearity functions and the corresponding Σ-modulation and/or Ξ-modulation linearization functions are calculated.

The device for forming and observing stereo images with maximum resolution contains a stereo video signal source 86 (FIG. 39), the first 87 and second 88 functional modules, an optical source 89 and sequentially located on the optical axis a sum optical modulator 90, that is electrically addressed in M rows and N columns, a ratio optical modulator 91, that is electrically addressed in M rows and N columns, an optical selector 92, that is electrically addressed in N columns, each of that is implemented with two complementary arbitrary optical states and arbitrary unambiguous characteristic of transition between these states, the aperture of an mn^{th} element of sum optical modulator 90 is optically connected with an aperture of the mn^{th} element of ratio optical modulator 91, wherein the adjacent (2k−1) and 2k columns of ratio optical modulator 91 and adjacent (2i−1) and 2i columns of optical selector 92 are implemented with the possibility of assigning respectively the first and second complementary states of the working medium between adjacent columns, the axis of symmetry of one of the formation zones is the common intersection line of N planes, of which the first N/2 planes pass through the axes of symmetry of the odd (2k−1) columns of ratio optical modulator 91 and through the axes of symmetry of the even 2i columns of optical selector 92, and the remaining N/2 pass through the axes of symmetry of the even 2k columns of ratio optical modulator 91 and through the axes of symmetry of the odd (2i−1) columns of optical selector 92, the axis of symmetry of another of formation zones is the common intersection line of N planes, of which the first N/2 planes pass through the axes of symmetry of the even 2k columns of ratio optical modulator 91 and through the axes of symmetry of the even 2i columns of optical selector 92, and the remaining N/2 planes pass through the axes of symmetry of the odd (2k−1) columns of ratio optical modulator 91 and through the axis of symmetry of the odd (2i−1) columns of optical selector 92, where n, k=1, 2, . . . , N, m=1, 2, . . . , M, the output of stereo video signal source 86 is connected with the inputs of the first 87 and second 88 functional modules, the output of the first of that is connected with the input of sum optical modulator 90, and the output of the second one—to the control input of ratio optical modulator 91; moreover, the first functional module 87 is implemented with transfer function T^{Σ}, that is the inverse of transfer function Φ^{ch}^{_{—}}¹ of the first optoelectronic channel:

T^{Σ}=F⁻¹{Φ^{ch}^{_{—}}¹}, (54)

the input of that is the control input of sum optical modulator 90, and the optical output is either of the formation zones Z_{form}^{L}, Z_{form}^{R}, the second electronic functional module 88 is implemented with transfer function T^{Ξ}, that is the inverse of transfer function Φ^{ch}^{_{—}}² of the second optoelectronic channel:

T^{Ξ}=F⁻¹{Φ^{ch}^{_{—}}²}, (55)

the input of that is the control input of ratio optical modulator 91, the optical outputs are apertures of both Z_{form}^{L}, Z_{form}^{R} formation zones, and the optical intensity values are the values of the transfer functions of the first and second optoelectronic channels.

The unambiguity (uniqueness) of the arbitrary characteristic (function) of transition between two arbitrary complementary optical states means the presence of only one value in this characteristic (function) for each value of its argument.

The initial optical state of the working medium is identical in all elements of Σₘₙ of sum optical modulator (FIG. 41), and the initial states of the working medium are complementary for adjacent columns with elements Ξₘₙ of ratio optical modulator (FIG. 42) and for adjacent columns Cₙ of the optical selector (FIG. 43).

The operation of the device corresponds to the second embodiment of the method, where the function of sum modulation nonlinearity in its first particular embodiment Φ₍₁₎^{Σ} is equal to the transfer function Φ^{ch}^{_{—}}¹ of the first optoelectronic channel, the linearization function of sum modulation in its first particular embodiment Λ₍₁₎^{Σ} is equal to the transfer function of electronic functional module 87, function of the ratio modulation nonlinearity in its first particular embodiment Φ₍₁₎^{Ξ} is equal to the transfer function Φ^{ch}^{_{—}}² of the second optoelectronic channel, and the linearization function of ratio modulation in its first particular embodiment Λ₍₁₎^{Ξ} is equal to the transfer function T^{Ξ} of electronic functional module 87.

The linearization procedure of transfer functions of the first and second optoelectronic channels of the device is spent in accordance with the graphic dependences represented in FIG. 10, 11, 13, 14 and schematic diagram shown in FIG. 18 with a structural diagram for calculating linearization functions according to the example shown in FIG. 9. The linearized device operates in accordance with relations (26), (27), from which the achievement of the desired separation of the stereo image views is followed in accordance with expression (20).

The optical state S of the working medium is described by a generalized complex function of the form:

S=Kexp(−iΘ), (56)

where K is real-amplitude transmission (absorption) coefficient, Θ is the generalized phase, which physical meaning is determined by concrete selection of optical characteristic of the working medium, utilized for forming the transfer function of the optoelectronic channel of the device. The complementarity of two optical states corresponds to their mutual opposition, that in each specific case takes the form of concrete relations between certain optical parameters of the working medium. The two complementary optical states of the working medium, i.e., initial state S and complementary to it state S*, correspond to two complex conjugate values of function (50), where S*=Kexp (iΘ), which can be caused not only by mutually opposite signs of generalized phase Θ, but be replaced by two extreme values of real amplitude transmission coefficient K. For the optical characteristics, represented by variations in the real-amplitude transmission coefficient only (generalized phase Θ is equal to 0), the two complementary optical states of the working medium correspond to maximum and minimum values K of optical transmission. For an optically anisotropic working medium when Θ=2πδ, where δ is the phase delay between ordinary and extraordinary ray, two complementary optical states correspond to two δ values, corresponding to two values of Θ_{δ} differing by π/2. For optically active medium Θ_{φ}=φ, where φ is the angle of optical activity, which corresponds to a change in the angular position of the polarization state (plane of polarization or ellipse of polarization), the two complementary optical states correspond to two values of φ, which differing by 90°. The value of K can be spectrally dependant (be a function of the light wavelength λ) or depend on the value of the angle to the normal of the plane of sum optical modulator 90 or ratio optical modulator 91 (for an angle-selective working medium). For a working medium with controlled optical thickness Θ_{d,λ}=2πdn/λ, where d is the physical thickness value, n is the refractive index value of the working medium. For example, the maximum value of the real-amplitude absorption coefficient of the luminous flux is complementary to its minimum (zero) value when using polarization selectors (analyzers) with mutually orthogonal polarization characteristic. In case of linear polarization the complementary values of the anisotropic optical thickness of the ratio optical modulator are its values corresponding to zero and 180° (differing by the value n) initial phase shifts for ordinary and extraordinary rays in the working medium In the case of circular polarization a difference ratio modulation implementation corresponds to zero 0 and 90° (π/2) values of initial phase shift of polarization of light between the formation windows. Any values that are multiples of the phase shift by the value of 2π, can be algebraically added to the phase shift values in all cases without effect on the resultant complementarity of optical states.

The sum optical modulator, ratio optical modulator and optical selector can be mutually permutated in the method and device along the direction of propagation of the luminous flux (along the optical axis) with formation of the particular embodiments for realizing the technical disclosures, for which the operations of sum, ratio and conversion (spatial selection) of spatial optical signals are invariant relative to the permutation, owing to universality of the calibration procedures of linearization of optoelectronic channels.

The first particular embodiment of implementation of the device (characterized by inverted order of arrangement of optical components in comparison with the first particular embodiment of the second embodiment of the method), comprises sequentially arranged along an optical axis an optical source 93 (FIG. 44), an optical selector 94, a ratio optical modulator 95 and a sum optical modulator 96, wherein the optical source 93 is implemented in the form of sequentially arranged a parabolic reflector 93₁, a point light source 93₂, located in the focus of the parabolic reflector 93₁, and a transmitting-reflecting (transflective) layer 93₃ of cholesteric LC with circular twisting of molecules; the optical selector 94 is implemented with a layer of working medium in the form of an electrically addressable birefringent LC layer with phase delay values of π/2 and 3 π/2 respectively in (2i−1) and 2i columns, the ratio optical modulator 95 is implemented in the form of a layer of working medium in the form of an electrically addressable layer with phase delay values of 0 and π respectively in the (2k−1) and 2k columns of the layer adjacent with the first linear polarizer 97; a sum optical modulator 96 is implemented in the form of a layer of working medium in the form an electrically addressable 90°-twisting LC layer, adjacent with the second linear polarizer 98, which polarization direction is orthogonal to the polarization direction of the first polarizer 97. Each of the electrically addressable LC layers is arranged between two transparent electrodes 99, 100, to which a voltage U_{control} for controlling the optical state of the layer is applied.

The device works as follows. Optical source 93 generates a circularly polarized light wave (for example, with left-side rotation of the polarization plane). The implementation of optical source 93 under consideration makes it possible to ensure close to 100% efficiency of conversion of emanating from point source 93₂ not polarized light to circularly polarized light, because the transflective layer 93₃ of cholesteric LC transmits, for example, only the left-circularly polarized component of the luminous flux, and its remaining components are reflected from layer 93₃ of cholesteric LC back to reflector 93₁, moreover, as a result of reflection from reflector 93₁, the original direction of circulation of light changes to the inverse direction, which ensures the iterative procedure of conversion of not polarized light into left-circular light with a small absorption of its energy. The left circular polarized light wave, after passing through optical selector 94, is broken up into N light beams, from which any pair of adjacent 2i and 2i−1 light beams (passing through 2i and 2i−1 columns of optical selector 94, respectively) is characterized by mutually orthogonal directions of the polarization vector of the light wave, since segments of the working medium of 2i and 2i−1 columns are characterized, respectively, by π/2 and 3 π/2 phase shifts between ordinary and extraordinary rays. In the initial state, the working medium of ratio optical modulator 95 is characterized by phase shift values 0 and π in segments which correspond to columns 2k−1 and 2k. Therefore in the initial state of the device when sum optical modulator 96 is opened (i.e., its layer of working medium in all its mn^{th} elements ensures 90°-twist of the linear polarization plane of the transmitted light wave with zero control voltage at the control input in_{dir}^{Σ}) the left formation zone receives the luminous fluxes transmitted through columns (2i−1) of optical selector 94 and through the columns (2k−1) of ratio optical modulator 95, and also through their columns 2i and columns 2k, since the polarization direction of the luminous flux for the these optical paths is parallel to the direction of the polarization axis of polarizer 97. In the initial state of the device, luminous fluxes can not pass into the right formation zone, since for all combinations of i and k, corresponding to optical paths, which lead into the right formation zone, the polarization of the transmitted luminous flux will be orthogonal to the direction of the polarization axis of linear polarizer 97. At applying to the control input in_{dir}^{Ξ} of ratio optical modulator 95 the calibration electronic signal u_{calib}_{_{—}}ₗᵢₙ^{Ξ} (with linear-increasing amplitude from 0 to the maximum value) a reduction in intensity is occur (up to complete extinction) of the luminous flux in the left formation window, and an increase in intensity (up to the maximum value) is occur in the right window formation as a result of a change of phase delay values in segments of the working medium of the ratio optical modulator (π→2π=0 for column 2k and 0→π for column 2k−1) up to complete extinction of the luminous flux in the left formation window and maximization of its intensity in the right formation window. This means that ratio optical modulator 95 is the difference-effect optical modulator, with aid of which a ratio modulation is realized whereas to the control input in_{dir}^{Ξ} of ratio optical modulator 95 a ratio compensating signal uₘₙ^{Ξ}^{_{—}}^{comp} is applied, since before this the calibration procedure was carried out for ratio modulation, which corresponds to carrying out the calibration procedure for the first optoelectronic channel, the input of that is the control input in_{dir}^{Ξ} of ratio optical modulator 95, and the outputs are both formation zones. The schematic diagram showing the spending the calibration procedure corresponds to the schematic diagram shown in FIG. 16-18, and relations (26), (27) are used for calculating transfer function T^{Σ}, inverse to the nonlinearity function Φ^{ch}^{_{—}}¹ of the first optoelectronic channel with substitution of the function Φ^{ch}^{_{—}}¹ instead of the function Φ^{Σ}, and the result (instead of linearization function Λ^{Σ}) will be the transfer function T^{Σ}.

At applying the calibration electronic signal u_{calib}_{_{—}}ₗᵢₙ^{Ξ} to the control input in_{dir}^{Σ} of sum optical modulator 96, the latter functions as a uniform-effect modulator that causes identical (of the same sign and identical value) variations in the luminous flux intensity in both formation windows. Analogously, the linearization function of the second optoelectronic channel is determined in accordance with relations (28), (29), where, instead of nonlinearity function Φ^{Ξ}, the function Φ^{ch}^{_{—}}² is substituted, then the result of calculating is the transfer function T^{Ξ} instead of linearization function Λ^{Σ}. At applying the electronic compensating signal uₘₙ^{Σ}^{_{—}}^{comp} to the control input in_{dir}^{Σ} of sum optical modulator 96, a sum modulation is implemented. As a result, in the first particular embodiment of the device the corresponding embodiment of the method is implemented.

A color stereo image is realized in the method and the device due to the creation of a spatial triad of adjacent color image elements R, G, B in each mn^{th} element of the sum or ratio optical modulators with individual matrix addressing of each color pixel (with corresponding tripling of the number of address columns in the optical modulators in comparison with a black and white image). The calibration procedures are not changed in comparison with the case of black-and-white images.

Concrete examples of the implementation of the sum optical modulator, ratio optical modulator and optical converters (selectors) in the method and device (in the particular embodiments of their implementation) are determined in essence by the type and structure of the working medium, the variation of optical parameters of which are used for modulation of light wave (luminous flux) characteristics.

It is preferable to use LC material as the working medium because of possibility of implementation on its basis all optical components in the method and device, which also leads to the possibility of mutual compensation of chromatic dispersion of LC media (and to a corresponding increase in the dynamic range of the stereo image) in mirror symmetrical LC structures for neighboring optical components. The most useful working medium in LC imaging matrices is a nematic LC, allowing to realize electrically controlled birefringent (ECB) structures (S-, B-cells) [3], optically active (twist- or T-cells, super-twist cells) structures with different twist angles α, in which the electrically controlled optical activity (ECOA) effect is realized. LC mediums with positive sign of dielectric anisotropy (Δ∈>0) are implemented in the form of homogeneously oriented structures (FIG. 46), i.e., with initial (at zero strength E of the control electric field) orientation of LC molecules predominantly along (parallel to) the plane of the LC layer, wherein Δ∈=∈ₑ−∈₀, where ∈ₑ and ∈₀ are the dielectric permeability of the LC layer for extraordinary and ordinary rays. For the ECB effect with a change in the strength E of the control electric field (caused by application of control voltage u_{control} to transparent electrodes 101, 102), a change occurs in the value of Δ∈, which leads to phase or polarization modulation of the luminous flux which passes through an elementary nematic LC cell, depending on the orientation of input polarizer 103. When using polarization modulation, the latter can be converted into a variation in the intensity of light inputting into polarization analyzer 104. Use of the ECOA effect ensures controlled (by the voltage value u_{control}) twist of polarization plane, wherein the most useful initial rotation values are 90°, 180°, 270°, whereas for the ECB effect the initial and final rotation angles are always equal to 0. The main disadvantage of elementary LC cells with the ECB effect is insufficiently high contrast image (no more than 30-40:1) because of LC chromatic dispersion. The main disadvantage of elementary LC cells with ECOA is small viewing angles (drop in image contrast for the viewing field angles over 20-30°). To obtain high contrast (dynamic range) of the image (several hundred to one) in combination with wide viewing angles (up to 120° and more), the complicated LC structures [4] with homogeneous orientation are used (FIG. 47)—IPS (in-plane switching), FFS (fringe-field switching) with Δ_{∈}>0, or with homeotropic (vertical) orientation of LC molecules (VA—vertical alignment) of structure with negative sign of dielectric anisotropy (Δ_{∈}<0) and their modifications—poly-domain structures with vertical orientation: MVA (multi-domain VA), PVA (protrusion-type VA), where several variously oriented domains correspond to one element of LC structure, each of which ensures the required angular characteristic of representation in its solid angle. In the these nematic LC structures the different combinations of ECB and ECOA effects are used, controlled by complex configurations of the electric field lines E. Besides analog structures, the bistable (multi-stable) LC structures are used as well on the basis of nematic LC, for example, with effects of zenithal and azimuthal bistability (FIG. 48) due to giving the appropriate form to one of control electrodes 105, which leads to appearance of two or more low energy levels (equally favorable energetically) for several configurations of LC molecules within one layer. It allows to do discretely the different configurations of LC layer by applying a control voltage of the required form (the flexo-electric effect is used at surface stabilization of LC layer on the asymmetric surface of control electrode 105). One of most promising bistable LC structures is a structure on ferroelectric LC (FIG. 49), that is characterized by spontaneous polarization; the “smectic-C*” LC structure has chiral layers of LC molecules, in which an the LC director (direction of preferred orientation of LC layer) is inclined relative to the planes of layers, which finally creates reflecting and twisting asymmetry in LC layers, leading to appearance of spontaneous polarization so to appearance of LC domains 106 with definite polarization direction P. A change in control voltage above the threshold value (E>Eₜₕ) produces an abrupt change in the polarization direction P.

The polarizer 103 and polarization analyzer 104 can be implemented within the LC layer, for example, in the form of a thin crystalline film [6], or with use of polarizing lyotropic LC [7], which optical characteristic include possible concomitant sum or ratio modulation.

In the absence of polarization analyzer 104, all considered analog LC structures can be used as the base cells for phase-polarization ratio modulation, for example, in the first and fifth particular embodiment of the method and for realization of the optical selector in the first particular embodiment of implementation of the device. A bistable ferroelectric LC structure can be used for implementation of pulse-width optical ratio modulation in the fourth particular embodiment of the method, wherein switching speeds are attained in units and tens of microseconds, operating switching frequencies are units and tens of kilohertz, which with the reserve provides the flicker less fusion perception of the luminous flux of the stereo image views by the observer's vision.

It is possible to reduce to a combination of equivalent optical activity and equivalent phase shift the result of the effect on the light wave from any, arbitrary complex, anisotropic optical structure, i.e., to represent the result in the form of the effect of the equivalent structure, which uses sequentially arranged a phase plate and a plate with optical activity, having arbitrary orientations of optical axes and arbitrary values of optical delay and optical activity angle, whereas all possible polarization values of the resultant luminous flux are determined geometrically on a Poincaré sphere [5], corresponding to all possible variations of orientation of a polarization ellipse (FIG. 50), which ellipticity χ is determined only by the value of the equivalent phase shift δ, and the resultant angular orientation of the polarization ellipse is determined by the combination of the values of the angles ψ and φ, where the value of the angle ψ is determined by the equivalent value of the phase shift δ, and the value of φ by the degree of equivalent optical activity. Therefore, the invention is applicable to all possible birefringent and optically active (including LC) structures with their use as phase-polarization modulators in implementation of ratio modulation. Optical anisotropic compensation films with supplied spectral and diffraction characteristics allow to expand the angular field of view and to improve image contrast due to compensation of the dispersion of the refractive index gradient of the of LC medium. Thereby birefringent optical elements with focusing properties can be used (for example, polarization micro lenses) for adjusting the position of the observation zones along the z axis, including using an electric field gradient along the boundary of the transparent electrode for adjusting the focal length, both due to adjusting the refractive index and due to adjusting the optical thickness of the layer of working medium. The diffraction and spectral characteristic of optical compensation films and also the refraction properties of the working medium of the focusing optical layer (distribution of refractive index along the layer) are automatically taken in account in the calibration process procedures.

For implementation of real-amplitude (direct) sum modulation in the first, second and fourth particular embodiments of the method, and also in the first particular embodiment of implementation of the device, any of the considered structures can be used if the polarization analyzer 104 is present. The presence of the polarizer 103 (necessary for the functioning of the considered single-crystal LC structures) leads to a 50% energy loss of light in case not polarized light wave source. To implement a polaroid-less real-amplitude light modulation it is possible to use, for example, an electrically controlled LC grid 107 (FIG. 51) with a period d, comparable with the light wavelength λ, that is characterized by a variable scattering coefficient of luminous flux in a direction that is normal to the surface of the LC layer. In particular, with this purpose the different variations of LC medium dispersed in polymeric matrices—PDLC (polymer-dispersed liquid) are used, where the LC takes the form of drops impregnated in an ordered manner in the polymer layer 108 (FIG. 52), forming a controlled diffraction grating, which scatters light at zero control voltage u_{control} and transmits light when the control voltage u_{control} which value corresponds matching the refractive index n_{LC} of the LC medium and the refractive index of the polymeric material. Such structures can be used for implementation of sum modulation in the first, third and fourth particular embodiments of the method and for implementation of the sum optical modulator in the first particular embodiment for implementation of the device, since these structures do not create concomitant sum modulation. For realizing direct ratio modulation in the form of variations of intensity (as the element of the difference-effect optical modulator), for example, a beam-splitting optical element 109 (FIG. 53) can be used, on the face of which a polarized or not polarized input light beam is routed at different angles (up to the attainment of total internal reflection (TIR). As a result of a combination of the refractive and reflective effects, output reflected and transmitted light beams are formed, which total intensity, in first approximation, is equal to the intensity of the input light beam, and the difference between intensity values of output beams is determined by the value of the angle of incidence of the input light beam on the face [5].

The role of optical converters and an optical selector in the case of direct sum and/or ratio modulation is to transmit without change the corresponding sum component and/or the ratio component of luminous flux intensity; and their role also (for particular embodiments of the technical disclosures) to set upper or lower limits of ultimate values of mentioned components to reach required dynamic range of change in image brightness, or to correct the characteristics of intermediate intensity values to reach their monotonic behavior.

To increase the optical efficiency, a polaroid-less LC structure can also be used with the “guest-host” effect, where light intensity modulation is implemented by molecules of dichroic dye, introduced in the LC layer and which orientation (and, correspondingly, the real-amplitude transmission coefficient of the luminous flux) is changed due to changing the orientation of LC molecules under effect of the control electric field. This type of working medium creates concomitant polarization modulation, and it can be used, for example, in the fourth and fifth particular embodiments of the method.

Variable real-amplitude transmission coefficient K can be realized, for example, in the total internal reflection effect at the boundary of two media, in the dynamic scattering effect in LC, in the electrowetting effect, in the electrochromic effect and in another electrically initiated optical effects. It is also possible to use matrix structures to generate a luminous flux, for example, any plasma- or light-emitting-diode-(including OLED—organic light-emitting diode) panels as the real-amplitude sum modulator, functionally combined with the optical source.

In the second particular embodiment of the method, as the sum and ratio optical modulators and also as the optical converter, comb optical filters can be used, made in the form of different interference, diffraction, holographic structures, electro-photo-chromic materials, photonic crystals (optical structures with a periodic alternation in dielectric constant along the optical axis). The line spectrum of luminous flux can be obtained, for example, with aid of a multilayer interference filter, that is a component part of a luminous flux generator. Deposited multilayer interference filters are also the examples of concrete implementation of a comb frequency filter. Use of a line (discrete) optical spectrum with spectral lines of a width of several tens of nanometers makes it possible to attain normal brightness and color reproduction of image.

In the third particular embodiment of the method, sum and ratio optical modulators can be implemented in the form of volume or surface acoustooptic modulators and, as louver optical converter, three-dimensional holographic grids (including on the principles of polarization holography), or on micro structures implemented by the method of the routed spraying.

The working medium of optical modulators can have a composite layer structure, which includes adjacent layers with different type or a mixture of working mediums of different types in one layer. Thereby the presence of optical compensation layers in the composition of the optical structure for forming the image, either of the sum or ratio optical modulators, and also in the composition of the optical converter (spatially-selective optical decoder) for realization of maximum viewing angle and/or maximum dynamic range (in the formed image) is automatically taken in account on carrying out the linearization calibration procedure, since any possible nonlinearity function of any of the layers will be included in the general nonlinearity function of the optoelectronic channels.

For realization the invention, it is possible to use any physically realizable optical structure with two or more complementary optical states, the transition between that is described by a arbitrary unambiguous physically realizable function.

The physical nature of the control information, calibration signals, and also matrix addressing signals, can be arbitrary (electronic, optical, including in the ultraviolet and infrared regions of the spectrum, optoelectronic, magneto-optical, ultrasonic and other signals). To obtain a signal of the required physical nature (both for matrix addressing and for information signals), it is sufficient to use a corresponding converter of the type of signal. For example, for forming matrix addressing optical signals, it is possible to use optically controlled space-time light modulators. The functional modules can be implemented, for example, in the form of the electronic digital processing modules or optoelectronic analog computers, including in the form of integral-optical modules. The optical source (light wave source) can be any source of incoherent or coherent emission (laser with continuous or pulse emission), including waveguide optical sources with luminous flux output through a heterogeneous lateral surface of the waveguide.

### INFORMATION SOURCES

1. Ezhov, V. A. Method for Forming Stereo Images with Integrated Presentation of Views and Device for its Realization. Patent RU No. 2306680, MKI H04N 15/00, published Sep. 20, 2007.
2. Ezhov V. “Stereoscopic method and a device for implementation thereof”. U.S. Pat. No. 7,929,066 (19 Apr. 2011).
3. Blinov, L. M. Electro- and Magneto-optics of Liquid Crystals. M., Nauka, 1974.
4. Yang, D. K., Wu, S. T. Fundamentals of Liquid Crystal Devices. Wiley Publishing House, 2006.
5. Born, M., Volf, E. Fundamentals of Optics. M., Nauka, 1974.
6. Ukai, Y. et al. Current and Future Properties of In-cell Polarizer Technology. Journal of the SID, 2005, v. 13, No. 1, pp. 17-24.
7. Paukshto, M. et al. Optics of Sheared LC Polarizer . . . . Journal of the SID, 2005, v. 13, No. 9, pp. 765-772.

1-19. (canceled)

20. An apparatus for forming and observing stereo images with maximum spatial resolution comprising
(A) a stereo video signal source; and
(B) an optical source; and
(C) an electrically controlled optical device, which is optically connected with the optical source; and
(D) a first and second functional modules;
wherein
(a) the electrically controlled optical device comprises arranged along an optical axis a sum optical modulator, that is addressed in M rows and N columns, a ratio optical modulator, that is addressed in M rows and N columns, and an optical selector, that is N-column addressed, with possibility of mutual permutation of the sum optical modulator, the ratio optical modulator and the optical selector or/and their components along the optical axis; and
(b) the inputs of the first and second functional modules are connected to the corresponding outputs of the stereo video signal source, the outputs of the first and second functional modules are connected to the control input of the sum optical modulator and to the control input of the ratio optical modulator respectively; and
(c) an aperture of the mn^{th} element of the sum optical modulator is optically connected with an aperture of the mn^{th} element of the ratio optical modulator, the axis of symmetry of one of the formation zones Z_{form}^{L}, Z_{form}^{R} is the common intersection line of one group of N planes, of which the first N/2 planes pass through the axes of symmetry of the odd (2k−1) columns of the optical selector and through the axes of symmetry of the even 2i columns of the ratio optical modulator, and the remaining N/2 planes pass through the axes of symmetry of the even 2k columns of the optical selector and through the axes of symmetry of the odd (2i−1) columns of the ratio optical modulator; the axis of symmetry of the another of the formation zones Z_{form}^{L}, Z_{form}^{R} is the common intersection line of another group of N planes, of which the first N/2 planes pass through the axes of symmetry of the even 2k columns of the optical selector and through the axes of symmetry of the even 2i columns of ratio optical modulator, and the remaining N/2 planes pass through the axes of symmetry of the odd (2k−1) columns of the optical selector and through the axes of symmetry of the odd (2i−1) columns of the ratio optical modulator, where n=1, 2, . . . , N, m=1, 2, . . . , M, i=1, 2, . . . , N, k=1, 2, . . . , N;
whereas
(i) each of the sum optical modulator, the ratio optical modulator and the optical selector contains at least one layer of working medium, having two complementary optical states with unambiguous characteristic of transition between said states, whereas the initial optical states of the working medium are complementary between the adjacent (2i−1) and 2i columns of the ratio optical modulator and between the adjacent (2k−1) and 2k columns of the optical selector; and
(ii) the first functional module has a transfer function T^{Σ}=F⁻¹{Φ^{ch}^{_{—}}¹}, that is the inverse of the transfer function Φ^{ch}^{_{—}}¹ of the first optoelectronic channel, which input is the control input of the sum optical modulator and which output is either of the formation zones Z_{form}^{L}, Z_{form}^{R},
(iii) the second electronic functional module has a transfer function T^{Ξ}=F⁻¹{(Φ^{ch}^{_{—}}²}, that is the inverse of the transfer function Φ^{ch}^{_{—}}² of the second optoelectronic channel, which input is the control input of the ratio optical modulator, and which optical outputs are both the formation zones Z_{form}^{L}, Z_{form}^{R}; and
(iv) the values of the transfer functions Φ^{ch}^{_{—}}¹ and Φ^{ch}^{_{—}}² of the first and second optoelectronic channels correspond to the optical intensity values on the outputs of the optoelectronic channels.

21. The apparatus of claim 20, wherein at least one of the sum optical modulator, the ratio optical modulator and the optical selector includes at least one compensating or focusing or polarizing auxiliary optical layer or a combination of said auxiliary optical layers, each of which is stationary or controlled, the transfer functions of which are spectrally dependent or diffraction-dependent or refraction-dependent components of the values of the transfer functions of the first and second optoelectronic channels.

22. A method of forming and observing stereo images with maximum spatial resolution, comprising in that:
(A) with the aid of an optical source generating a light wave; and
(B) with the aid of a uniform-effect optical modulator, that is matrix-addressed in M rows and N columns, carrying out a sum optical modulation in the mn^{th} element of the uniform-effect optical modulator causing identical in a value and a sign optical intensity changes in left W_{form}^{L} and right W_{form}^{R} formation windows; and
(C) with the aid of a difference-effect optical modulator, that is addressed in M rows and N columns, carrying out a ratio optical modulation in the mn^{th} element of the difference-effect optical modulator causing the identical in a value but different in a sign optical intensity changes in the left W_{form}^{L} and right W_{form}^{R} formation windows; and
(D) with the aid of first and second optical converters, having complementary optical decoding parameters, forming a first and second luminous fluxes with intensity values of Jₘₙ^{L} and Jₘₙ^{R}, which are equal to the values Bₘₙ^{L} and Bₘₙ^{R} of the brightness of the mn^{th} image elements of the left and right views in the left W_{form}^{L} and right W_{form}^{R} formation windows respectively, which are optically connected with the left W_{V}^{L} and right W_{V}^{R} observation windows, in which ones the left and right views of the stereo image are observed; and
(E) forming the modulated by intensity luminous fluxes in the left W_{form}^{L} and right W_{form}^{R} formation windows with aid of the first and second optical converters respectively,
wherein
(a) the first and second optical converters have:
(i) the complementary parameters for ratio modulation conversion;
(ii) the identical parameters for sum modulation conversion;
(iii) the identical parameters of optical transmission for both the direct ratio component and the direct sum component of luminous flux intensity;
(b) the carrying out the sum modulation of a light wave is in accordance with the sum Bₘₙ^{L}+Bₘₙ^{R} of the brightness of the mn^{th} image elements of the left and right views, wherein m=1, 2, . . . , M, p=1, 2, . . . , N, whereas supplying to control input of the uniform-effect optical modulator a sum compensating signal sₘₙ^{Σ}^{_{—}}^{comp} which amplitude is directly proportional to the linearization function Λ^{Σ} of sum modulation; and
(c) the carrying out the ratio optical modulation is in accordance with the ratio Bₘₙ^{L}/Bₘₙ^{R} of the brightness of the mn^{th} image elements of the left and right views, whereas supplying to the control input of the a difference-effect optical modulator a ratio compensating signal sₘₙ^{Ξ}^{_{—}}^{comp} which amplitude is directly proportional to the linearization function Λ^{Ξ} of ratio modulation;
(d) the carrying out the sum modulation comprises i) a direct sum modulation implemented due to a modulation of an optical intensity value of the light wave; or ii) an indirect sum modulation implemented due to a modulation of the remaining physical characteristics of the light wave, said remaining characteristics are selected from the group consisting of a direction of propagation, a value of a convergence angle, a value of a divergence angle, a spectral characteristic, a polarization state, a phase value and a combination thereof;
(e) the carrying out the direct ratio modulation comprises i) a modulation of an optical intensity value of the light wave, ii) an indirect ratio modulation implemented due to a modulation of remaining physical characteristics of the light wave, said remaining characteristics selected from the group consisting of a direction of propagation, a value of a convergence angle, a value of a divergence angle, a spectral characteristic, a polarization state, a phase value and a combination of thereof.

23. The method of claim 22, wherein
(A) the sum compensating signal sₘₙ^{Σ}^{_{—}}^{comp}:
(i) in its first particular embodiment s₍₁₎ₘₙ^{Σ}^{_{—}}^{comp} is given as a signal s₍₁₎ₘₙ^{Σ}^{_{—}}^{comp}≈Λ₍₁₎^{Σ}{Bₘₙ^{L}+Bₘₙ^{R}}, which amplitude is directly proportional to the linearization function Λ^{Σ} of sum modulation in its first particular embodiment Λ₍₁₎^{Σ}, taken from the sum Bₘₙ^{L}+Bₘₙ^{R}; or
(ii) in its second particular embodiment s₍₂₎ₘₙ^{Σ}^{_{—}}^{comp} is given as a signal s₍₁₎ₘₙ^{Σ}^{_{—}}^{comp}≈Λ₍₂₎^{Σ}{Bₘₙ^{L}+Bₘₙ^{R}}·Λ₍₂₎^{Σ} which amplitude is directly proportional to product of the sum Bₘₙ^{L}+Bₘₙ^{R} on the sum function Λ^{Σ} of modulation linearization in its second particular embodiment Λ₍₂₎^{Σ}; and
(B) a ratio compensating signal sₘₙ^{Ξ}^{_{—}}^{comp}:
(i) in the first particular embodiment, s₍₁₎ₘₙ^{Ξ}^{_{—}}^{comp} is given as a signal s₍₁₎ₘₙ^{Ξ}^{_{—}}^{comp}≈Λ₍₁₎^{Ξ}{Bₘₙ^{L}+Bₘₙ^{R}}, which amplitude is directly proportional to the linearization function Λ^{Σ} of ratio modulation in its first particular embodiment Λ₍₁₎^{Ξ}, taken from the ratio Bₘₙ^{L}/Bₘₙ^{R}; or
(ii) in the second particular embodiment, s₍₂₎ₘₙ^{Ξ}^{_{—}}^{comp} is given as a signal s₍₂₎ₘₙ^{Ξ}^{_{—}}^{comp}≈{Bₘₙ^{L}/Bₘₙ^{R}}·Λ₍₂₎^{Ξ}, which amplitude is directly proportional to the product of the ratio Bₘₙ^{L}/Bₘₙ^{R} on the linearization function of ratio modulation Λ^{Ξ} in its second particular embodiment Λ₍₂₎^{Ξ}; and
(C) the linearization function of sum modulation Λ^{Σ}:
(i) in its first particular embodiment, Λ₍₁₎^{Σ} is given as a function Λ₍₁₎^{Σ}=F⁻¹{Φ₍₁₎^{Σ}}, that is the inverse of the calibration function Φ^{Σ} of sum modulation nonlinearity in its first particular embodiment Φ₍₁₎^{Σ}; or
(ii) in its second particular embodiment, Λ₍₂₎^{Σ} is given as a function Λ₍₂₎^{Ξ}=F^{reciprocal}{Φ₍₂₎^{Ξ}}=1/Φ₍₂₎^{Ξ}, that is the reciprocal to the calibration function Φ^{Σ} of sum modulation nonlinearity in its second particular embodiment Φ₍₂₎^{Σ}; and
(D) the linearization function Λ^{Ξ} of ratio modulation:
(i) in the first particular embodiment, Λ₍₁₎^{Ξ} is given as a function Φ₍₁₎^{Ξ}=F⁻¹{Φ₍₁₎^{Ξ}}, that is the inverse of the calibration function Φ^{Ξ} of ratio modulation nonlinearity in its first particular embodiment Φ₍₁₎^{Ξ}; and
(ii) in the second particular embodiment, Λ₍₂₎^{Ξ} is given as the function Λ₍₂₎^{Ξ}=F^{reciprocal}{Φ₍₂₎^{Ξ}}=1/Φ₍₂₎^{Ξ}, that is the reciprocal to the calibration function Φ^{Ξ} of ratio modulation nonlinearity in its second Φ₍₂₎^{Ξ} particular embodiment; whereas
(E) the calibration function Φ^{Σ} of sum modulation nonlinearity:
(i) in the first particular embodiment Φ₍₁₎^{Σ} is given as the function Φ₍₁₎^{Σ}=J_{calib}^{Σ}, that is the assemblage of the uniformly modulated component calibration values J_{calib}^{Σ} of the luminous flux intensity on the output of either of the formation windows W_{form}^{L}, W_{form}^{R}, whereas the linearly-varying calibration signal s_{calib}_{_{—}}ₗᵢₙ^{Σ} of sum modulation is applied to the control input of the uniform-effect optical modulator; and
(ii) in the second particular embodiment Φ₍₂₎^{Σ} is given as the function Φ₍₁₎^{Σ}≈J_{calib}^{Σ}/s_{calib}^{Σ}, that is the ratio of the sequence of calibration values of the uniformly modulated component J_{calib}^{Σ} of the luminous flux intensity on the output of either of the formation windows W_{form}^{L}, W_{form}^{R} to the sequence of the corresponding amplitude values of the monotonically-varying calibration signal s_{calib}^{Σ} of sum modulation; and
(G) the calibration function Φ^{Ξ} of ratio modulation nonlinearity:
(i) in the first particular embodiment, Φ₍₁₎^{Ξ} is given as the function Φ₍₁₎^{Ξ}≈J_{calib}^{Ξ(L)}/J_{calib}^{Ξ(R)}, that is the ratio of the assemblage of the calibration values of the difference-modulated component J_{calib}^{Ξ(L)} of the luminous flux intensity in the left formation window W_{form}^{L} to the assemblage of the calibration values of the difference-modulated component J_{calib}^{Ξ(R)} of the luminous flux intensity in the right formation window W_{form}^{R}, whereas the linearly-varying calibration signal s_{calib}_{_{—}}ₗᵢₙ^{Ξ} of ratio modulation is applied to the control input of the difference-effect optical modulator; and
(ii) in the second particular embodiment, Φ₍₁₎^{Ξ} is given as the function
$${Φ}_{( 1 )}^{Ξ} = \frac{{J}_{calib}^{Ξ ( L )} / {J}_{calib}^{Ξ ( R )}}{{s}_{calib}^{Ξ}} ,$$
that is the ratio of the assemblage of the calibration values of the difference-modulated component J_{calib}^{Ξ(L)} of the luminous flux intensity in the left formation window W_{form}^{L} to the sequence of the calibration values of the difference-modulated component J_{calib}^{Ξ(R)} of the luminous flux intensity in the right formation window W_{form}^{R}, divided by the sequence of the corresponding values of the amplitude of the monotonically-varying ratio modulation calibration signal s_{calib}^{Σ}.

24. The method of claim 22, wherein
(A) the sum compensating signal sₘₙ^{Σ}^{_{—}}^{comp}:
(i) in the first particular embodiment, s₍₂₎ₘₙ^{Σ}^{_{—}}^{comp} is given as the signal s₍₁₎ₘₙ^{Σ}^{_{—}}^{comp}≈Λ₍₁₎^{Σ}{Bₘₙ^{L}+Bₘₙ^{R}}, which amplitude is directly proportional to the linearization function Λ^{Σ} of sum modulation in its first particular embodiment Λ₍₁₎^{Σ}, taken from the sum B_{form}^{L}+B_{form}^{R} of the values of the brightness of the mn^{th} image elements of the left and right views; or
(ii) in the second particular embodiment, s₍₂₎ₘₙ^{Σ}^{_{—}}^{comp} is given as the signal s₍₂₎ₘₙ^{Σ}^{_{—}}^{comp}≈{Bₘₙ^{L}+Bₘₙ^{R}}·Λ₍₂₎^{Σ} which amplitude is directly proportional to the product of the sum Bₘₙ^{L}+Bₘₙ^{R} on the linearization function Λ^{Σ} of sum modulation in its second Λ₍₂₎^{Σ} particular embodiment, whereas
(B) a ratio compensating signal sₘₙ^{Ξ}^{_{—}}^{comp}:
(i) in the first particular embodiment s₍₁₎ₘₙ^{Ξ}^{_{—}}^{comp} given as the signal s₍₁₎ₘₙ^{Ξ}^{_{—}}^{comp}≈Λ₍₁₎^{Ξ}{Bₘₙ^{L}/Bₘₙ^{R}} which amplitude is directly proportional to the values of the linearization function Λ^{Ξ} of ratio modulation in its first particular embodiment Λ₍₁₎^{Ξ}, taken from the ratio Bₘₙ^{L}/Bₘₙ^{R}; or
(ii) in the second particular embodiment s₍₂₎ₘₙ^{Ξ}^{_{—}}^{comp} is given as the signal s₍₂₎ₘₙ^{Ξ}^{_{—}}^{comp}≈{Bₘₙ^{L}/Bₘₙ^{R}}·Λ₍₂₎^{Ξ} which amplitude is directly proportional to the product of the ratio Bₘₙ^{L}/Bₘₙ^{R} on the linearization function Λ^{Ξ} of ratio modulation in its second particular embodiment Λ₍₂₎^{Ξ}; whereas
(c) the linearization function Λ^{Σ} of sum modulation:
(i) in the first particular embodiment, Λ₍₁₎^{Σ} is given as the function Λ₍₁₎^{Σ}=F⁻¹{Φ₍₁₎^{Σ}}F⁻¹{Φ₍₁₎^{Σ}}, that is the inverse of the calibration function Φ^{Σ} of sum modulation nonlinearity in its first particular embodiment Φ₍₁₎^{Σ}; or
(ii) in the second particular embodiment, Λ₍₂₎^{Σ} is given as the function Λ₍₂₎^{Ξ}=F^{reciprocal}{Φ₍₂₎^{Ξ}}=1/Φ₍₂₎^{Ξ}, that is the reciprocal 1/Φ₍₂₎^{Σ} to the calibration function Φ^{Σ} of sum modulation nonlinearity in its second particular embodiment Φ₍₂₎^{Σ}; and
(iii) in the first particular embodiment, Λ₍₁₎^{Ξ} is given as the function Φ₍₁₎^{Ξ}=F⁻¹{Φ₍₁₎^{Ξ}}, that is the inverse of the calibration function of ratio modulation nonlinearity in its first Φ₍₁₎^{Ξ} particular embodiment; or
(iii) in the second particular embodiment, Λ₍₂₎^{Ξ} is given as the function Λ₍₂₎^{Ξ}=F^{reciprocal}{Φ₍₂₎^{Ξ}}=1/Φ₍₂₎^{Ξ}, that is reciprocal 1/Φ₍₂₎^{Ξ} to the calibration function of ratio modulation nonlinearity in its second Φ₍₂₎^{Ξ} particular embodiment, wherein
(D) the calibration function Φ^{Σ} of sum modulation nonlinearity:
(i) in the first particular embodiment, Φ₍₁₎^{Σ} is given as the function Φ₍₁₎^{Σ}=J_{calib}^{Σ}, that is the sequence of the calibration values of the uniform modulated component J_{calib}^{Σ} of the luminous flux intensity in either of the formation windows, whereas a linearly-varying calibration signal of sum modulation s_{calib}_{_{—lin}}^{Σ} is applied to the control input of the uniform-effect optical modulator; or
(ii) in the second particular embodiment, Φ₍₂₎^{Ξ} is given as the function Φ₍₁₎^{Σ}≈J_{calib}^{Σ}/s_{calib}^{Σ}, that is the ratio of the sequence of calibration values of the uniformly modulated component J_{calib}^{Σ} of the luminous flux intensity in either of the formation windows W_{form}^{L}, W_{form}^{R} to the sequence of the corresponding values of the amplitude of the monotonically-varying calibration signal s_{calib}^{Σ} of sum modulation;
(E) the calibration function Φ^{Ξ} of ratio modulation nonlinearity:
(i) in the first particular embodiment, Φ₍₁₎^{Ξ} is given as the function Φ₍₁₎^{Ξ}≈J_{calib}^{Ξ(L)}/J_{calib}^{Ξ(R)}, that is the ratio of the assemblage of the calibration values of the difference-modulated component J_{calib}^{Ξ(L)} of the luminous flux intensity in the left formation window to the assemblage of the calibration values of the difference-modulated component J_{calib}^{Ξ(R)} of the luminous flux intensity in the right formation window, whereas a linearly-varying ratio modulation calibration signal s_{calib}_{_{—}}ₗᵢₙ^{Ξ} applied to the control input of the difference-effect optical modulator; and
(ii) in the second particular embodiment, Φ₍₂₎^{Ξ} is given as the function
$${Φ}_{( 2 )}^{Ξ} = \frac{{J}_{calib}^{Ξ ( L )} / {J}_{calib}^{Ξ ( R )}}{{s}_{calib}^{Ξ}} ,$$
that is the ratio of the assemblage of calibration values of the difference-modulated component J_{calib}^{Ξ(L)} of the luminous flux intensity in the left formation window W_{form}^{L} to the assemblage of calibration values of the difference-modulated component J_{calib}^{Ξ(R)} of the luminous flux intensity in the right formation window W_{form}^{R}, divided by the assemblage of the corresponding amplitude values of the monotonically-varying ratio signal s_{calib}^{Ξ} of modulation calibration.

25. The method of claim 22, wherein values of the linearization function Λ^{Σ} of the sum modulation depend on values of the ratio signal, and/or values of the linearization function Λ^{Ξ} of the ratio modulation depend on values of the sum signal.

26. The method of claim 22, wherein
(a) the carrying out the sum modulation comprises: a modulation of the luminous flux intensity with the aid of a real-amplitude optical modulator;
(b) the carrying out the ratio modulation comprises a ratio optical modulation implemented by a modulation of the polarization state of the luminous flux with aid of a phase-polarization modulator with unambiguous characteristic of transition between two complementary phase-polarization optical states; and wherein the method further comprises
(c) converting the ratio modulation into a ratio component of luminous flux intensity, which is implemented with the aid of the first and second polarization converters with complementary polarization parameters.

27. The method of claim 22, wherein
(a) with the aid of the optical source, a luminous flux with a first spectrum is generated;
(b) with the aid of the real-amplitude optical modulator, the sum amplitude modulation is carried out by a modulation of an intensity of the luminous flux; and
(c) with the aid of an optical frequency modulator, a ratio modulation is carried out in a form of a ratio spectral modulation with a transition from the first spectrum to a second spectrum, whereas a control input of the optical frequency modulator is provided by a voltage changing from a first value to a second value;
(d) with the aid of first and second optical frequency analyzers with spectral characteristics, corresponding to the first and second spectra, the ratio spectral modulation is converted into the ratio component of the intensity of the light flux.

28. The method of claim 22, wherein
(a) with the aid of the optical source, a collimated luminous flux is formed;
(b) with the aid of a sum diffraction optical modulator, a sum diffraction modulation is implemented due to changing a deflection angle of the luminous flux in a first transverse direction;
(c) with the aid of a ratio diffraction optical modulator, a ratio diffraction modulation is implemented due to changing the deflection angle of the luminous flux in a second transverse direction;
(d) with the aid of a louver optical converter, that is asymmetric in two mutually orthogonal transverse directions,
(i) in the first transverse direction, a separation of a component of the luminous flux is implemented in accordance with the sum diffraction modulation in the left and right formation windows, and
(ii) in a second transverse direction a separation of component of the luminous flux is implemented in accordance with the ratio diffraction modulation between the left and right formation windows.

29. The method of claim 22, wherein
(a) with the aid of an analog real-amplitude optical modulator, a sum modulation is implemented due to an analog modulation of an intensity of a luminous flux;
(b) with the aid of a bistable polarization modulator, a ratio bistable polarization modulation is implemented due to a pulse-width modulation between two complementary polarization states;
(c) with the aid of first and second polarization converters with complementary polarization states, an analog polarization conversion of the ratio modulation to bistable variations of the ratio component of the intensity of the luminous flux is implemented, whereas
(d) a bistable polarization linearization function Λ_{Bi}^{Ξ}^{_{—}}^{P} of the ratio modulation is determined:
(i) in the first embodiment, Λ_{(1)Bi}^{Ξ}^{_{—}}^{P} as the inverse function F⁻¹{Φ_{(1)Bi}^{Ξ}^{_{—}}^{P}} to the nonlinearity function Φ_{Bi}^{Ξ}^{_{—}}^{P} of the ratio bistable polarization modulation in its first embodiment Λ_{(1)Bi}^{Ξ}^{_{—}}^{P}≈F⁻¹{Φ_{(1)Bi}^{Ξ}^{_{—}}^{P}}, which is given as the ratio of the time-averaged calibration values of the ratio component \tilde{J}_{calib}_{_{—}}_{Bi}^{Ξ}^{_{—}}^{P(L)}(u) of the luminous flux intensity in the left formation window to the time-averaged calibration values of the ratio component of the luminous flux intensity \tilde{J}_{calib}_{_{—}}_{Bi}^{Ξ}^{_{—}}^{P(R)}(u) in the right formation window:
$${Φ}_{Bi}^{Ξ\_ P} ( u ) \approx {\tilde{J}}_{calib\_B i}^{Ξ\_ P ( L )} ( u ) / {\tilde{J}}_{calib\_B i}^{Ξ\_ P ( R )} ( u ) , \\ where {\tilde{J}}_{calib\_B i}^{Ξ\_ P ( L )} ( u ) = {\int }_{t}^{ } {J}_{calib\_Bi}^{Ξ\_ P ( L )} d t , \\ {\tilde{J}}_{calib\_B i}^{Ξ\_ P ( R )} ( u ) = {\int }_{t}^{ } {J}_{calib\_B i}^{Ξ\_ P ( R )} d t ,$$
whereas the calibration pulse-width signal is applied to the control input of the bistable polarization modulator u_{calib}_{_{—}}ₗᵢₙ_{_{—}}_{Bi}^{Ξ}^{_{—}}^{P} with linearly-varying pulse width, and
(ii) in the second embodiment, Λ_{(2)Bi}^{Ξ}^{_{—}}^{P} is given as the assemblage of the values each of which is reciprocal to the corresponding value of the bistable polarization nonlinearity function Φ_{Bi}^{Ξ}^{_{—}}^{P} of ratio modulation in its second embodiment Λ_{(2)Bi}^{Ξ}^{_{—}}^{P}(u)≈1/Φ_{(2)Bi}^{Ξ}^{_{—}}^{P}(u), where Φ_{(2)Bi}^{Ξ}^{_{—}}^{P} is the ratio of the sequence of time-averaged calibration values of the ratio component \tilde{J}_{calib}_{_{—}}_{Bi}^{Ξ}^{_{—}}^{P(L)}(u) of the luminous flux intensity in the left formation window to the sequence of time-averaged calibration values of the ratio component \tilde{J}_{calib}_{_{—}}_{Bi}^{Ξ}^{_{—}}^{P(R)}(u) of the luminous flux intensity in the right formation window, divided by the time-averaged ũ_{calib}_{_{—}}ₗᵢₙ_{_{—}}_{Bi}^{Ξ}^{_{—}}^{P} values of the calibration signal with monotonically-varying duration of pulses:
$${Φ}_{( 2 ) Bi}^{Ξ\_ P} \approx \frac{{\tilde{J}}_{calib\_B i}^{Ξ\_ P ( L )} ( u ) / {\tilde{J}}_{calib\_Bi}^{Ξ\_ P ( R )} ( u )}{{\tilde{u}}_{calib\_lin \_Bi}^{Ξ\_ P}} , \\ where {\tilde{u}}_{calib\_li n}^{Ξ\_ P} = {\int }_{0}^{T} {u}_{calib\_lin \_Bi}^{Ξ\_ P} d t .$$

30. The method of claim 22, wherein said sum and/or ratio modulation is implemented due to the combination of analog and bistable or multi-stable modulation of characteristic of the luminous flux.

31. A method of forming and observing stereo images with maximum spatial resolution comprises in that,
(A) generating a light wave with the aid of an optical source;
(B) with aid of a uniform-effect optical modulator, that is matrix-addressed in M rows and N columns, carrying out a sum optical modulation in the mn^{th} element of a uniform-effect optical modulator causing identical in a value and a sign optical intensity changes in left W_{form}^{L} and right W_{form}^{R} formation windows; and
(C) with the aid of a difference-effect optical modulator, that is matrix-addressed in M rows and N columns, whereas assigning complementary values of ratio modulation characteristics in the adjacent 2i and (2i−1) columns of the difference-effect optical modulator, wherein i=1, 2, . . . , N, and supplying to its control input a ratio compensating signal sₘₙ^{Ξ}^{_{—}}^{comp} which amplitude is directly proportional to the value of the linearization function of ratio modulation Λ^{Ξ}, carrying out a ratio optical modulation in the mn^{th} element of the difference-effect optical modulator causing identical in a value but different in a sign optical intensity changes in the left W_{form}^{L} and right W_{form}^{R} formation windows;
(D) forming first and second groups of N modulated intensity light beams with aid of an N-column addressed spatially-periodic optical analyzer with complementary optical analysis parameters for its adjacent 2k and (2k−1) columns, wherein k=1, 2, . . . , N, a first and second groups of light beams are formed with common intensity values Jₘₙ^{L} and Jₘₙ^{R}, equal to the values Bₘₙ^{L} and Bₘₙ^{R} of the brightness of the mn^{th} image elements of the left and right views in the left Z_{form}^{L} and right Z_{form}^{R} formation zones respectively, wherein the first group N light beams is routed to one of the formation zones, the first N/2 of which pass through N/2 even 2i columns of the difference-effect optical modulator and through N/2 even 2k columns of the spatially-periodic optical analyzer, and the remaining N/2 light beams pass through N/2 odd (2k−1) columns of the difference-effect optical modulator and through N/2 odd (2k−1) columns of the spatially-periodic optical analyzer, and the second group N light beams is routed to the other formation zone, first N/2 which pass through N/2 odd (2i−1) columns of the difference-effect optical modulator and through N/2 even 2k columns of the spatially-periodic optical analyzer, and the remaining N/2 light beams pass through N/2 even 2i columns of the second optical modulator and through N/2 odd (2k−1) columns of the spatially-periodic optical analyzer
(E) observing left and right views of the stereo image in left Zᵥ^{L} and right Zᵥ^{R} observation zones respectively, which ones are optically connected with the left Z_{form}^{L} and right Z_{form}^{R} formation zones respectively;
wherein said carrying out the sum optical modulation comprises:
(a) carrying out a direct sum modulation by a modulation of the intensity of the light wave or
(b) carrying out an indirect sum modulation, which comprises a modulation of remaining physical characteristics of the light wave selected from the group consisting of a direction of propagation; a value of a convergence angle, a value of a divergence angle, a spectral characteristic, a polarization state, a phase value, and a combination thereof; and wherein carrying out the ratio optical modulation comprises:
(c) carrying out a direct ratio modulation modulation of the intensity of the light wave; or
(d) carrying an indirect ratio modulation, which comprises a modulation of remaining physical characteristics of the light wave selected from the group consisting of a direction of propagation; a value of a convergence angle, a value of a divergence angle, a spectral characteristic, a polarization state, a phase value, and a combination thereof.

32. The method of claim 31, wherein
(a) a sum compensating signal sₘₙ^{Σ}^{_{—}}^{comp} is as follows:
(i) in the first particular embodiment, s₍₁₎ₘₙ^{Σ}^{_{—}}^{comp} is directly proportional to the linearization function of sum modulation Λ^{Σ} which is supplied in its first particular embodiment Λ₍₁₎^{Σ}, taken from the product of the sum Bₘₙ^{L} and Bₘₙ^{R} of the values of the brightnesses of the mn^{th} image elements of the left and right views: s₍₁₎ₘₙ^{Σ}^{_{—}}^{comp}≈Λ₍₁₎^{Σ}{Bₘₙ^{L}+Bₘₙ^{R}}, or
(ii) in the second particular embodiment, s₍₂₎ₘₙ^{Σ}^{_{—}}^{comp} is directly proportional to the product of the sum Bₘₙ^{L}+Bₘₙ^{R} on the linearization function Λ^{Σ} of sum modulation in its second Λ₍₂₎^{Σ} particular embodiment: s₍₂₎ₘₙ^{Σ}^{_{—}}^{comp}≈(Bₘₙ^{L}+Bₘₙ^{R})·Λ₍₂₎^{Σ}, whereas
(b) the ratio compensating signal sₘₙ^{Ξ}^{_{—}}^{comp} is as follows:
(i) in the first particular embodiment, s₍₁₎ₘₙ^{Ξ}^{_{—}}^{comp}, which amplitude is directly proportional to the linearization function of ratio modulation Λ^{Ξ} in its first particular embodiment Λ₍₁₎^{Ξ}, taken from the ratio of the values Bₘₙ^{L}/Bₘₙ^{R} of the brightness in the mn^{th} of the image elements of the left and right views: s₍₁₎ₘₙ^{Ξ}^{_{—}}^{comp}≈Λ₍₁₎^{Ξ}{Bₘₙ^{L}/Bₘₙ^{R}}, or
(ii) in the second particular embodiment, s₍₂₎ₘₙ^{Ξ}^{_{—}}^{comp}, which amplitude is directly proportional to the product of the ratio Bₘₙ^{L}/Bₘₙ^{R} on the linearization function Λ^{Ξ} of ratio modulation in its second particular embodiment Λ₍₂₎^{Ξ}: s₍₂₎ₘₙ^{Ξ}^{_{—}}^{comp}≈(Bₘₙ^{L}/Bₘₙ^{R})·Λ₍₂₎^{Ξ}, wherein
(c) the linearization function Λ^{Σ} of sum modulation:
(i) in the first particular embodiment, Λ₍₁₎^{Σ} is given as the function Λ₍₁₎^{Σ}=F⁻¹{Φ₍₁₎^{Σ}}, inverse to the nonlinearity calibration function Φ^{Σ} of sum modulation in its first particular embodiment Φ₍₁₎^{Σ}: Λ₍₁₎^{Σ}=F⁻¹{Φ₍₁₎^{Σ}}, and
(ii) in the second particular embodiment, Λ₍₂₎^{Σ} is given as the function F^{reciprocal}{Φ₍₂₎^{Σ}}, whose values are the reciprocal values 1/Φ₍₂₎^{Σ} of the values of the nonlinearity calibration function Φ^{Σ} of sum modulation in its second particular embodiment Φ₍₂₎^{Σ}: Λ₍₂₎^{Ξ}=F^{reciprocal}{Φ₍₂₎^{Ξ}}=1/Φ₍₂₎^{Ξ};
(d) the linearization function Λ^{Ξ} of ratio modulation:
(i) in the first particular embodiment, Λ₍₁₎^{Ξ} is given as the function F⁻¹{Φ₍₁₎^{Ξ}}, inverse to the nonlinearity calibration function Φ^{Ξ} of ratio modulation in its first particular embodiment Φ₍₁₎^{Ξ}: Λ₍₁₎^{Ξ}=F⁻¹{Φ₍₁₎^{Ξ}}; and
(ii) in the second particular embodiment, Λ₍₂₎^{Ξ} is given as the function F^{reciprocal}{Φ₍₂₎^{Ξ}}; whose values are the reciprocal values 1/Φ₍₂₎^{Ξ} of the values of the calibration function of ratio modulation nonlinearity in its second particular embodiment Φ₍₂₎^{Ξ}: Λ₍₂₎^{Ξ}=F^{reciprocal}{Φ₍₂₎^{Ξ}}=1/Φ₍₂₎^{Ξ}, wherein
(e) the calibration function Φ^{Σ} of sum modulation nonlinearity:
(i) in the first particular embodiment, Φ₍₁₎^{Σ} is equal to the assemblage of the calibration values of the uniform-modulated component J_{calib}^{Σ} of the luminous flux intensity on the output of either of the formation windows: Φ₍₁₎^{Σ}=J_{calib}^{Σ} whereas a sum modulation linearly-varying calibration signal s_{calib}_{_{—}}ₗᵢₙ^{Σ} is applied to the control input of the uniform-effect optical modulator; and
(ii) in the second particular embodiment, Φ₍₂₎^{Σ} is equal to the ratio of the sequence of calibration values of the uniformly modulated component J_{calib}^{Σ} of the luminous flux intensity on the output of either of the formation zones Z_{form}^{L}, Z_{form}^{R} to the sequence of the corresponding values of the monotonically-varying calibration signal s_{calib}^{Σ} of sum modulation: Φ₍₁₎^{Σ}≈J_{calib}^{Σ}/s_{calib}^{Σ};
(f) the nonlinearity calibration function Φ^{Ξ} of ratio modulation:
(i) in its first particular embodiment, Φ₍₁₎^{Ξ} is equal to the ratio of the sequence of the calibration values of the difference-modulated component J_{calib}^{Ξ(L)} of the luminous flux intensity in the left formation zone to the sum of the calibration values of the difference-modulated component J_{calib}^{Ξ(R)} of the luminous flux in the right formation zone: Φ₍₁₎^{Ξ}≈J_{calib}^{Ξ(L)}/J_{calib}^{Ξ(R)} whereas a linearly-varying calibration signal s_{calib}_{_{—}}ₗᵢₙ^{Ξ} of ratio modulation is applied to the control input of the difference-effect optical modulator;
(ii) in the second particular embodiment, Φ₍₂₎^{Ξ} is equal to the ratio of the assemblage of the calibration values of the difference-modulated component J_{calib}^{Ξ(L)} of the luminous flux intensity in the left formation zone Z_{form}^{L} to the assemblage of the calibration values of the difference-modulated component J_{calib}^{Ξ(R)} of the luminous flux intensity in the right formation zone Z_{form}^{R}, divided by the assemblage of the corresponding values of the amplitude of the monotonically-varying calibration signal s_{calib}^{Ξ} of ratio modulation:
$${Φ}_{( 2 )}^{Ξ} = \frac{{J}_{calib}^{Ξ ( L )} / {J}_{calib}^{Ξ ( R )}}{{s}_{calib}^{Ξ}} .$$

33. The method of claim 31, wherein the values of the linearization function Λ^{Σ} of sum modulation depend on the values of the ratio signal and/or the values of the linearization function Λ^{Ξ} of ratio modulation depend on the values of the sum signal.

34. The method of claim 31, wherein (a) the carrying out the sum modulation comprises a modulation of luminous flux intensity with the aid of a real-amplitude optical modulator (b) the carrying out the ratio modulation comprises the ratio optical modulation implemented by a modulation of the polarization state of the luminous flux with the aid of a phase-polarization modulator with unambiguous characteristic of transition between two complementary phase-polarization optical states, and wherein the method further comprises (c) converting the ratio modulation to a ratio component of the luminous flux intensity with the aid of first and second polarization converters with the complementary polarization parameters.

35. The method of claim 31, wherein
(a) said generating comprises generating, with the aid of the optical source, a luminous flux with a first spectrum;
(b) with the aid of a real-amplitude optical modulator, the amplitude sum modulation is carried out by a modulation of an intensity of the luminous flux;
(c) the carrying out the ratio modulation is in the form of ratio spectral modulation with transition from the first spectrum to a second spectrum with the aid of a optical frequency modulator, whereas a voltage on a control input of the optical frequency modulator is changed from a first to a second value; and
(d) with the aid of a first and second optical frequency analyzers with spectral characteristics correspond to the first spectra and the second spectra, the spectral ratio modulation is converted to a ratio component of the intensity of the luminous flux.

36. The method of claim 31, wherein
(a) with the aid of the optical source, a collimated luminous flux is formed;
(b) with the aid of a sum diffraction optical modulator, the sum diffraction modulation is implemented due to changing a deflection angle of the luminous flux in a first transverse direction;
(c) with the aid of a ratio diffraction optical modulator, the ratio diffraction modulation is implemented due to a changing the deflection angle of the luminous flux in a second transverse direction; and
(d) with the aid of a louver optical converter, that is asymmetric in two mutually orthogonal transverse directions,
(i) a separation of a component of the luminous flux is carried out in the first transverse direction implementing thereby the sum diffraction modulation in the left and right formation zones; and
(ii) a separation of a component of the luminous flux is carried out in a second transverse direction implementing thereby the ratio diffraction modulation between the left and right formation zones.

37. The method of claim 31, wherein
(a) with the aid of an analog real-amplitude optical modulator, the sum modulation is implemented due to an analog modulation of an intensity of a luminous flux; and
(b) with the aid of a bistable polarization modulator, a ratio bistable polarization modulation is implemented due to a pulse-width modulation between two complementary polarization states; and
(c) with the aid of a first and second polarization converters with complementary polarization states, an analog polarization conversion of the ratio modulation to bistable variations of the ratio component of the intensity of the luminous flux is implemented, wherein
(i) the linearization function Λ_{Bi}^{Σ}^{_{—}}^{P} of polarization bistable ratio modulation is determined in the first embodiment Λ_{(1)Bi}^{Ξ}^{_{—}}^{P} as the function F⁻¹{Φ_{(1)Bi}^{Ξ}^{_{—}}^{P}}, inverse to the function of nonlinearity of ratio polarization bistable modulation in its first embodiment Φ_{(1)Bi}^{Ξ}^{_{—}}^{P}: Λ_{(1)Bi}^{Ξ}^{_{—}}^{P}≈F⁻¹{Φ_{(1)Bi}^{Ξ}^{_{—}}^{P}}, which is given as the ratio of the assemblage of time-averaged calibration values of the ratio component \tilde{J}_{calib}_{_{—}}_{Bi}^{Ξ}^{_{—}}^{P(L)}(u) of the luminous flux intensity in the left formation zone to the assemblage of time-averaged calibration values of the ratio component \tilde{J}_{calib}_{_{—}}_{Bi}^{Ξ}^{_{—}}^{P(R)}(u) of the luminous flux intensity in the right formation window:
$${Φ}_{Bi}^{Ξ\_ P} ( u ) \approx {\tilde{J}}_{calib\_B i}^{Ξ\_ P ( L )} ( u ) / {\tilde{J}}_{calib\_B i}^{Ξ\_ P ( R )} ( u ) , \\ wherein {\tilde{J}}_{calib\_B i}^{Ξ\_ P ( L )} ( u ) = {\int }_{t}^{ } {J}_{calib\_Bi}^{Ξ\_ P ( L )} d t , \\ {\tilde{J}}_{calib\_B i}^{Ξ\_ P ( R )} ( u ) = {\int }_{t}^{ } {J}_{calib\_B i}^{Ξ\_ P ( R )} d t ,$$
whereas a calibration pulse-width signal u_{calib}_{_{—}}ₗᵢₙ_{_{—}}_{Bi}^{Ξ}^{_{—}}^{P} with linearly-varying width of pulses is applied to the control input of the bistable polarization modulator; and
(ii) the linearization function of polarization bistable ratio modulation in its second embodiment Λ_{(2)Bi}^{Ξ}^{_{—}}^{P} is given as the assemblage of the values each of which is the reciprocal value of the corresponding value of the nonlinearity function Φ_{Bi}^{Ξ}^{_{—}}^{P} of polarization bistable ratio modulation in its second embodiment Φ_{(2)Bi}^{Ξ}^{_{—}}^{P}: Λ_{(2)Bi}^{Ξ}^{_{—}}^{P}(u)≈1/Φ_{(2)Bi}^{Ξ}^{_{—}}^{P}(u), where Φ_{(2)Bi}^{Ξ}^{_{—}}^{P} is the ratio of the assemblage of time-averaged calibration values of the ratio component \tilde{J}_{calib}_{_{—}}_{Bi}^{Ξ}^{_{—}}^{P(L)}(u) of the luminous flux intensity in the left formation zone to the assemblage of time-averaged calibration values of the ratio component \tilde{J}_{calib}_{_{—}}_{Bi}^{Ξ}^{_{—}}^{P(L)}(u) of the luminous flux intensity in the right formation zone, divided by the assemblage of time-averaged values ũ of the calibration signal ũ_{calib}_{_{—}}ₗᵢₙ_{_{—}}_{Bi}^{Ξ}^{_{—}}^{P} with monotonically-varying duration of pulses:
$${Φ}_{( 2 ) Bi}^{Ξ\_ P} \approx \frac{{\tilde{J}}_{calib\_B i}^{Ξ\_ P ( L )} ( u ) / {\tilde{J}}_{calib\_Bi}^{Ξ\_ P ( R )} ( u )}{{\tilde{u}}_{calib\_lin \_Bi}^{Ξ\_ P}} , \\ wherein {\tilde{u}}_{calib\_li n}^{Ξ\_ P} = {\int }_{0}^{T} {u}_{calib\_lin \_Bi}^{Ξ\_ P} d t .$$

38. The method of claim 31, wherein said sum and/or ratio modulation are/is implemented due to the combination of analog and bistable or multi-stable modulation of the of the luminous flux characteristic.
